(19) United States
(12) Patent Application Publication
(10) Pub. No.: US 2007/0202353 A1
(43) Pub. Date: Aug. 30, 2007

(54) Luminescent Material And Method For Producing Same

(75) Inventors: Shinji Inagaki, Aichi-ken (JP); Osamu Ohtani, Aichi-ken (JP); Yasutomo Goto, Aichi-ken (JP); Kentaro Okamoto, Tokyo (JP); Mitsumasa Horii, Aichi-ken (JP); Masamichi Ikai, Aichi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toyota Chuo Kenkyusho, Aichi-ken (JP)

(21) Appl. No.: 10/594,253

(22) PCT Filed: Mar. 25, 2005
(86) PCT No.: PCT/JP05/06440

§ 371 Date: Sep. 25, 2006

(30) Foreign Application Priority Data
Mar. 25, 2004 (JP) 2004-088702

(51) Int. Cl. C09K 11/00; B32B 19/00; B32B 3/26; B32B 9/00

(52) U.S. Cl. 428/690; 428/447; 428/304.4; 428/402; 252/301.35; 528/33; 528/43

(57) ABSTRACT

A luminescent material composed of the polymer of the organic silicon compound represented by the following general formula (1):
Chemical Formula 1 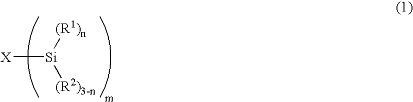
[where X is an organic molecule which emits fluorescence or phosphorescence; R¹ is a lower alkoxy group, a hydroxyl group, an allyl group, an ester group, or halogen atoms; R² is a lower alkyl group or a hydrogen atom; n is an integer of 1 to 3; and m is an integer of 1 to 4].

### TECHNICAL FIELD

The present invention relates to a luminescent material and a method of producing the same. More specifically, the present invention relates to an organic luminescent material which contains fluorescent or phosphorescent organic molecules, and to a method of producing the same.

### BACKGROUND OF THE INVENTION

Conventionally, organic luminescent materials are classified into a low-molecular-weight group and a high-molecular-weight group. The former group, low-molecular-weight luminescent material group, includes aromatic fluorescent dyes such as anthracene group, benzene group, and biphenyl group. The group also includes complexes such as an aluminum complex, an iridium complex, and a rare earth complex. The latter group, high-molecular-weight luminescent material group, includes a polyphenylene vinylene group, polyfluorene group, polythiophene group, and a dye-containing nonconjugated polymer {refer to, for example, Kazuyuki Horie et al., Science of Optical function Molecule: Molecule photonics, Kodansha Co., Ltd., 7th print, Aug. 10, 2001, p. 58 (Literature 1)}. However, there are problems with the conventional organic luminescent material described above. Intermolecular action causes concentration quenching, which decreases luminance. Thus, luminance becomes insufficient and luminance efficiency becomes low. In addition, the organic luminescent materials generally have a service lifetime shorter than that of other luminescent materials. Thus it is difficult to maintain a stable luminescence property over a long period of time.

On the other hand, in recent years, various kinds of organic-inorganic composite materials have been developed and reported as materials with nanostructure, The materials have, for example, benzene as their organic component matter, and silicon compounds as their inorganic component matters {refer to, for example, R. J. P. Corriu, “Ceramics and Nanostructures from Molecular Precursors,” Angrew. Chem. Int. Ed., 39, 2000, pp. 1376-1398 (Literature 2)}. In addition, the present inventors developed mesoporous materials composed of such organic-inorganic composite materials {refer to, for example, Japanese Unexamined Patent Application Publication No. 2001-114790 (Literature 3)}. However, no study on the luminescence properties of such organic-inorganic composite materials has been reported so far. Nor has been any report even suggesting that such materials could be made luminescent.

### DISCLOSURE OF THE INVENTION

The present invention is made in view of the above-described problems with the prior art. An object of the present invention is to provide an organic luminescent material with improved luminous efficiency, and capable of producing high luminescence. The high luminescence is made possible by preventing the decrease in luminance, a cause of which is concentration quenching. The organic luminescent material to be provided by the present invention, furthermore, has excellent heat resistance, and a long service lifetime.

The present inventors, as a result of the intensive and extensive studies for the above-mentioned purposes, though somewhat surprisingly, found the following facts. Polymerizing particular organic silicon compounds containing fluorescent or phosphorescent organic molecules such as benzene, and biphenyl produces a polymer with improved luminous efficiency. The polymer can produce high luminescence by preventing the decrease in luminance, which is derived from concentration quenching. Furthermore, the polymer has excellent heat resistance and is capable of serving as a luminescent material for a long time. Thus, the inventors have completed the present invention.

Precisely, the luminescent material of the present invention is characterized in that it is composed of a polymer of organic silicon compound represented by the following general formula (1):
Chemical Formula 1 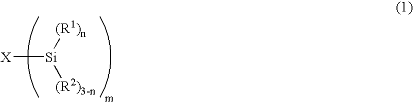
[where X is a fluorescent or phosphorescent organic molecule; R¹ is at least a member selected from the group consisting of a lower alkoxy group, a hydroxyl group, an allyl group, an ester group, and halogen atoms; R² is at least a member selected from the group consisting of a lower alkyl group, and a hydrogen atom; n is an integer 1 to 3; and m is an integer 1 to 4].

Preferably, in the above organic silicon compound related to the present invention, R¹ is a lower alkoxy group and/or a hydroxyl group, and n is 3. More preferably, in the above organic silicon compound related to the present invention, R¹ is a lower alkoxy group, n is 3, and m is 2. In this case, the above polymer of the organic silicon compound has the repeating unit which is represented by the following general formula (2):
Chemical Formula 2 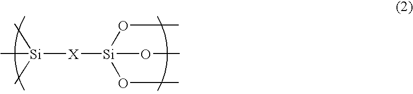
[where X is a fluorescent or phosphorescent organic molecule].

Preferably, the fluorescent or phosphorescent organic molecule related to the present invention has a difference in energy of 40 to 140 kcal/mol between a singlet excited or a triplet excited state, and the ground state.

In the luminescent material of the present invention, the above polymer of the organic silicon compound preferably has a 5 nm or less periodic structure caused by regular sequence of the above-mentioned fluorescent or phosphorescent organic molecules.

The luminescent material of the present invention may further comprise another luminescent compound (preferably phosphorescent material). Such another luminescent compound preferably is in a state selected from the group consisting of “adsorbed on,” “bonded to,” “filled in,” or “mixed with” the above-mentioned luminescent material.

In the luminescent material of the present invention, the above-mentioned polymer of the organic silicon compound is preferably a porous material, more preferably a mesoporous material having pores with a central fine pore diameter of 1 to 30 nm. In this case, the above porous material may further comprise other luminescent compound (preferably phosphorescent material). Such another luminescent compound preferably is in a state selected from the group consisting of “adsorbed on,” “bonded to,” “filled in,” or “mixed with” the above-mentioned porous material. In this case, the above-mentioned porous material may further comprise a surfactant.

In the luminescent material of the present invention, the above-mentioned polymer of the organic silicon compound preferably is a particle having an average particle size of 1 μm or less or thin film having an average thickness of 1 μm or less. Alternatively, it may also be a layered matter formed by the stacking of nanosheets each having a thickness of 10 nm or less. The luminescent material of the present invention may further comprise an electron charge transporting material in addition to the above-mentioned polymer of the organic silicon compound.

The method of producing the luminescent material according to the present invention comprises a process of obtaining the luminescent material by polymerizing the organic silicon compounds represented by the foregoing general formula (1) in the presence of another luminescent compound. In such a method of producing the luminescent material according to the present invention, the above-mentioned organic silicon compound may be polymerized under the coexistence of the above-mentioned another luminescent compound and the surfactant.

The reason is not necessarily clear, why the luminescent material according to the present invention has improved luminous efficiency, checks reduction in luminance derived from concentration quenching to be able to produce high luminescence, and further has an excellent heat resistance and a long service lifetime. Presumably, the fluorescent or phosphorescent organic molecule of the prior art (hereinafter referred to as fluorescence molecule) is quenched at a high concentration thereof due to intermolecular action so that the molecule produces luminescence less efficiently. Therefore, an increase in the concentration renders an improvement in luminance only to a certain limit. In the luminescent material according to the present invention, however, a hydrophobic fluorescent molecule and a hydrophilic silicon-containing group are chemically bonded to each other so that a unique sequence structure in which the fluorescent molecules and silica make a regular sequence is formed based on intermolecular action (hydrophobic and hydrophilic interaction or n-n interaction). It is concluded that, in the luminescent material according to the present invention, the fluorescent molecule does not cause quenching, even in such high concentration that usually causes concentration quenching, thanks to the unique sequence structure of the fluorescent molecules. Thus, each fluorescence molecule efficiently produces luminescence. Furthermore, the present inventors make a conclusion that, in the luminescent material according to the present invention, the chemical bonding between the fluorescent molecule and silica, which is an inorganic matter having an excellent stability, improves the heat resistance of the fluorescence molecule, and helps to maintain a stable luminescence property over a long period of time.

What the present invention makes possible is the provision of the luminescent material which has improved luminance efficiency, which checks reduction in luminance derived from concentration quenching and produces high luminance, and which further has excellent heat resistance and a long service lifetime.

### BRIEF DESCRIPTION OF THE DRAWINGS

FIG. 1 shows various kinds of positive hole transporting materials having low molecular weight.

FIG. 2 is a graph showing the X-ray diffraction pattern of Ph-HMM-c which is obtained in Example 1 and that of Ph-Si which is obtained in Example 2.

FIG. 3 is a graph showing the N₂ adsorption isotherms of samples which are obtained in Examples 1 to 3.

FIG. 4 is a graph showing the X-ray diffraction pattern of Ph-HMM-a which is obtained in Example 3.

FIG. 5 is an SEM photograph of Ph-Si which is obtained in Example 2.

FIG. 6 is a graph showing the visible absorption spectra of samples which are obtained in Examples 1 to 3.

FIG. 7 is a graph showing the fluorescence spectra of samples which are obtained in Examples 1 to 3.

FIG. 8 is a graph showing the X-ray diffraction pattern of BiPh-HMM-c which is obtained in Example 4.

FIG. 9 is a graph showing the X-ray diffraction pattern of BiPh-HMM-c-s which is obtained in Example 5.

FIG. 10 is a graph showing the N₂ adsorption isotherm of BiPh-HMM-c which is obtained in Examples 4.

FIG. 11 is a graph showing the X-ray diffraction pattern of BiPh-Si-Base which is obtained in Example 6.

FIG. 12 is a graph showing the X-ray diffraction pattern of BiPh-Si-Acid which is obtained in Example 7.

FIG. 13 is an SEM photograph of BiPh-Si-Base which is obtained in Example 6.

FIG. 14 is a graph showing the X-ray diffraction pattern of BiPh-HMM-a which is obtained in Example 8.

FIG. 15 is a graph showing the X-ray diffraction pattern of BiPh-HMM-a-s which is obtained in Example 9.

FIG. 16 is a graph showing the nitrogen adsorption isotherm of BiPh-HMM-a which is obtained in Examples 8.

FIG. 17 is a graph showing the visible absorption spectrum of BiPh-HMM-a which is obtained in Examples 8.

FIG. 18 is a graph showing the visible absorption spectrum of BiPh-HMM-c which is obtained in Examples 4.

FIG. 19 is a graph showing the fluorescence spectra of the samples which are obtained in Examples 4 to 9.

FIG. 20 is a graph showing the X-ray diffraction pattern of BiPh-HMMc-s-film which is obtained in Example 10.

FIG. 21 is a graph showing the fluorescence spectrum of BiPh-HMMc-s-film which is obtained in Examples 10.

FIG. 22 is a photograph showing the luminescence of the film of BiPh-HMMc-s-film which is obtained in Example 10.

FIG. 23 is a photograph showing the luminescence of the films of samples 1 to 3 which are respectively obtained in Example 11 to 13.

FIG. 24 is a graph showing the fluorescence spectra of samples 1 to 3 which are respectively obtained in Example 11 to 13.

FIG. 25 is a graph showing the fluorescence spectra of the powder of the luminescent material which is obtained in Example 5 and the powder of the luminescent materials of comparative examples 1 to 3.

FIG. 26 is a graph showing the fluorescence spectra of the film of the luminescent material which is obtained in Example 10 and of the films of the luminescent materials of comparative examples 1 to 3.

FIG. 27 is a graph showing the fluorescence spectra of BTEB solutions.

FIG. 28 is a graph showing the fluorescence spectra of BTEBP solutions.

FIG. 29 is a graph showing the fluorescence spectra of benzene solutions.

FIG. 30 is a graph showing the fluorescence spectra of biphenylene solutions.

FIG. 31 is a graph showing the relationships between the maximum fluorescence intensity and the concentration.

FIG. 32 is a graph showing the results of plotting the maximum luminescence wavelength (λₘₐₓ) to the concentration.

FIG. 33 is a graph showing the fluorescence spectra of the luminescent materials which are obtained in Examples 5 and 9 and the BTEBP solutions.

FIG. 34 is a graph showing the variation due to concentration in the fluorescence intensities of the luminescent materials obtained in Examples 5 and 9, and of the BTEBP solutions.

FIG. 35 is a graph showing the X-ray powder diffraction pattern of the layered phenyl silica composite material which is obtained in Example 14.

FIG. 36 is a graph showing the ²⁹Si MAS NMR spectrum of the layered phenyl silica composite material which is obtained in Example 14.

FIG. 37 is a pattern diagram showing the structure of the layered phenyl silica composite material which is obtained in Example 14.

FIG. 38 is a graph showing the fluorescence spectrum of the layered phenyl silica composite material which is obtained in Example 14.

FIG. 39 is a graph showing the X-ray powder diffraction pattern of the layered biphenyl silica composite material which is obtained in Example 15.

FIG. 40 is a graph showing the X-ray powder diffraction pattern of the toluene-dropped layered biphenyl silica composite material which is obtained in Example 15.

FIG. 41 is a graph showing the fluorescence spectrum of the layered biphenyl silica composite material which is obtained in Example 15.

FIG. 42 shows the X-ray diffraction patterns of samples which are obtained in Example 16 to 18 and that of Ph-HMM-c which is obtained in Example 1.

FIG. 43 is a graph showing the N₂ adsorption isotherm of Ph-HMM-c which is obtained in Example 1.

FIG. 44 is a graph showing the N₂ adsorption isotherm of the sample which is obtained in Example 16.

FIG. 45 is a graph showing the N₂ adsorption isotherm of the sample which is obtained in Example 17.

FIG. 46 is a graph showing the N₂ adsorption isotherm of the sample which is obtained in Example 18.

FIG. 47 is a graph showing the result of ¹³C-CP-NMR of the sample which is obtained in Example 18.

FIG. 48 is a graph showing the result of ²⁹Si-MAS-NMR of the sample which is obtained in Example 18.

FIG. 49 is a graph showing the absorption spectrum of Ph-HMM-c which is obtained in Example 1.

FIG. 50 is a graph showing the absorption spectrum of the sample which is obtained in Example 16.

FIG. 51 is a graph showing the absorption spectrum of the sample which is obtained in Example 17.

FIG. 52 is a graph showing the absorption spectrum of the sample which is obtained in Example 18.

FIG. 53 is a graph showing the standard curve of BTEA.

FIG. 54 is a graph showing the absorption spectrum in the monomer of BTEA.

FIG. 55 is a graph showing the fluorescence spectra of Ph-HMM and of BTEA at 260 nm of excitation wavelength.

FIG. 56 is a graph showing the result of measuring the fluorescence spectra of the samples which are obtained in Example 16 to 18 at 260 nm of excitation wavelength.

FIG. 57 is a graph showing the X-ray diffraction patterns of Ph-HMM-c, of BiPh-HMM-c, of Al-TPPEt/Ph-HMM, and of Al-TPPEt/BiPh-HMM.

FIG. 58 is a graph showing the UV-vis spectra of Al-TPPEt/Ph-HMM.

FIG. 59 is a graph showing the UV-vis spectra of Al-TPPEt/BiPh-HMM.

FIG. 60 is a graph showing the fluorescence spectra of Al-TPPEt/Ph-HMM.

FIG. 61 is a graph showing the fluorescence spectra of Al-TPPEt/BiPh-HMM.

FIG. 62 is a photograph showing the luminescence of Al-TPPEt powder.

FIG. 63 is a photograph showing the luminescence of Al-TPPEt/Ph-HMM powder.

FIG. 64 is a photograph showing the luminescence of Ph-HMM-c powder.

FIG. 65 is a photograph showing the luminescence of BiPh-HMM-c powder.

FIG. 66 is a photograph showing the luminescence of Al-TPPEt/BiPh-HMM powder.

FIG. 67 is a graph showing the X-ray diffraction pattern of BiPh-HMM-c-s-film2 which is obtained in Example 22.

FIG. 68 is a graph showing the fluorescence and the excitation spectra of BiPh-HMM-c-s-film2 which is obtained in Example 22.

FIG. 69 is a graph showing the X-ray diffraction patterns before and after the calcining of Ph-HMM-film which is obtained in Example 23.

FIG. 70 is a graph showing the X-ray diffraction patterns before and after the calcining of BiPh-HMM-film which is obtained in Example 24.

FIG. 71 is a graph showing the fluorescence spectra before and after the calcining of Ph-HMM-film which is obtained in Example 23.

FIG. 72 is a graph showing the fluorescence spectra before and after the calcining of BiPh-HMM-film which is obtained in Example 24.

FIG. 73 is a graph showing the fluorescence and the excitation spectra of BiPh-acid-film which is obtained in Example 25.

FIG. 74 is a graph showing the UV spectrum of BiPh-acid-film which is obtained in Example 25.

FIG. 75 is a graph showing the X-ray diffraction pattern of TPh-HMMc-s-film which is obtained in Example 26.

FIG. 76 is a graph showing the fluorescence and the excitation spectra of TPh-HMMc-s-film which is obtained in Example 26.

FIG. 77 is a graph showing the fluorescence and the excitation spectra of TPh-acid-film which is obtained in Example 27.

FIG. 78 is a graph showing the X-ray diffraction pattern of Pyr-HMMc-s-film which is obtained in Example 28.

FIG. 79 is a graph showing the fluorescence and the excitation spectra of Pyr-HMMc-s-film which is obtained in Example 28.

FIG. 80 is a graph showing the fluorescence and the excitation spectra of Pyr-acid-film which is obtained in Example 29.

FIG. 81 is a graph showing the UV spectrum of Pyr-acid-film which is obtained in Example 29.

FIG. 82 is a graph showing the X-ray diffraction pattern of Ant-HMMc-s-film which is obtained in Example 30.

FIG. 83 is a graph showing the fluorescence and the excitation spectra of Ant-HMMc-s-film which is obtained in Example 30.

FIG. 84 is a graph showing the UV spectrum of Ant-HMMc-s-film which is obtained in Example 30.

FIG. 85 is a graph showing the fluorescence and the excitation spectra of octa-fluoro-biphenyl silica which is obtained in Example 31.

FIG. 86 is a graph showing the fluorescence and the excitation spectra of Tph-HMM-acid which is obtained in Example 32.

FIG. 87 is a graph showing the fluorescence and the excitation spectra of Pry-HMM-acid which is obtained in Example 33.

FIG. 88 is a graph showing the fluorescence and the excitation spectra of Ant-HMM-Acid which is obtained in Example 34.

FIG. 89 is a graph showing the fluorescence and the excitation spectra of Tph-acid which is obtained in Example 35.

FIG. 90 is a graph showing the fluorescence and the excitation spectra of Pry-Acid which is obtained in Example 36.

FIG. 91 is a graph showing the X-ray diffraction pattern of the sample 1 (BiPh-HMM powder) which is obtained in Example 37.

FIG. 92 is a graph showing the X-ray diffraction pattern of the sample 2 (Fl (0.5 mg)/BiPh-HMM powder) which is obtained in Example 37.

FIG. 93 is a graph showing the X-ray diffraction pattern of the sample 5 (Fl (5 mg)/BiPh-HMM powder) which is obtained in Example 37.

FIG. 94 is a graph showing the fluorescence spectra of the samples 1 to 5 which are obtained in Example 37.

FIG. 95 is the structural pattern diagrams of the sample (Fl/BiPh-HMM powder) which is obtained in Example 37.

FIG. 96 is a graph showing the X-ray diffraction pattern of the sample 2 (Fl (2 mol %)/BiPh-HMM film) which is obtained in Example 38.

FIG. 97 is a graph showing the fluorescence spectra of the samples 1 to 3 which are obtained in Example 38.

FIG. 98 is a graph showing the dependence on the excitation wavelength of fluorescence spectra of the sample 2 which is obtained in Example 38.

FIG. 99 is a graph showing the fluorescence spectra of samples (Rhodamine/BiPh-HMM film) obtained in Example 39.

FIG. 100 is a graph showing the fluorescence spectra of samples (pyrene/BiPh-HMM film) obtained in Example 40.

FIG. 101 is a graph showing the absorption spectra of ethanol solutions of EuCl₃ and of TbCl₃.

FIG. 102 is a graph showing the fluorescence spectra of an EuCl₃/BiPh-HMM-film which is obtained in Example 41.

FIG. 103 is a graph showing the fluorescence spectra of a TbCl₃/BiPh-HMM-film which is obtained in Example 42.

FIG. 104 is a graph showing the X-ray diffraction pattern of a BiPh-HMM-film.

FIG. 105 is a graph showing the X-ray diffraction pattern of the coumarin (3 mol %)/BiPh-HMM-film which is obtained in Example 43.

FIG. 106 is a graph showing the fluorescence spectra of a coumarin/BiPh-HMM-film into which different amounts of coumarin are introduced.

FIG. 107 is a graph showing the fluorescence and the excitation spectra of a BiPh-HMM-film, of an ethanol solution of coumarin, and of a coumarin/BiPh-HMM-film.

FIG. 108 is a graph showing the fluorescence spectrum of a coumarin/BiPh composite film into which different amounts of coumarin are introduced.

FIG. 109 is a graph showing the excitation spectra of an Ir(ppy)₃/BiPh-HMM film, of an Ir(ppy)₃/PMMA film, and of a PMMA film.

FIG. 110 is a graph showing the phosphorescence spectra of Ir(ppy)₃/BiPh-HMM films which is obtained in Example 45.

FIG. 111 is a graph showing the fluorescence spectra of the mixtures of R6G and BiPh-HMM which are obtained in Examples 46 to 48.

FIG. 112 is a graph showing the fluorescence spectrum of the mixture of DANS and BiPh-HMM which is obtained in Example 49.

FIG. 113 is a graph showing the fluorescence spectra of the mixtures of coumarin and BiPh-HMM which are obtained in Example 51 to 53, and the spectrum of BiPh-HMM-c2-s which is obtained in Example 50.

FIG. 114 is a graph showing the fluorescence spectra of the mixtures of coumarin and BiPh-HMM which are obtained in Example 51 to 53, and the spectrum of BiPh-HMM-c2-s which is obtained in Example 50.

FIG. 115 is a graph showing the fluorescence spectrum of a BiPh-HMM film obtained in Example 54 into which Rhodamine and coumarin are introduced.

FIG. 116 is a photograph showing that a BiPh-HMM film obtained in Example 54 into which Rhodamine and coumarin are introduced and which is emitting white light.

FIG. 117 is a graph showing the X-ray diffraction pattern of the BiPh-HMM-a-film which is obtained in Example 55.

FIG. 118 is a scanning electron microscope photograph of the fine particles of biphenyl silica which are synthesized in Example 56.

FIG. 119 is a scanning electron microscope photograph of the fine particles of biphenyl silica which are synthesized in Example 56.

FIG. 120 is a graph showing the X-ray diffraction of the fine particles of biphenyl silica which are synthesized in Example 56.

FIG. 121 is a graph showing the fluorescence spectrum of the powder of the fine particles of biphenyl silica which are synthesized in Example 56.

FIG. 122 is a graph showing the absorption spectra of the biphenyl silica fine particle/2-propanol dispersion liquids.

FIG. 123 is a graph showing the fluorescence spectra of the biphenyl silica fine particle/2-propanol dispersion liquids.

FIG. 124 is a graph showing the absorption spectra of 9,10-diphenyl-anthracene/cyclohexane solutions.

FIG. 125 is a graph showing the fluorescence spectra of 9,10-diphenyl-anthracene/cyclohexane solutions.

FIG. 126 is a graph showing the relationships between integrated fluorescence intensity and absorbance.

FIG. 127 is a graph showing the absorption spectrum of BTEBP/2-propanol solution.

FIG. 128 is a graph showing the fluorescence spectrum of BTEBP/2-propanol solution.

### DETAILED DESCRIPTION OF THE PREFERRED EMBODIMENTS

The present invention is hereinafter described according to preferred embodiments.

The luminescent material according to the present invention is characterized in that it is comprised of the polymer of organic silicon compound represented by the following general formula (1):
Chemical Formula 3

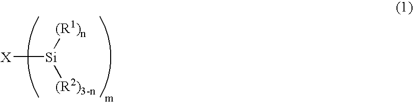

In the above-mentioned general formula (1), X is a fluorescent or phosphorescent organic molecule (hereinafter referred to as “fluorescence molecule”) Such a fluorescence molecule preferably has a difference in energy of from 40 to 140 kcal/mol between a singlet state or a triplet excited state and the ground state. When this difference in energy is less than the above-mentioned lower limit, the fluorescence molecule tends to be difficult to utilize because the wavelength of is too long. On the other hand, when the difference in energy is more than the above-mentioned upper limit, it tends to be difficult to utilize because the wavelength of the fluorescence or of phosphorescence is too short.

Such fluorescence molecules related to the present invention specifically include benzene, biphenyl, benzophenone, fluorene, anthraquinone, naphthalene, acenaphthene, carbazole, triphenylene, phenanthrene, acridine, azulene, chrysene, pyrene, anthracene, perylene, biacetyl, benzyl, fluorescein, eosin, Rhodamine-B and fluorine compounds thereof. Benzene, biphenyl, naphthalene, anthracene, tirphenylene, and pyrene are more preferable among the above-mentioned.

In the above general formula (1), R¹ is at least a member selected from the group consisting of a lower alkoxy group {preferably, alkoxy group (RO—) having 1 to 5 carbons}, a hydroxyl group (—OH), an allyl group (CH₂═CH—CH₂—), an ester group (preferably, ester group (RCOO—) having 1 to 5 carbons), and halogen atoms (chlorine atom, fluorine atom, bromine atom, or iodine atom). A lower alkoxy group, and/or a hydroxyl group are more preferable among them from the viewpoint of an easy control of condensation. In the case where a plurality of R¹s are contained in the same molecule, R¹s may be the same or may differ from each other.

In the above-mentioned general formula (1), R² is at least a member selected from the group consisting of a lower alkyl group (preferably, alkyl group (R—) having 1 to 5 carbons), and a hydrogen atom. When a plurality of R²s are contained in the same molecule, R²s may be the same or may differ from each other.

In the above-mentioned general formula (1), in addition, n and (3-n) are the numbers respectively of the R¹ and of the R² which are bonded to silicon atom (Si). Such n is one of integers 1 to 3, and n is, preferably, 3 in particular, considering that the condensed structure is stable. In the above-mentioned general formula (1), m is the number of silicon atoms (Si) which are bonded to the above-mentioned fluorescence molecule (X). Such m is one of integers 1 to 4, and n is, preferably 2, in particular, from the view point of the easy forming a stable siloxane network.

The luminescent material of the present invention is obtained by polymerizing the organic silicon compounds represented by the above-mentioned general formula (1). Monomers of a kind, which is represented by the above-mentioned formula (1) may be used for polymerization. Alternatively, two or more kinds of monomers, each of which is represented by the above-mentioned formula (1), may be used for copolymerization.

Also, the luminescent material of the present invention may be formed (i) by copolymerizing the organic silicon compounds represented by the above-mentioned general formula (1) and organic silicon compounds containing the X in the above-mentioned general formula (1) which is not an fluorescent nor phosphorescent organic molecule. Alternatively, the luminescent material of the present invention may be formed (ii) by copolymerizing the organic silicon compounds represented by the above general formula (1) and monomers of other kinds. Note that the organic silicon compounds represented by the above general formula (1) and monomers which supplied as necessary for copolymerization are hereinafter generically called “monomers”.

Such organic molecules as ones not emitting fluorescence or phosphorescence include organic groups having one valency or more which are formed by removing one or more hydrogen atoms from hydrocarbons such as alkane, alkene, alkyne, cycloalkane and the like, but are not limited to these groups. Organic compounds which contain organic groups such as amide group, amino group, imino group, mercapto group, sulfone group, carboxyl group, ether group, acyl group, vinyl group and the like may be included. The monomers other than the organic silicon compounds represented by the above general formula (1) include silicon compounds such as alkoxysilane, alkylalkoxysilane and the like. Furthermore, metallic compounds containing inorganic components such as aluminum, titan, magnesium, zirconium, tantalum, niobium, molybdenum, cobalt, nickel, gallium, beryllium, yttrium, lanthanum, hafnium, tin, lead, vanadium, boron and the like may be included. For the copolymerization described above in (i) or (ii), the organic silicon compounds represented by the above general formula (1) preferably account for 30% or more of all monomers used for the copolymerization.

When copolymerizing the organic silicon compounds represented by the above general formula (1), a siloxane bond (Si—O—Si) is formed at the bond area between Si and R¹ in the general formula (1) by hydrolysis and subsequent condensation. At this time, a silanol group (Si—OH) is partially formed in some cases. However, the formation of the silanol group has no effect on luminescence properties. The reaction equation of the reaction in which the organic silicon compounds having, for example, ethoxy group, 3 and 2 as R¹, n, and m in the above general formula (1), respectively are polymerized is represented by the following general formula (3):
Chemical Formula 4 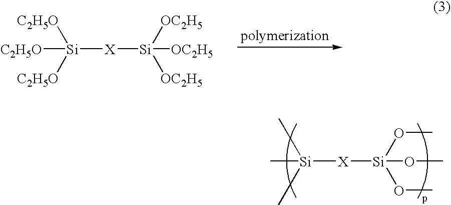
[where X is a fluorescent or phosphorescent organic molecule; and p is an integer equivalent to the number of a repeating unit; the magnitude of p is specifically not limited; preferably, p is generally within the range of approximately 10 to 1000].

The polymer formed by polymerizing the above monomers in this manner is an organic silicon material having a chemical backbone formed from the main components including a fluorescence molecule (X), silicon atoms (Si), and oxygen atoms. And the polymer has a network structure sophisticatedly cross-linked on the basis of a backbone (—X—Si—O—) which the silicon atom bonded to the fluorescence molecule is bonded to via oxygen atoms.

The method of above-mentioned polymerizing monomers is not specifically limited. Preferably, the monomers are hydrolyzed and condensed under the existence of an acid or a base catalyst using water, or a mixed solvent of water and an organic solvent, as a solvent. Organic solvents which are used suitably here include alcohol, acetone and the like. The mixed solvent to be used preferably contains about 5 to 50% by weight of an organic solvent. The acid catalysts to be used include mineral acids such as hydrochloric acid, nitric acid, and sulfuric acid. The acid catalyst solution to be used preferably has acidity of pH 6 or below (more preferably, pH 2 to 5). The base catalysts to be used include sodium hydroxide, ammonium hydroxide, and potassium hydroxide. The base catalyst solution to be used preferably is basic at pH 8 or above (more preferably, pH 9 to 11).

The content of the monomers in such a process of polymerization equivalent to the concentration of silicon preferably is within a range between approximately 0.0055 and 0.33 mol/L. The various conditions (temperature, time and the like) in the polymerization process are not specifically limited. And the conditions are suitably selected corresponding to the monomers to be used and the desired polymer. Preferably, the organic silicon compound is generally hydrolyzed and condensed at about 0 to 100° C. for about 1 to 48 hours.

(Luminescent Material Having a Periodic Structure Caused by the Regular Sequence of the Fluorescence Molecule)

The polymer formed by polymerizing the monomers (the polymer of the organic silicon compound represented by the above general formula (1)) generally has an amorphous structure, but is able to have a periodic structure caused by the regular sequence of the fluorescence molecule depending on the synthesis conditions. The periodicity depends on the molecule length of the monomer to be used. Preferably, the periodic structure has 5 nm or less of periodicity. This periodic structure is also maintained after the monomers have been polymerized. The formation of the periodic structure can be identified when a peak appears in an area in which d is 5 nm or less in an X-ray diffraction (XRD) measurement. When such a peak cannot be identified in the X-ray diffraction measurement, the periodic structure is partially formed in some cases. The periodic structure such as this one is generally formed along with a layered structure described below, but not limited to this case.

When the periodic structure caused by the regular sequence of the fluorescence molecule is formed in the luminescent material of the present invention, luminescence intensity tends to be drastically improved. A mechanism in which the formation of the periodic structure drastically improves the luminescence intensity is not necessarily apparent. The present inventors conclude the mechanism as follows. The concentrated (high density) fluorescence molecule generally causes concentration quenching to reduce luminous efficiency. However, the present inventors conclude that the regular sequence of the fluorescence molecule as described above allows a uniform band structure to be formed and maintained, thus highly efficient production of luminescence becomes possible at a high concentration, and the concentration quenching is more fully inhibited from occurring.

Suitable synthesizing conditions under which the periodic structure caused by the regular sequence of the fluorescence molecule is formed include the following.

(i) Organic group (X), such as, for example benzene, biphenyl, naphthalene, and anthracene, which makes interactions between monomers strong is preferably used because the periodic structure is formed by the interactions.

(ii) The solution preferably has a pH of 1 to 3 (acidic) or of 10 to 12 (basic), more preferably, of 10 to 12 (basic).

The periodic structure can be obtained by conforming to, for example, the method described in S. Inagaki et al., Nature, 2002, Vol. 416, pp 304-307.

(Porous Luminescent Material)

It is possible to form pores in an obtained polymer (the polymer of the organic silicon compound represented by the above general formula (1)) by controlling the synthesizing conditions during polymerizing the monomers, or by mixing a surfactant with the raw material. In the former method, the solvent serves as a mold, and in the latter method, the micelle or liquid crystal structure of the surfactant serves as a mold to form a porous material having pores.

Particularly, the use of a surfactant described later is preferable because it allows the obtaining of a mesoporous material having mesopores having 1 to 30 nm of central pore diameter in a pore diameter distribution curve. The central pore diameter refers to a pore diameter in the maximum peak on the curve (pore diameter distribution curve) formed by plotting the value (dV/dD) obtained by differentiating the pore volume (V) by pore diameter (D) to the pore diameter (D). This can be obtained using the method described subsequently. The porous material is cooled to the temperature of liquid nitrogen (−196° C.) to introduce nitrogen gas. The amount of the adsorbed liquid nitrogen is determined by a constant volume method or a weight method. Then, the pressure of the nitrogen gas to be introduced is gradually increased, and the amount of the adsorbed nitrogen gas is plotted to each equilibrium pressure to obtain an adsorption isotherm. The pore diameter distribution curve can be obtained by using calculation methods, such as Cranston-Inklay method, Pollimore-Heal method, and BJH method, with the obtained adsorption isotherm.

In such a mesoporous material, 60% or more of the total volume of pores preferably has the diameter within a range of plus and minus 40% of the central pore diameter on the pore diameter distribution curve. It is meant that the mesoporous material which meets this condition has a very uniform pore diameter. The specific surface area of the mesoporous material is not limited in particular, but preferably is 700 m²/g or more. The specific surface area can be calculated as a BET specific surface area from the adsorption isotherm by using a BET isotherm adsorption equation.

Furthermore, the mesoporous material such as this one preferably has one or more peaks in a diffraction angle equivalent to 1.5 to 30.5 nm of d value in the X-ray diffraction (XRD) pattern. An X-ray diffraction peak means that there exists a periodic structure having d value equivalent to the peak angle in the sample. Therefore, an existence of one or more peaks in a diffraction angle equivalent to 1.5 to 30.5 nm of d value means that pores are orderly arrayed at 1.5 to 30.5 nm of intervals.

The pores which the mesoporous material has are formed not only on the surface thereof but also in the interior thereof. In such a porous material, the state of the sequence (pore sequence structure or structure) of the pores is not specifically limited, but is preferably of a 2d-hexagonal structure, a 3d-hexagonal structure, or a cubic structure. Also, the pore sequence structure may be a disordered pore sequence structure.

Here, the fact that the porous material has a hexagonal pore sequence structure means that the sequence of pores is of a hexagonal structure (see S. Inagaki et al., J. Chem. Soc., Chem. Commun., 1993, p. 680, S. Inagaki et al., Bull. Chem. Soc. Jpn., 69, 1996, p. 1449, and Q. Huo et al., Science, 268, 1995, p. 1324). Also, the fact that the porous material has a cubic pore sequence structure means that the sequence of pores is of a cubic structure (see J. C. Vartuli et al., Chem. Mater., 6, 1994, p. 2317, and Q. Huo. et al., Nature, 368, 1994, p. 317). In addition, the fact that the porous material has a disordered pore sequence structure means that the sequence of the pores is irregular (see P. T. Tanev et al., Science, 267, 1995, p. 865, S. A. Bagshaw et al., Science, 269, 1995, p. 1242, and R. Ryoo et al., J. Phys. Chem., 100, 1996, p. 17718). The cubic structure preferably is Pm-3n, Ia-3d, Im-3m, or Fm-3m symmetric. The symmetry property above is determined based on the notation of a space group.

As described above, when the luminescent material of the present invention has pores therein, the porous material can be allowed to adsorb (physically adsorb or chemically bond) another luminescent compound described later. In this case, the energy transfer from the aforementioned fluorescence molecule to the another luminescent compound is allowed to occur. As a result, the light having a wavelength which differs from the original luminance wavelength of the fluorescence molecule is emitted. Thus, multiple-colored luminescence becomes possible corresponding to a combination of the fluorescence molecule to be introduced and the luminescent compound. In addition, if the aforementioned periodic structure is formed on the wall of the pore of the porous material, the energy transfer from the fluorescence molecule in the pore wall to the another luminescent compound is efficiently carried out, and thereby the intense emission of the luminescence having a different wavelength being able to be achieved. Furthermore, the introduction of an electric charge transporting material described later into the interior of the pore of the porous material allows the fluorescence molecule in the wall of the pores to efficiently emit the light. In order to obtain the aforementioned mesoporous material, a surfactant preferably is added to the monomer of the present invention prior to polycondensation. This is because the added surfactant serves as a mold to form mesopores in the polycondensation of the aforementioned monomer.

The surfactant which is used to obtain the above mesoporous material is not specifically limited, and may be either of cationic, anionic, or nonionic. Specifically, it includes chlorides, bromides, iodides, or hydroxides of alkyltrimethylammonium, alkyltriethylammonium, dialkyldimethylammonium, benzylammonium or the like; fatty acid salt, alkylsulfonic acid salt, alkylphosphoric acid salt, polyetyleneoxide-based nonionic surfactant, primary alkylamine. These surfactants are used either alone or in combination of two or more kinds.

The polyethyleneoxide-based nonionic surfactant, among the above-mentioned surfactants, includes the polyethyleneoxide nonionic surfactants having hydrocarbon group as a hydrophobic component and a polyethyleneoxide as a hydrophilic component. As such a surfactant, for example, a surfactant represented by a general formula of CₙH₂ₙ₊₁(OCH₂CH₂)ₘ OH, where n is 10 to 30, and m is 1 to 30, can suitably be used. Also, as such a surfactant, esters of fatty acid including oleic acid, lauric acid, stearic acid, and palmitic acid with sorbitan, or compounds formed by adding polyethyleneoxide to these esters can be used.

Furthermore, as such a surfactant, triblock copolymer type polyalkyleneoxide can be used. Such a surfactant includes surfactant which is formed from polyethyleneoxide (EO) and polypropyleneoxide (PO), and which is represented by a general formula of (EO)ₓ(PO)_{y}(EO). Here, x and y represent the numbers of repetition of EO and PO, respectively. Preferably, x is 5 to 110, and y is 15 to 70. More preferably, x is 13 to 106, and y is 29 to 70. The above-mentioned triblock copolymers include (EO)₁₉(PO)₂₉(EO)₁₉, (EO)₁₃(PO)₇₀(EO)₁₃, (EO)₅(PO)₇₀(EO)₅, (EO)₁₃(PO)₃₀(EO)₁₃, (EO)₂₀(PO)₃₀(EO)₂₀, (EO)₂₆(PO)₃₉(EO)₂₆, (EO)₁₇(PO)₅₆(EO)₁₇, (EO)₁₇(PO)₅₈(EO)₁₇, (EO)₂₀(PO)₇₀(EO)₂₀, (EO)₈₀(PO)₃₀(EO)₈₀, (EO)₁₀₆(PO)₇₀(EO)₁₀₆, (EO)₁₀₀(PO)₃₉(EO)₁₀₀, (EO)₁₉(PO)₃₃(EO)₁₉, and (EO)₂₆(PO)₃₆(EO)₂₆. These triblock copolymers are available from BASF Company, Aldrich Corporation and the like. The triblock copolymer having desired x and y values can be obtained in small production scale.

A star diblock copolymer formed by bonding two polyethyleneoxide (EO) chains-polypropyleneoxide (PO) chains to each of the two nitrogen atoms of the ethylenediamine can also be used. Such a star diblock copolymer includes one represented by a general formula of ((EO)ₓ(PO)_{y})₂NCH₂CH₂N((PO)_{y}(EO)ₓ)₂. Here, x and y represent the numbers of repetition of EO and PO, respectively, and preferably x is 5 to 110 and y is 15 to 70. More preferably, x is 13 to 106 and y is 29 to 70.

The salt of alkyltrimethylammonium [CₚH₂ₚ₊₁N(CH₃)₃] (preferably, halide salt) of such surfactants is preferably used because it can provide the mesoporous material having a high crystalline property. In this case, the number of carbons contained in an alkyl group of alkyltrimethylammonium is more preferably 8 to 22. These alkyltrimethylammoniums include octadecyltrimethylammonium chloride, hexadecyltrimethylammonium chloride, tetradecyltrimethylammonium chloride, dodecyltrimethylammonium bromide, decyltrimethylammonium bromide, octyltrimethylammonium bromide, and dococyltrimethylammonium chloride.

In order to obtain a mesoporous material as the polymer of the above monomer, the above monomers are polymerized in a solution containing the above surfactant. In this case, the concentration of the surfactant preferably is 0.05 to 1 mol/L in the solution. When this concentration is less than the lower limit of the range, the formation of the pores tends to be imperfect. On the other hand, when the concentration exceeds the upper limit, the increased amount of the unreacted surfactant tends to remain in the solution to reduce the uniformity of the pores.

Also, the surfactant contained in the mesoporous material obtained in this manner may be removed. The method of removing the surfactant includes, for example,

(i) a method of removing the surfactant by immersing the mesoporous material in an organic solvent (for example, ethanol) in which the surfactant is highly soluble, (ii) a method of removing the surfactant by calcining the mesoporous material at 300 to 1000° C., and (iii) an ion exchange method by which the mesoporous material immersed in a acid solution is heated so that the surfactant would be exchanged with a hydrogen ion.

The mesoporous material can also be obtained by conforming to the method which is described in the Japanese Unexamined Patent Application Publication No. 2001-114790 and the like.

The advantages of making the luminescent material of the present invention porous are (i) that the introduction of another luminescent compound into the pores causes an excited energy on the wall of the pore to be efficiently transferred to the luminescent compound, and makes it possible to emit multi-colored light, (ii) that the deterioration durability of the luminescent compound introduced into the pores is improved, and (iii) that the refraction index of the luminous layer is reduced, thereby resulting in improved efficiency of taking out the light. For example, when an ITO electrode layer and a luminous layer thereon are formed on a glass substrate, there is a problem that the light emitted from the luminous layer reflects on the boundary face between the luminous layer and the ITO layer, on the boundary face between the ITO layer and the glass substrate, or on the boundary face between the glass substrate and the air to reduce the efficiency of taking out the light. In general, it is considered that making the refraction index of the luminous layer closer to that of the air makes the taking out the light more efficient. Making the luminescent material porous allows the refraction index thereof to be close to that of the air.

(Luminescent Material Further Comprising Another Luminescent Compound)

The luminescent material of the present invention is not specifically limited on its structure to further comprise another luminescent compound. The another luminescent compound may be adsorbed on, bonded to, filled in, or mixed with the nonporous or porous luminescent material of the present invention. The adsorption refers to adhesion of the luminescent compound on the surface of the particle or film of the luminescent material in the case of the nonporous luminescent material, and refers to an adhesion of the luminescent compound on the inner surface or on the outer surface of the pores of the luminescent material in the case of the porous luminescent material. The bonding refers to the state in which this adhesion is accompanied by chemical bonding. The filling refers to the existence of the another luminescent compound in the pore of the luminescent material. In this case, the another luminescent compound is allowed not to be adhered to the inner surface of the pores. A material other than the another luminescent compound may be filled in the pores, as long as this material contains the another luminescent compound. The material other than the another luminescent compound includes a surfactant and the like. The mixing refers to the state in which the nonporous or porous luminescent material is physically mixed with the another luminescent compound. At this time, another material other than the luminescent material and the another luminescent compound may further be mixed therewith.

The method of further comprising the another luminescent compound is not specifically limited. The method includes a method of mixing nonporous or porous luminescent material and the another luminescent compound. At this time, mixing the luminescent material with the another luminescent compound which has been resolved in a suitable solvent makes the mixture more uniform, thereby resulting in more efficient light emission.

A method of introducing the another luminescent compound simultaneously with the synthesis of the luminescent material is available. Specifically, the another luminescent compound is added to the monomer, and then the polymerization is carried out. In this case, a surfactant may further be added prior to polymerization. The addition of the surfactant causes a porous material structure to be formed in the polymer with the help of the surfactant serving as a mold. In the pores of the formed porous material, the surfactant and the another luminescent compound are filled, and thus there is, practically, not any pore. The amount of the another luminescent compound is not specifically limited. The addition of 1 to 10 mol % of the another luminescent compound to the monomer allows a sufficient amount of energy to be transferred from the backbone to the luminescent compound.

In the polymer with the another luminescent compound, the backbone formed from the polymer of the monomer can efficiently absorb the light and efficiently transfer the energy to the another luminescent compound. Thus, the luminescence having a different wavelength depending on the another luminescent compound can be obtained. At this time, the backbone formed from the polymer of the monomer can serve as a light-collecting antenna and can intensively inject the collected light energy to the another luminescent compound. As a result, highly efficient and strong luminescence can be achieved.

The method of causing the another luminescent compound to be adsorbed on, bonded to, filled in, or mixed with (hereinafter, in some cases, collectively referred to as “permeating”) the polymer of the organic silicon compound related to the present invention is not specifically limited. Usual methods can be used. For example, a method can be used in which the solution of the another luminescent compound to permeate is sprayed on, impregnated with, or immersed in the above polymer, and then dried. At this time, the solution may be washed as necessary. Also, depressurization or vacuum deaeration may be performed during permeating or drying. This permeation allows the another luminescent compound to be adhered on the surface of the above polymer, filled in the pores, or adsorbed on the surface thereof. The principle of multi-colored luminescence is varied corresponding to the kind and composition of the organic silicon compound and the another luminescent compound, the distance and bonding strength between the two compounds, and the existence of a surfactant and the like. The multi-colored luminescence, however, becomes possible corresponding to a combination of the above factors. In the luminescent material of the present invention, the another luminescent compound to permeate the organic silicon compound can singularly or in combination of two or more kinds be used.

In the case where the luminescent material of the present invention is the aforementioned porous material, as described above, it is preferable that the another luminescent compound be adsorbed on (physically absorbed on and/or chemically bonded to) the porous material.

In the case where the porous material has such another luminescent compound adsorbed thereon, the another luminescent compound preferably is adsorbed on the surface of the porous material, particularly on the surface of the inner wall of the pores. This adsorption may be a physical adsorption generated by the interaction between the another luminescent compound and the functional group existing on the surface of the porous material. Also, the porous material and the another luminescent compound may be fixed by chemically bonding one end of the another luminescent compound to the functional group existing on the surface of the porous material. In the latter case, preferably, the another luminescent compound has, at one end thereof, a functional group which is chemically bonded to the functional group existing on the surface of the porous material (for example, trialkoxysylil group, dialkoxysylil group, monoalkoxysylil group, trichlorosylil group and the like).

In a preferable method for adsorbing the another luminescent compound to the porous material, the porous material is immersed in an organic solvent (for example, benzene, toluene and the like) solution in which the another luminescent compound is dissolved, and the solution is stirred at about 0 to 80° C. for about 1 to 24 hours. By this method, the another luminescent compound is adsorbed on (fixed to) the porous material by physical adsorption and/or chemical bonding.

Such another luminescent compound is not specifically limited, and includes optical functional molecules such as porphyrins, anthracenes, aluminum complex, rare earth elements or complex thereof, fluorescein, Rhodamine (B, 6G and the like), coumarin, pyrene, dansyl acid, cyanine dye, merocyanine dye, styryl dye, benzstyryl dye. The amount of the another luminescent compound adsorbed on the porous material is not limited either, but preferably, is about 20 to 80 parts by weight to 100 parts by weight of the porous material.

A phosphorescent material is preferable as the another luminescent compound related to the present invention. Some phosphorescent materials have a larger difference between absorption wavelength and emission wavelength than a fluorescent material. Therefore, the use of such a phosphorescent material allows efficient absorption of ultraviolet ray having short wavelength, and makes possible efficient red luminescence which has a long wavelength. The combination of such a phosphorescent material and the organic silicon compound having luminescence area in an ultraviolet emission area makes possible luminescence over a wide wavelength range from blue to red. The phosphorescent material to be used is not specifically limited. A suitable phosphorescent material includes the one that allows relatively highly efficient luminescence at room temperature and that has the following structural formula.
Chemical Formula 5

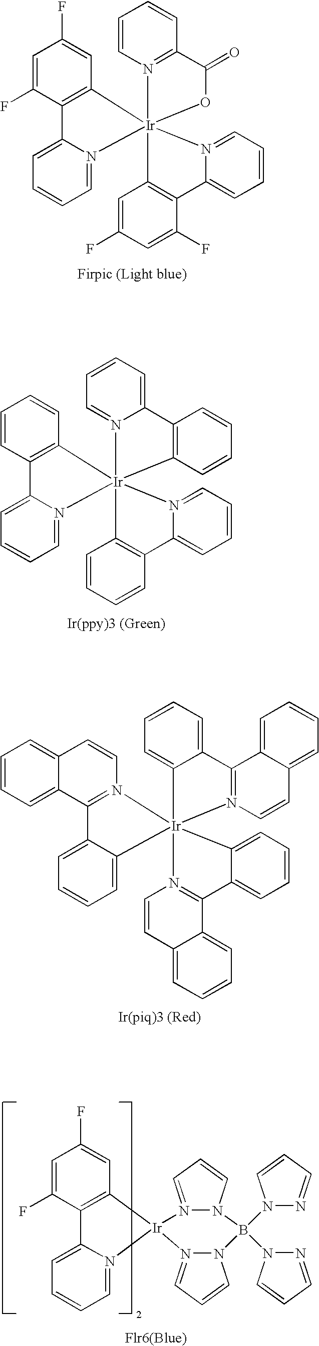

(Thin-Film Luminescent Material)

The conformation of the polymer formed by polymerizing the monomers (the polymer of the organic silicon compound represented by the general formula (1)) is usually particulate. It can be a thin film, and furthermore, be in pattern formed by patterning the thin film as predetermined.

In order to obtain such a thin-film luminescent material, the monomers are first reacted (partially hydrolyzed and partially condensed) by stirring an acidic solution (aqueous solution such as sulfuric acid, nitric acid and the like, or alcohol solution) containing the monomers to obtain a sol solution containing the partial polymer. The hydrolysis of the monomers is easy to occur in a low pH range. Thus, the lowering of the pH of the system can stimulate partial polymerization. In this polymerization, the pH preferably is 2 or less, more preferably, 1.5 or less. The reaction temperature at this time can be approximately 15 to 25° C., and the reaction time can be approximately 30 to 90 minutes.

Next, a thin-film luminescent material can be manufactured by applying this sol solution to a substrate using various kinds of coating methods. The various kinds of coating methods available include a bar coater, roll coater, gravure coater and the like. Also, dip coating, spin coating, and spray coating can be used. In addition, it is also possible to form a patterned luminescent material on a substrate by applying the sol solution using an inkjet method.

Then, preferably, the obtained thin film is heated at about 70 to 150° C. to be dried, and thereby the condensation reaction of the partial polymer is advanced to form a three-dimensional cross-linked structure. Preferably, the average thickness of the obtained thin film is 1 μm or less, more preferably, 0.1 to 0.5 μm. A film thickness exceeding 1 μm tends to reduce the efficiency of luminescence by an electric field.

If the aforementioned periodic structure is formed in such a thin film, the fluorescence molecules in the thin film form the periodic structure, thereby resulting in further improvement in the intensity of luminescence emitted from the thin film. Also, the addition of the aforementioned surfactant to the sol solution allows the formation of a regularly arrayed pore structure in the thin film. Like this, in a case where the thin film is porous material, it becomes possible to adsorb the aforementioned another luminescent compound on the porous material. Thus, it becomes possible to generate luminescence having a wavelength different from the proper luminescence wavelength of the fluorescence molecule.

Such a thin film luminescent material can also be obtained by conforming to the method described in the Japanese Unexamined Patent Application Publication No. 2001-130911.

(Layered Luminescent Material)

The conformation of the polymer formed by polymerizing the aforementioned monomers (the polymer of the organic silicon compound represented by the general formula (1)) can be a layered material formed by layering nanosheets each having a thickness of 10 nm or less. Specifically, the synthesizing conditions can be controlled during polymerization reaction (hydrolysis and condensation) of the aforementioned monomers under the existence of the aforementioned surfactant to obtain such a layered material.

As described above, if the luminescent material of the present invention is formed to be layered, the nanosheet can be immersed in a solvent to be swelled, and thereby a thin film (preferably, a nanosheet with layers each having a thickness of 10 nm or less) can easily be manufactured.

(Luminescent Material Further Comprising an Electric Charge Transporting Material)

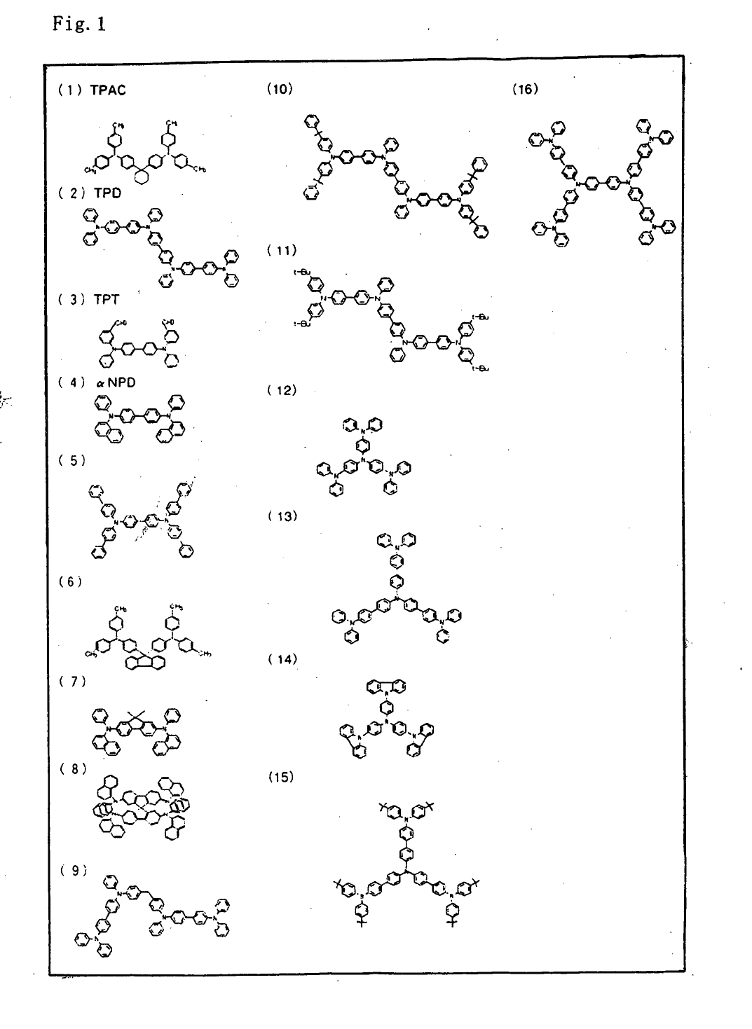

The luminescent material of the present invention may further comprise an electric charge transporting material in addition to the polymer formed by polymerizing the aforementioned monomers (the polymer of the organic silicon compound represented by the general formula (1)). Such an electric charge transporting material includes a positive hole transporting material and an electron transporting material. The former, the positive hole transporting material includes polymers such as poly (ethylene-dioxythiophene)/poly(sulfonic acid) [PEDOT/PSS], polyvinylcarbazole (PVK), polypara-phenylene vinylene derivatives (PPV), polyalkylthiophene derivatives (PAT), polypara-phenylene derivatives (PPP), polyfluorene derivatives (PDAF), and carbazole derivatives (PVK), and various kinds of low molecular positive hole transporting materials shown in FIG. 1. The latter, the electron transporting material includes aluminum complex, oxadiazole, oligophenylene derivatives, phenanthroline derivatives, silole-based compounds. The amount of the electric charge transporting material to be added is not specifically limited, and, in general, preferably is approximately 20 to 80 parts by weight to 100 parts by weight of the aforementioned polymer.

The combination of the electric charge transporting material and the aforementioned thin-film luminescent material should be achieved by mixing the electric charge transporting material with the aforementioned sol solution and applying the mixture in film form to the substrate. Thus, the combination with the electric charge transporting material allows an efficient luminescence by electricity. The structure of the above mixture may be a sea-island structure in which the aforementioned polymer is dispersed in the matrix of the electric charge transporting material, and may also be a structure in which the aforementioned polymer and the electric charge transporting material are uniformly dispersed.

In a case where the electric charge transporting material is combined with the above layered luminescent material, nanosheets constructing the layered material are separated to be dispersed in the electric charge transporting material. As a result, an efficient luminescence by electricity is made possible.

Furthermore, in a case where the electric charge transporting material is combined with the above particulate luminescent material, the dispersion of these particles in the electric charge transporting material allows an efficient luminescence by electricity. The average particle diameter of the particulate luminescent material preferably is 1 μm or less, more preferably 100 nm or less so that the scattering of light would not be caused.

### EXAMPLES

The present invention is hereinafter more specifically described based on examples and comparative examples. The present invention, however, is not limited to the examples described below. A spectrofluorometer FP-6600 available from JASCO was used to measure a fluorescence or phosphorescence spectrum and an excitation spectrum. The vertical axis, intensity of the fluorescence or phosphorescence spectrum, is represented by the amount of energy.

<Synthesis of and Luminescence Property Test on Phenylsilica Composite Material>

### Example 1

Octadecyltrimethylammonium chloride (ODTMA, [C₁₈H₃₇N(CH₃)₃Cl], available from Tokyo Chemical Industry Co., Ltd., 16.665 g, 47.88 mmol) was dissolved at 50 to 60° C. in the mixture of 500 g of ion-exchange water and 40 g (200 mmol, NaOH) of 6N aqueous NaOH solution. 1,4-bis(triethoxysilyl)benzene (BTEB available from Azmax Co., Ltd., 20 g, 49.67 mmol) was added to the above solution, while being vigorously stirred at room temperature. This liquid mixture was subjected to an ultrasonic device for 20 minutes to disperse the separated hydrophobic BTEB in the aqueous solution. Then, the solution was continued to be stirred at room temperature for 20 hours, and left at rest in an oil bath at 95° C. for 20 hours. The formed white precipitate was filtered and dried, and thereby 8.22 g of the precursor of the mesoporous material containing the surfactant was obtained. 1 g of the precursor was dispersed in 250 ml of ethanol to which 9 g of 36% aqueous HCl solution was added. The solution was heated at 70° C., and was stirred for 8 hours. Thus, the surfactant which was contained in the precursor was extracted with the solvent to obtain 0.69 g of the mesoporous material (Ph-HMM-c) of phenylsilica composite material.

### Example 2

A liquid mixture of 50 g of water and 4 g of NaOH was stirred and 2 g of BTEB was quickly put therein. Then, the solution was exposed to ultrasonic waves for 20 minutes. At this time, the solution began becoming cloudy. Then, after the solution had been stirred at ambient temperatures for 24 hours, it became translucent. Then, the solution was left at reflux at 98° C. for 20 hours and left at rest. Heating caused the solution to begin becoming cloudy in white, and then precipitates were gradually formed. The precipitates were filtered and dried at room temperature to obtain a white powder of phenylsilica composite material (Ph-Si).

### Example 3

As poly(ethylene oxide)₂₀-poly(propylene oxide)₇₀-poly(ethylene oxide)₂₀; (P123: Mav=5800) which serves as a triblockcopolymer, one available from Aldrich Corporation was used. 0.99 g of P123 was dissolved in 36 ml of ion-exchange water, and 200 ml of aqueous hydrochloric acid solution (36% by weight) was added therein. 1.01 g of BTEB was added at 0° C. (in an ice bath) to this solution, and the solution was stirred for 1 hour. Then, it was heated at 35° C. and was stirred for 20 hours. This is moved into an airtight container, and heated at 100° C. for another 24 hours. After allowing this solution to cool at room temperature, it was filtered, washed, and the residue was dried to obtain the precursor of the mesoporous material containing the surfactant. The precursor was dispersed in 60 times amount of ethanol, and the solution was stirred for 1 hour or more. Then, it was filtered, dried, and calcined in air at 350° C. for 2 hours to obtain 0.3 g of the mesoporous material (Ph-HMM-a) of phenylsilica composite material.

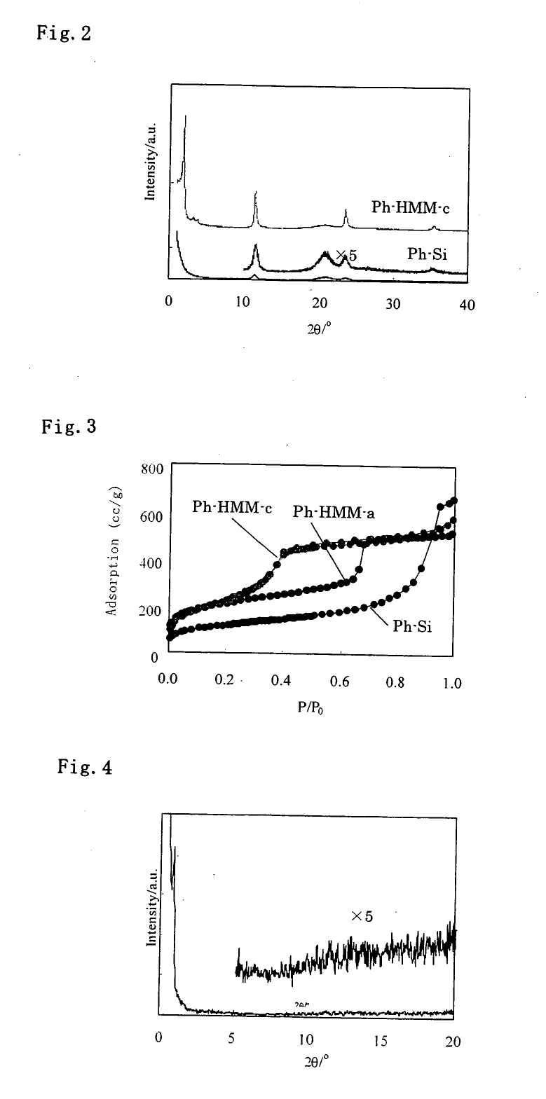

FIG. 2 shows the X-ray diffraction patterns of Ph-HMM-c obtained in Example 1 and of Ph-Si obtained in Example 2. In Ph-HMM-c which was synthesized by adding C₁₈TMA⁺Cl⁻ as a template, a peak which indicates a mesostructure (2D hexagonal) at 2θ=1 to 3°, and peaks at 7.6, 3.8, and 2.5 nm which indicate the periodicity of benzene in the backbone could be observed. In Ph-Si which was synthesized without adding a surfactant, no peak indicating a mesostructure was observed. However, peaks which indicate the periodicity of benzene in the backbone could be observed. In order to investigate each pore structure, N₂ adsorption isotherm was measured. FIG. 3 shows the N₂ adsorption isotherm of Ph-HMM-c. It was observed that the adsorption isotherm is of type IV, and that Ph-HMM-c has a typical mesoporous material structure. The pore diameter and the specific surface area were 3.0 nm, and 835 m²/g, respectively. However, it could be confirmed that Ph-Si has a small specific surface area and does not have a mesopore. The result showed that Ph-HMM-c has both a pore structure and the periodic structure of benzene. And it could be confirmed that Ph-Si does not have a pore structure, but that Ph-Si is a material which has the periodic structure of benzene in the backbone.

On the other hand, FIG. 4 shows the X-ray diffraction pattern of Ph-HMM-a which is synthesized under acidic conditions in Example 3. A peak indicating a mesostructure (2D hexagonal) was observed at 2θ=0.5 to 1°. However, no peak indicating the periodicity of benzene in the backbone could be observed. It was confirmed that the N₂ adsorption isotherm shown in FIG. 3 is of type IV, and that Ph-HMM-a has a typical mesoporous material structure. The pore diameter and the specific surface area were 6.3 nm, and 773 m²/g, respectively. From the above result, it could be confirmed that Ph-HMM-a which is synthesized by adding P123 as a template under acidic conditions has a regular pore structure, but does not have the periodicity of benzene in the backbone of the pore.

Table 1 shows the synthesis conditions used in Example 1 to 3 and the structures of the obtained samples.

TABLE 1

| | | Synthesis | | |
|---|---|---|---|---|
| | | conditions | Structure | |
| | Sample | Surfactant | Meso- | Benzene |
| Example | name | Acidic/Basic | structure | periodicity |
| 1 | Ph-HMM-c | C18TMACl | ◯ | ◯ |
| | | Basic | | |
| 2 | Ph-Si | None | X | ◯ |
| | | Basic | | |
| 3 | Ph-HMM-a | P123 | ◯ | X |
| | | Acidic | | |

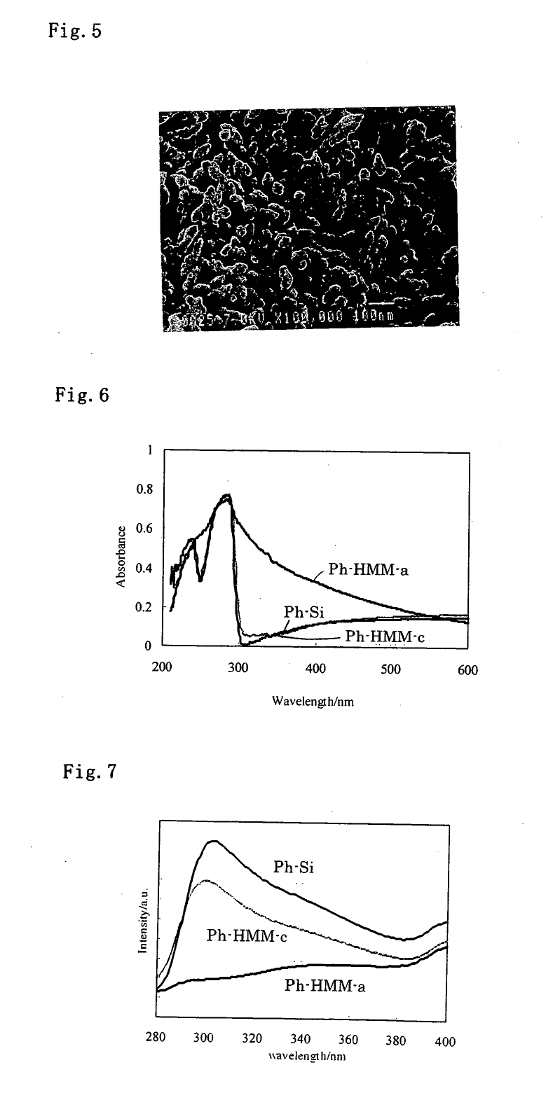

FIG. 5 shows an SEM photograph of Ph-Si obtained in Example 2. It could be observed that the particle diameter of this material is about 100 nm. Also, it was confirmed by thermogravimetry that Ph-Si maintains its structure at up to 500° C.

FIG. 6 shows the visible absorption spectra of samples obtained in Example 1 to 3. The absorption spectrum of Ph-HMM-a was broad and had the maximum absorption wavelength (λₘₐₓ) of 285 nm. The absorption end was observed at a long wavelength of 550 nm (2.3 eV). On the other hand, in the absorption spectrum of Ph-HMM-c, large absorbance was observed at 285 nm, the same as the λₘₐₓ in Ph-HMM-a, and at 240 nm. The spectrum of Ph-HMM-c had a smaller peak width than that of Ph-HMM-a, and the absorption end was at 310 nm (4.0 eV). Note that in Ph-HMM-a, a peak of 240 nm is considered to exist as well, but is considered to be overlapped with 280 nm because the peak width is broad. From the fact that, in Ph-Si, an absorption spectrum similar to that of Ph-HMM-c was obtained, it was confirmed that this difference in absorption spectrum does not depend on the pore structure of each sample but heavily depends on the periodicity of benzene in the backbone of each sample.

FIG. 7 shows the fluorescence spectra of samples obtained in Example 1 to 3. Ph-HMM-a which has a mesopore structure and little periodicity of benzene in the backbone, didn't emit strong fluorescence. The following properties of Ph-HMM-a can explain this. Firstly, in Ph-HMM-a, because of the long and broad UV absorption end, it is envisaged that there exist a variety of energy levels in an excited state. Thus, fluorescence is considered to be reduced because various energy levels were passed when returning to the ground state after being excited at 260 nm. Secondly, it is also envisaged that low periodicity of benzene in the backbone may result in quenching as excimer is formed, and that thermal energy may escape out of the system.

On the other hand, in each of Ph-HMM-c which has both a mesopore structure and the periodicity of benzene in the backbone, and of Ph-Si which does not have a mesopore but which has benzene periodicity, even feeble excitation light emitted a strong fluorescence. A sharp absorption was observed at 280 nm in UV-vis absorption spectrum, but, interestingly, no absorption wavelength of 310 nm or more could not be observed. This suggests that the energy levels between the ground state and an excited state are degenerated, that is, each band is narrow. For these reasons it was confirmed that the regular array of phenyl groups in the backbone allows the occurrence of stable energy transfer between phenyl groups. Another possible reason why feeble excitation light emits fluorescence in Ph-HMM-c and Ph-Si is a quantum well effect. That is, both of Ph-HMM-c and Ph-Si have a structure in which phenyl group and silicate layer alternately regularly are arrayed. Therefore, when being excited at 260 nm, they are not excited in the silicate layer having high absorption energy, and cause the light to operate on the layer of the phenyl group only. It is considered that the layer of the excited phenyl group is sandwiched between the silicate layers which do not contribute to absorption of light, and thereby the light is trapped within the phenyl group layer, thus resulting in emission of strong fluorescence by benzene-silica.

<Synthesis of a Biphenyl Silica Composite Material and Luminescence Property Test Thereof>

### Examples 4 and 5

3.2 mmol of ODTMA was dissolved at 50 to 60° C. in the liquid mixture of 3.3 mol of ion-exchange water and 30.4 mmol of 6N aqueous NaOH solution. 2.5 mmol of 4,4′-bistriethoxysylilbiphenyl (BTEBP, available from Azmax Co., Ltd.) was added at room temperature in the above solution vigorously being stirred, and the mixture was continued to be stirred at room temperature for another 20 hours. The solution was left at rest in an oil bath at 95° C. for 22 hours. The formed white precipitate was filtered and dried to obtain the precursor (BiPh-HMM-c-s) of the mesoporous material containing a surfactant. 0.75 g of the precursor was dispersed in 150 ml of ethanol to which 3.1 g of 2M aqueous hydrochloric acid solution was added. Then, the liquid mixture was stirred at room temperature for 8 hours to extract the surfactant in the precursor with a solvent, thereby the mesoporous material (BiPh-HMM-c) of a biphenyl silica composite material being obtained.

### Example 6

2 g of BTEBP was quickly put in a liquid mixture of 120 ml of water and 6 g of NaOH being stirred. The solution was then exposed to the ultrasonic waves for 20 minutes. At this time, the solution was still transparent and separated into two layers—a BTEBP layer and a water layer. Stirring at room temperature for 24 hours made the solution uniform and transparent. Then, the solution was left at reflux and at rest at 98° C. for 72 hours. The solution began becoming whitish after 24 hours, and then precipitates were formed. The solid content was filtered, and dried at room temperature to obtain the powder of the biphenyl silica composite material (BiPh-Si-Base).

### Example 7

0.6 g (1.25 mmol) of BTEBP was added to an acidic solution prepared by adding 2 ml of 12N HCl to 36 g (2 mol) of water. The solution was exposed to ultrasonic process for 20 minutes, and then stirred at room temperature for 24 hours. Then, the obtained liquid mixture was stirred at 35° C. for 24 hours, filtered, and washed to obtain a white powder. Synthesis was carried out in a mixing ratio of 1:412:4.8=BTEBP:H₂O:HCl. This white powder was calcined in air at 300° C. for 2 hours to obtain the targeted biphenyl silica composite material (BiPh-Si-Acid).

### Examples 8 and 9

1.2 g of BTEBP was added to a liquid mixture of 0.99 g of P123 and 40 ml of 2N aqueous hydrochloric acid solution while the mixture was vigorously being stirred. A mixing temperature was 30° C. This obtained liquid mixture was stirred at 30° C. for 20 hours, and then left at rest at room temperature for 48 hours. Then, this liquid mixture was put in a Teflon autoclave, and then heated at 100° C. for 24 hours. A solid content was filtered and dried at room temperature to obtain the precursor of the mesoporous material containing a surfactant. 0.5 g of the precursor was added to a liquid mixture of 200 ml of ethanol and 0.5 g of 2N aqueous hydrochloric acid solution. And the solution was stirred at room temperature for 8 hours. This operation was repeated once more to obtain the mesoporous material (BiPh-HMM-a) of the biphenyl silica composite material from which a surfactant was completely removed.

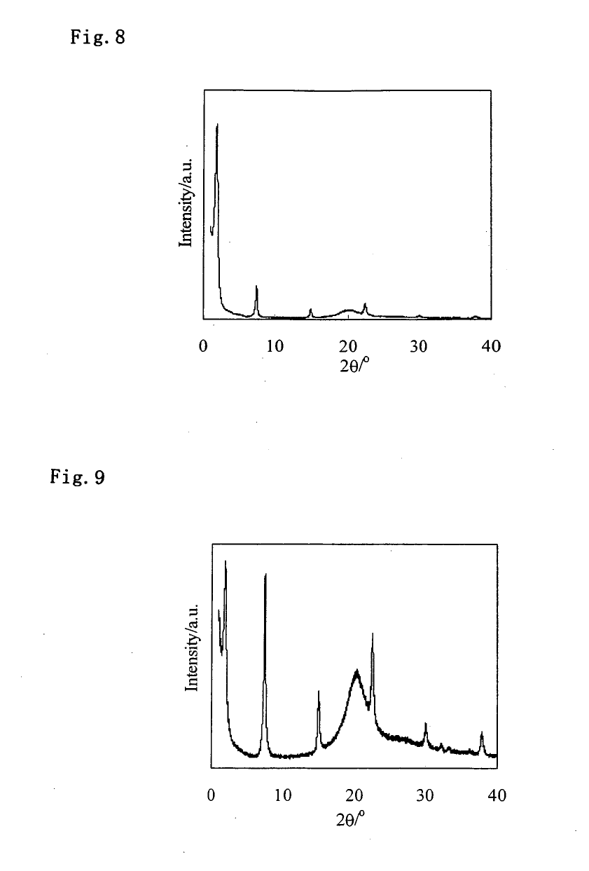

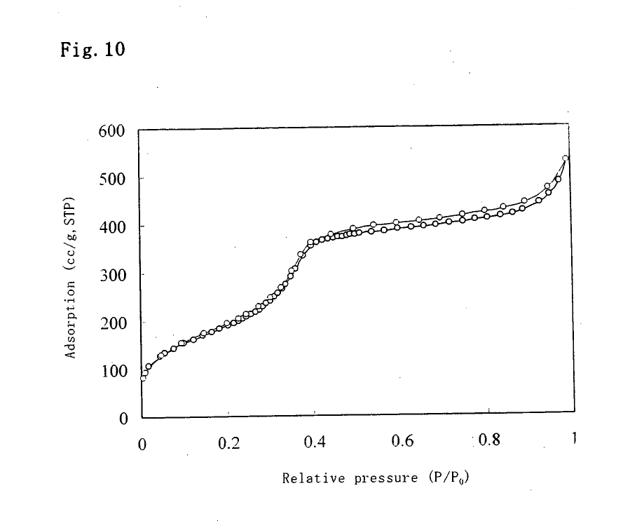

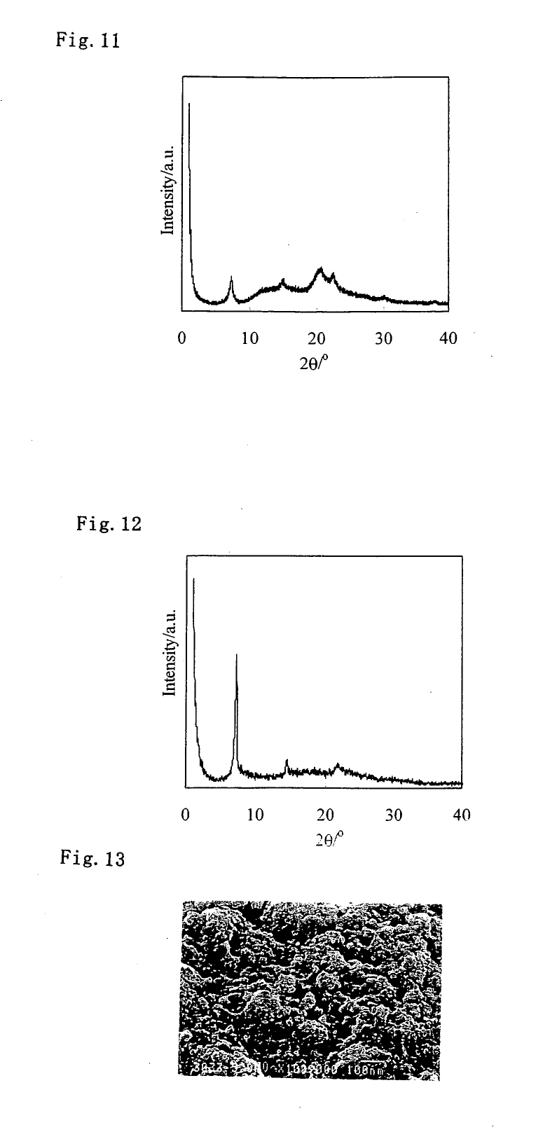

FIG. 8 shows the X-ray diffraction pattern of BiPh-HMM-c obtained in Example 4, and FIG. 9 shows that of BiPh-HMM-c-s obtained in Example 5. In each pattern, a peak at 1.19 nm which indicates the periodicity of biphenyl in the backbone was observed, as well as a peak which indicates a mesostructure (2D hexagonal) at 2θ=1 to 30. FIG. 10 shows the result of measurement of the N₂ adsorption isotherm, which was performed to investigate the interior structure of the pore of BiPh-HMM-c obtained in Example 4. It was confirmed that the adsorption isotherm is of IV type and that BiPh-HMM-c has a typical mesoporous structure. The pore diameter of BiPh-HMM-c was 3.0 nm and the specific surface area thereof was and 709 m³/g.

FIG. 11 shows the X-ray diffraction pattern of BiPh-Si-Base obtained in Example 6, and FIG. 12 shows that of BiPh-Si-Acid obtained in Example 7. In each of these patterns, a peak which indicates the mesostructure on low-angle side was not observed, and only the peak at 1.19 nm that indicates the periodicity of biphenyl was observed. From this, it was observed that the biphenyl silica composite material has a structure in which biphenyl groups are regularly arrayed even when it is synthesized not adding a surfactant. FIG. 13 shows an SEM photograph of BiPh-Si-Base obtained in Example 6. From this SEM photograph, it is confirmed that the primary particle diameter of BiPh-Si-Base obtained in Example 6 is very small as small as 100 nm or less.

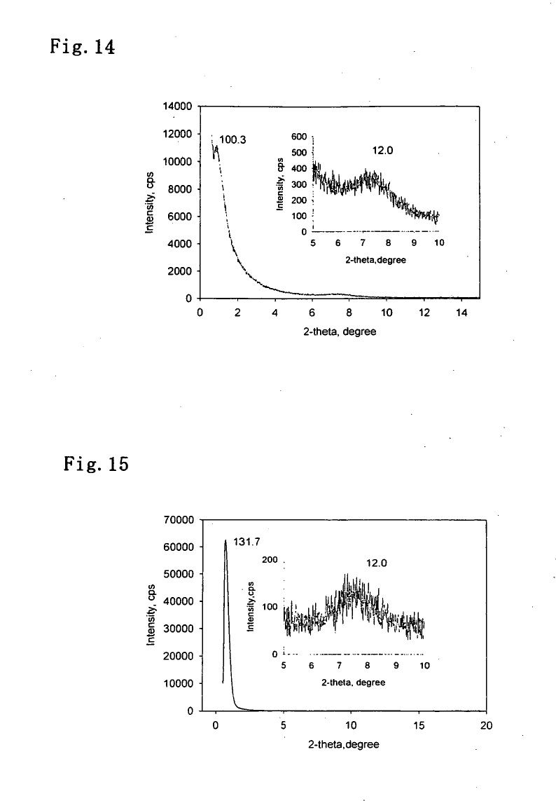

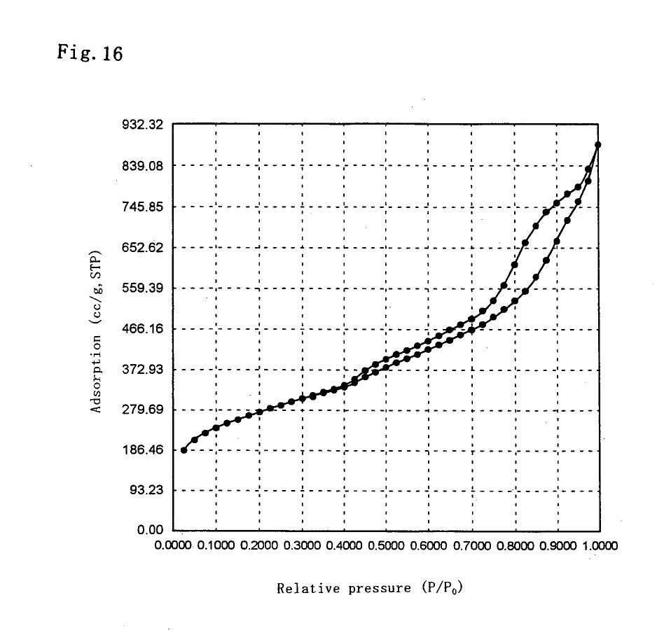

FIG. 14 shows the X-ray diffraction pattern of BiPh-HMM-a obtained in Example 8, and FIG. 15 shows that of BiPh-HMM-a-s obtained in Example 9. In BiPh-HMM-a and BiPh-HMM-a-s, both of which were synthesized using a surfactant under acidic conditions, a distinctive peak at 2θ=0.5 to 1° which indicates the mesostructure was observed, but a peak which indicates the periodicity of biphenyl in the backbone was low. FIG. 16 shows the nitrogen adsorption isotherm of BiPh-HMM-a obtained in Example 8. The specific surface area was as large as 926 m²/g. The pore diameter was 5.5 nm. From the above result, it could be confirmed that the sample synthesized by adding P123 as a template under acidic conditions has a regular pore structure, and a low periodicity of biphenyl of the pore backbone.

Table 2 shows the synthesis conditions and the structure of each of the samples obtained in Examples 4 to 9.

TABLE 2

| | | Synthesis | | | |
|---|---|---|---|---|---|
| | | conditions | Structure | | |
| | | Surfactant | Meso- | Biphenyl | Removal of |
| Example | Sample name | Acidic/Basic | structure | periodicity | surfactant |
| 4 | BiPh-HMM-c | C18TMACl | ◯ | ◯ | ◯ |
| | | Basic | | | |
| 5 | BiPh-HMM-c-s | C18TMACl | ◯ | ◯ | X |
| | | Basic | | | |
| 6 | BiPh-Si-Base | None | X | ◯ | — |
| | | Basic | | | |
| 7 | BiPh-Si-Acid | None | X | ◯ | — |
| | | Acidic | | | |
| 8 | BiPh-HMM-a | P123 | ◯ | Δ | ◯ |
| | | Acidic | | | |
| 9 | BiPh-HMM-a-s | P123 | ◯ | Δ | X |
| | | Acidic | | | |

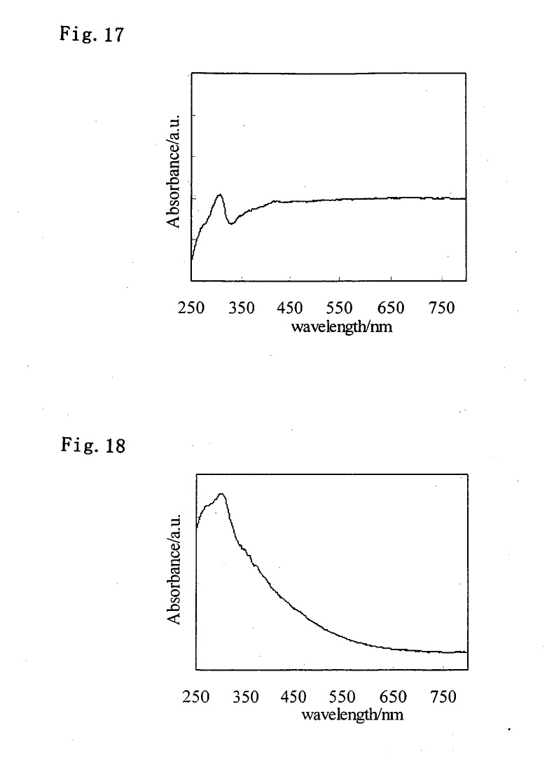

FIG. 17 shows the visible absorption spectrum of BiPh-HMM-a obtained in Example 8. And FIG. 18 shows that of BiPh-HMM-c obtained in Example 4. The absorption spectrum of BiPh-HMM-a was broad and has the maximum absorption wavelength (λₘₐₓ) of 300 nm. Also, the absorption end was observed at a long wavelength as long as 600 nm. On the other hand, in the absorption spectrum of BiPh-HMM-c, a large absorbance was observed at 303 nm the same as the λₘₐₓ of BiPh-HMM-a. The peak width was narrower than that of BiPh-HMM-a, and absorption end was observed at 325 nm. Also in the absorption spectrum of BiPh-HMM-a, it is conceivable that a peak exists at 240 nm, but the peak is overlapped with another peak at 280 nm as the peak width is broad.

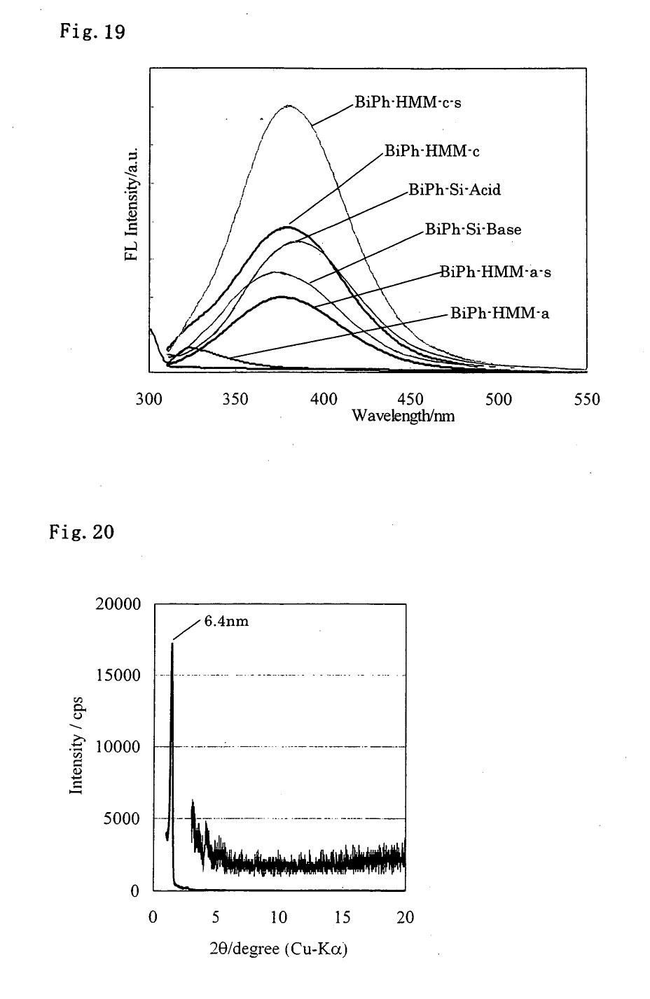

FIG. 19 shows the fluorescence spectra of samples obtained in Examples 4 to 9, which were measured using excitation light of 300 nm. The mesoporous material BiPh-HMM-a having low biphenyl regularity did not emit strong fluorescence. The mesoporous material BiPh-HMM-c having a high biphenyl regularity structure emitted strong fluorescence. It was observed that BiPh-HMM-c gleams blue when the sample is exposed to the excitation light (250 nm). As compared to biphenyl (C₆H₅—C₆H₅), an increase in the fluorescence intensity of BiPh-HMM-c and a red-shift of the maximum luminescence wavelength toward the visible light side were observed. As compared to benzene silica, the red-shift of the maximum luminescence wavelength due to the difference in n-conjugation and an increase in the fluorescence intensity were also observed. It is conceivable that the increase in the fluorescence intensity is caused by the quantum yield (0.69) of biphenylene higher than that of benzene (0.29).

On the other hand, it was found that Ph-HMM-a-s and BiPh-HMM-c-s still containing a surfactant in mesopores emitted stronger fluorescence than that emitted by the mesoporous material from which the surfactant had been removed. A possible reason for this is that the template (surfactant) remained in the mesopores, as had been introduced, prevents oxygen from being in contact with the biphenyl group, and quenching by oxygen is prevented, as a result.

Both of BiPh-Sis synthesized without a template showed strong fluorescence intensity. BiPh-Si-Acid which was synthesized under acidic conditions had higher fluorescence intensity than BiPh-Si-Base. A possible reason for this is that BiPh-Si-Acid synthesized under acidic conditions has a higher orientation of biphenyl than BiPh-Si-Base.

<Synthesis and Luminescence Property Test of Film Luminescent Material (1)>

### Example 10

0.09 g of ion exchange water and 10 μl of 2N aqueous hydrochloric acid solution were added to 2 g of ethanol (EtOH) to produce a uniform solution. 0.6 g of BTEBP was added to this solution being stirred. The mixture was stirred at room temperature for 1 hour. Then, a solution prepared by adding 0.43 g of a surfactant Brij76 (C₁₈H₃₇ (EO)₁₀) to 2 g of EtOH was added to the above mixture. The solution was stirred for another 1 hour to obtain a transparent sol solution. The composition of the sol solution was in a ratio of 1:0.48:4:0.016:69.4=BTEBP:Brij76:H₂O:HCl:EtOH. A glass substrate was coated with this sol solution using a dip coating method to obtain a uniform coat film (film thickness: 450 nm). The dipping was carried out under conditions of 2 cm/min of dipping speed and 2 hours of immersing time.

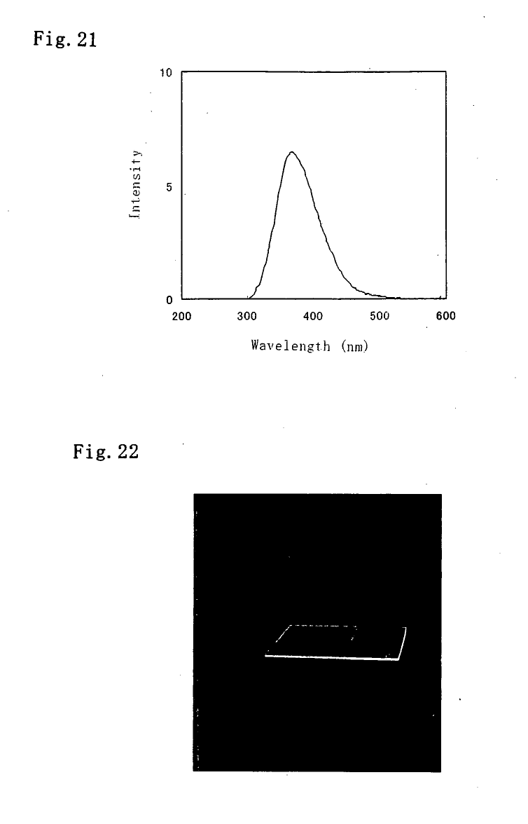

FIGS. 20, 21, and 22 show the X-ray diffraction pattern of the film (BiPh-HMM-s-film) of the biphenyl silica composite material obtained in Example 10, the fluorescence spectrum thereof, and a photograph thereof showing the luminescence of the film exposed to a back light having a wavelength of 254 nm, respectively. A distinctive peak at d=6.4 nm is observed in the X-ray diffraction pattern, and it is observed that the film has a regular mesostructure (FIG. 20). However, no peak at d=1.19 nm corresponding to the periodic structure of biphenyl was observed. In the fluorescence spectrum, strong luminescence was observed near 380 nm (FIG. 21). It is observed that the film gleamed blue when exposed to the light having a wavelength of 254 nm (FIG. 22).

### Examples 11 to 13

10 μl of 2N aqueous HCl solution was added to a mixture solvent of 2 g of ethanol (EtOH) and 0.09 g of ion-exchange water. 0.6 g of BTEBP was added to this solution being vigorously stirred. The solution was stirred at room temperature for 30 minutes. A solution prepared by dissolving 0.43 g of surfactant Brij76 (C₁₈H₃₇(EO)₁₀) in 2 g of EtOH was added therein. The solution was stirred for another 30 minutes to obtain a transparent sol solution. The composition of the sol solution was in a ratio of 1:0.48:4:0.016:69.44=BTEBP:Brij76:H₂O:HCl:EtOH. This sol solution was diluted by 2.65 g of EtOH to prepare a solution A. 0.01 g of polyvinylcarbazole (PVK) was dissolved in tetrahydrofuran to prepare a solution B.

A mixture solution was prepared by mixing a predetermined amount of the solution A and a predetermined amount of the solution B. In the thin film (PVK/BiPh-HMM film) of PVK containing biphenyl silica composite material obtained thereby, the PVK-to-BiPh-HMM content ratio (solid content) was made to be those (by weight) shown in Table 3. A glass substrate was spin-coated with the obtained mixture solution at 3000 rpm of revolution speed for 30 seconds of revolution time to obtain a uniform coat film (film thickness: 100 to 300 nm) thereon. In Example 11, dilution by 2.65 g of EtOH was not carried out. The coat film was prepared using a dip coating method.

TABLE 3

| | | Film |
|---|---|---|
| Example | PVK/BiPh-HMM Solid content | thickness (nm) |
| 11 | 0/1 | ≈450 |
| 12 | 1/1 | ≈100 |
| 13 | 3.2/1 | ≈300 |

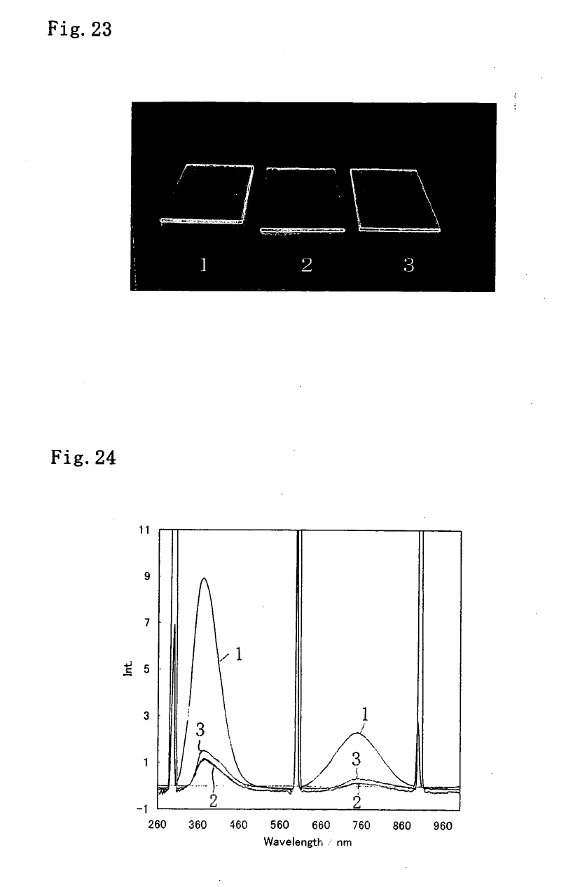

FIG. 23 shows a photograph showing the luminescence of the films of the sample 1 obtained in Example 11, of the sample 2 obtained in Example 12, and of sample 3 obtained in Example 13 which were exposed to a back light having a wavelength of 254 nm. It was observed that each sample emits strong luminescence. FIG. 24 shows fluorescence spectra of the samples 1 to 3 respectively obtained in Examples 11 to 13.

<Comparative Testing in Luminescence Properties with Conventional Luminescent Materials>

### Comparative Examples 1 to 3

A comparison was made between the luminescence spectra of the luminescent materials of the present invention and those of typical luminescent materials conventionally available represented by the following three. These luminescent materials were prepared in powder and in coat film (film thickness: 200 nm) formed on a glass substrate. Note that, to form the coat film with each luminescent material, a spattering method was employed.

### Comparative Example 1

Bis[N-(1-naphtyl)-N-phenyl]benzidine (NPB)

### Comparative Example 2

4,4′-Bis(9-carbazolyl)-biphenyl (CBP)

### Comparative Example 3

Poly(9-vinylcarbazole) (PVK).

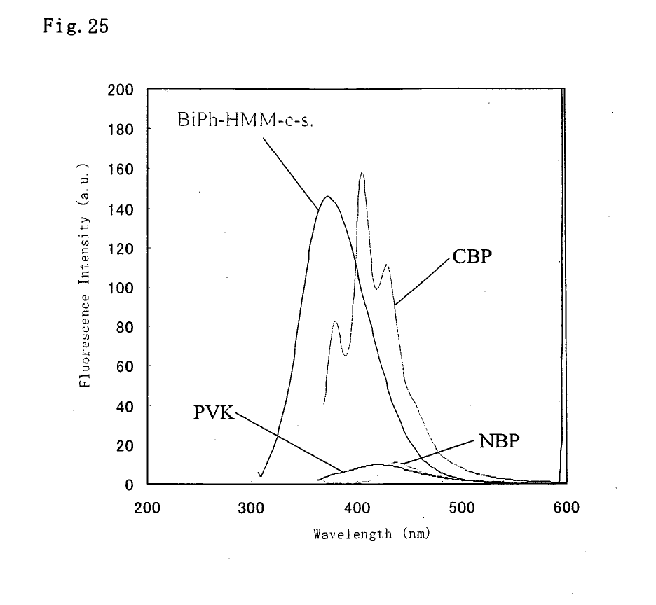

FIG. 25 shows the result of measuring the fluorescence spectrum of the mesoporous material (containing a surfactant, BiPh-HMM-c-s) of biphenyl silica composite material in powder obtained in Example 5 and the spectra of the luminescent materials in powder in Comparative examples 1 to 3. The excitation wavelength of 300 nm was used for BiPh-HMM-c-s, and one of 365 nm was used for CBP, NBP, and PVK.

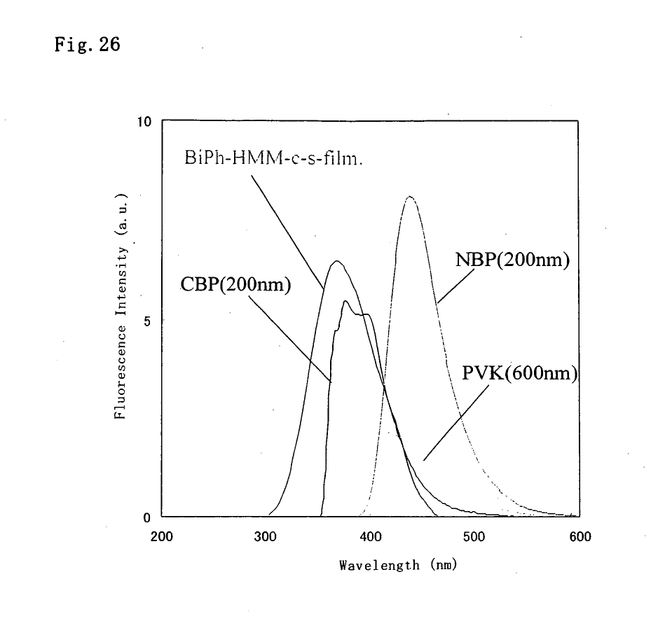

FIG. 26 shows the result of measuring the fluorescence spectrum of the film of the biphenyl silica composite material (BiPh-HMM-c-s-film) obtained in Example 10 and the spectra of the films of the luminescent materials in Comparative examples 1 to 3. The excitation wavelength of 300 nm was used for BiPh-HMM-c-s-film and one of 256 nm was used for CBP, NBP, and PVK.

When comparing the results shown in FIGS. 25 and 26, it was observed that both of BiPh-HMM-c-s and BiPh-HMM-c-s-film which are the luminescent materials of the present invention emit luminescence having intensity equivalent to or more than that of the conventional luminescent materials.

<Comparative Testing in Luminescence Properties with Monomer Solution>

### Comparative Example 4

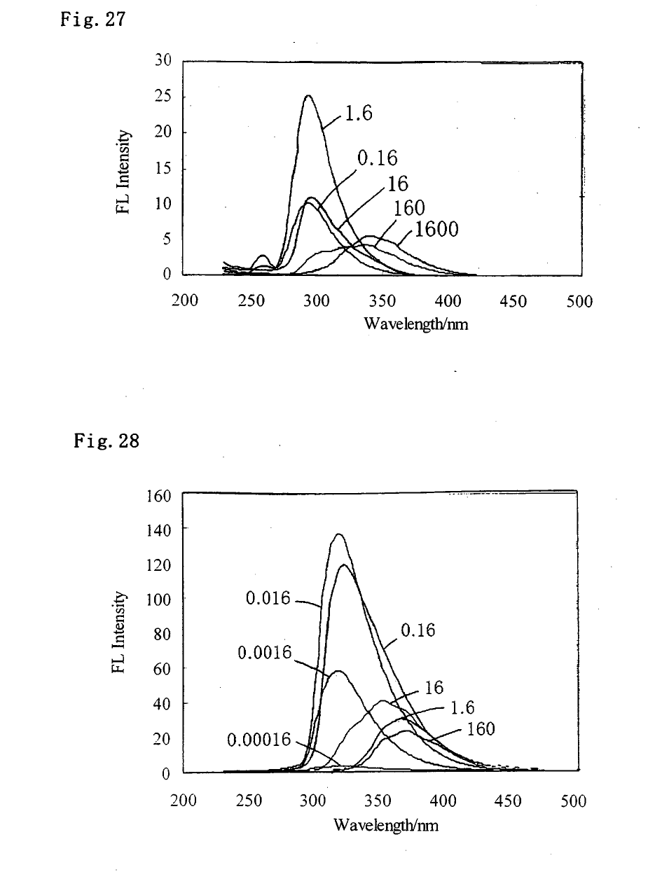

FIG. 27 shows the result of measuring the fluorescence spectra of sample solutions prepared by mixing dichloromethane and 1,4-bistriethoxysylilbenzene (BTEB) (a monomer reagent) in mixing ratios (Unit: mM) shown in FIG. 27.

### Comparative Example 5

FIG. 28 shows the result of measuring the fluorescence spectra of sample solutions prepared by mixing dichloromethane and 1,4-bistriethoxysylilbiphenyl (BTEBP) (a monomer reagent) in mixing ratios (Unit: mM) shown in FIG. 28.

Each of BTEB and BTEBP has a concentration which exhibits the maximum fluorescence intensity. Quenching occurring over and below the concentration which exhibits the maximum fluorescence intensity is attributable to the concentration quenching on the high concentration side and to the reduction in the number of molecule itself which emits luminescence on the low concentration side.

### Comparative Example 6

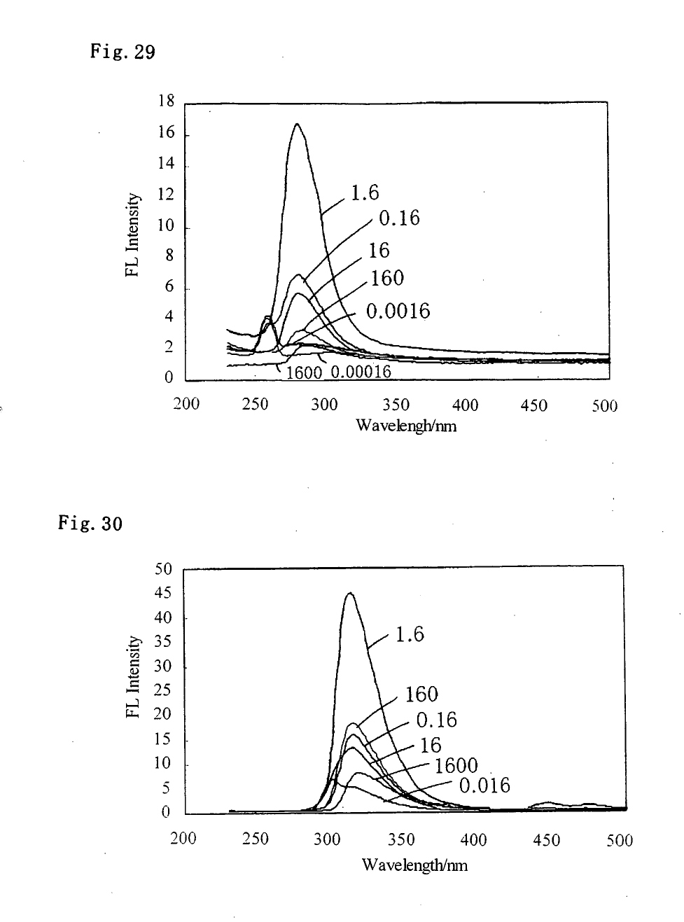

FIG. 29 shows the result of measuring the fluorescence spectra of sample solutions prepared by mixing dichloromethane and benzene which does not contain a Si source (a monomer reagent) in mixing ratios (Unit: mM) shown in FIG. 28.

### Comparative Example 7

FIG. 30 shows the result of measuring the fluorescence spectra of sample solutions prepared by mixing dichloromethane and biphenylene which does not contain a Si source (a monomer reagent) in mixing ratios (Unit: mM) shown in FIG. 30.

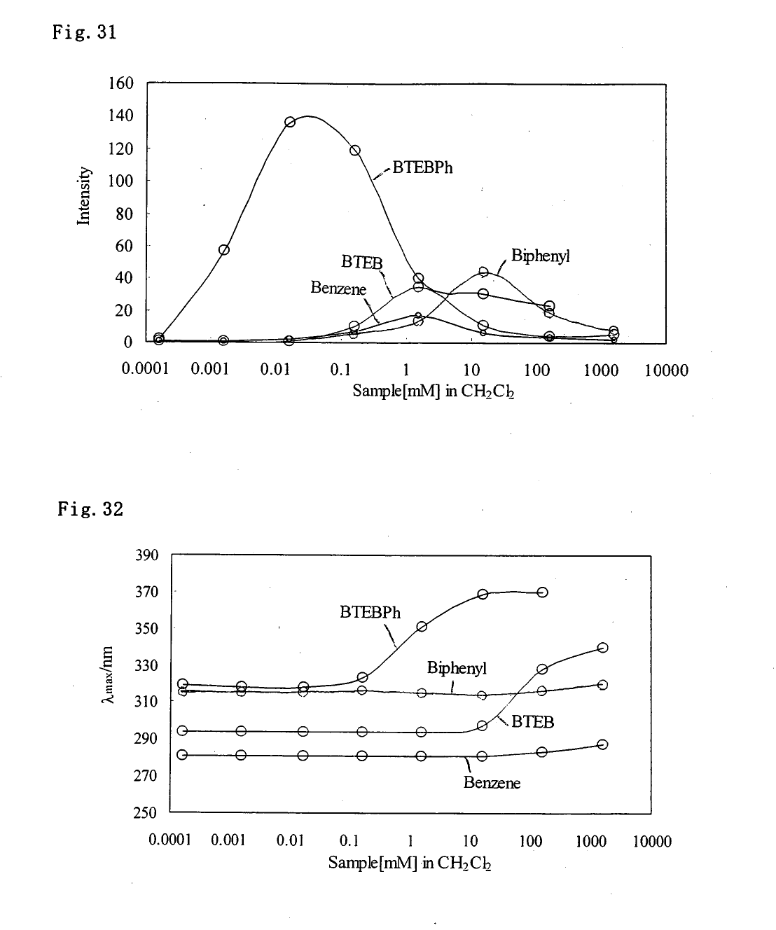

As apparent from the relationship between the maximum fluorescence intensity and the concentration shown in FIG. 31, both of the maximum luminescence intensity of benzene and that of biphenylene were lower than those of BTEB and of BTEBP each of which contains a Si source. This is considered to be influenced by substituents.

FIG. 32 shows the result of plotting the maximum luminescence wavelengths (λₘₐₓ) of all samples with respect to the concentrations. The maximum luminescence wavelengths of BTEB and BTEBP, each containing a Si source, were largely blue-shifted in the low concentration. Nevertheless, this phenomenon was not observed in benzene and biphenylene. This difference is caused probably by the formation of molecule aggregates in a high concentration because the substitution groups of BTEB and BTEBP have an ethoxy group.

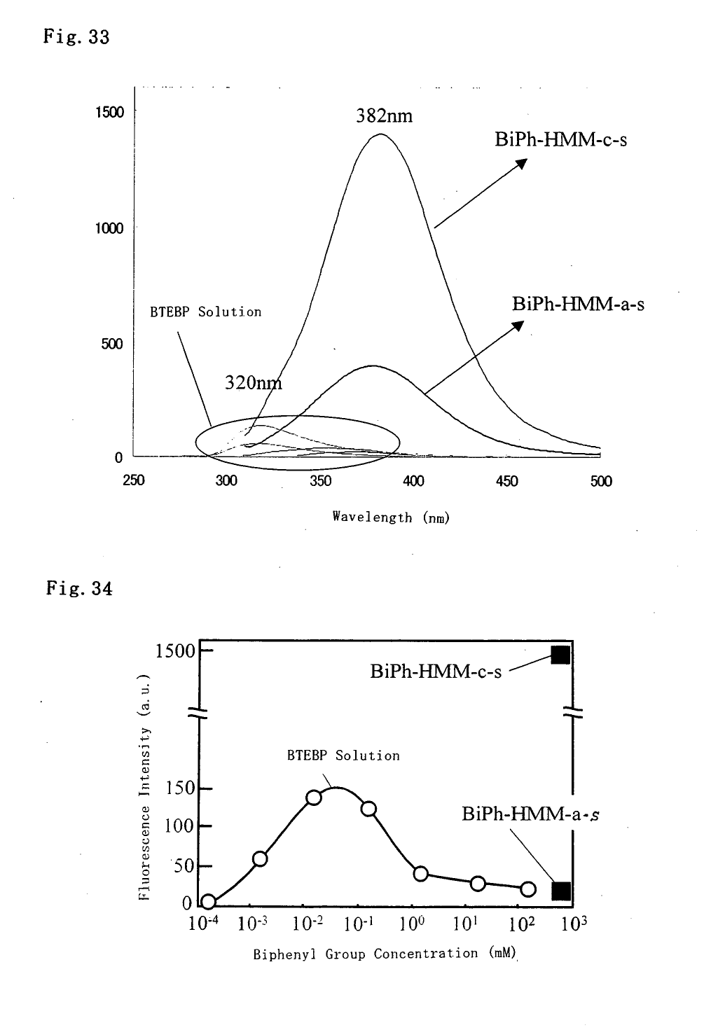

Next, FIG. 33 shows the result of measuring the fluorescence spectrum of the powder of the mesoporous material of the biphenyl silica composite material obtained in Example 5 (BiPh-HMM-c-s), the spectrum of the powder of the mesoporous material of the biphenyl silica composite material obtained in Example 9 (BiPh-HMM-a-s), and the spectrum of the solution of BTEBP (a monomer). The result demonstrated that the fluorescence intensity of the mesoporous material of the biphenyl silica composite material obtained in Example 5 is approximately ten times higher than the maximum fluorescence intensity of the monomer solution, and that the fluorescence intensity of the mesoporous material of the biphenyl silica composite material obtained in Example 9 is higher than the maximum fluorescence intensity of the monomer solution.

FIG. 34 shows the comparison of change in fluorescence intensity relative to the concentration between the BTEBP solution and the mesoporous materials of biphenyl silica composite materials obtained in Examples 5 and 9. The density of biphenyl group of BiPh-HMM is equivalent to 1000 mM of the concentration of biphenyl. It was demonstrated that, although complete concentration quenching occurs in biphenyl monomer having a concentration of 1000 mM, the mesoporous material of the biphenyl silica composite material obtained in Example 5 (BiPh-HMM-c-s) in which biphenyls are regularly arrayed emits strong luminescence. On the other hand, the mesoporous material of biphenyl silica composite material obtained in Example 9 (BiPh-HMM-a-s) which has no regular structure of biphenyl exhibited fluorescence intensity nearly equal to that of BTEBP solution. It was demonstrated that the strong fluorescence of BiPh-HMM-c-s is influenced by a unique array structure of biphenyl.

<Synthesis and Luminescence Property Test of Layered Phenylsilica Composite Material>

### Example 14

16.665 g (47.88 mmol) of ODTMA was dissolved at 50 to 60° C. in a liquid mixture of 500 g of ion-exchange water and 40 g (200 mmol NaOH) of 6N aqueous NaOH solution. 20 g (49.67 mmol) of BTEB was added at room temperature to the solution vigorously being stirred. The mixture solution was exposed to ultrasonic waves for 20 minutes to cause the separated hydrophobic BTEB to be dispersed in the solution, and then continued to be stirred at room temperature for 20 hours. The solid content was filtered and dried to obtain 9.5 g of layered phenylsilica composite material.

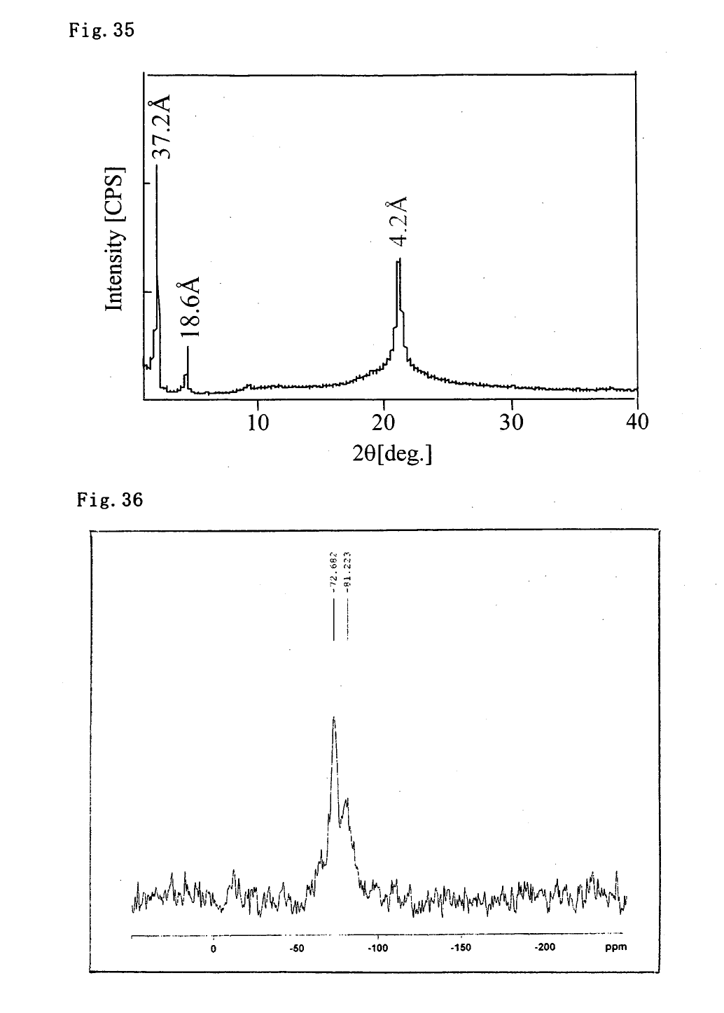

FIG. 35 shows the X-ray powder diffraction pattern of the obtained layered phenylsilica composite material. From the fact that distinctive diffraction peaks of d=37.2 Å and 18.6 Å were observed at 2θ=10° or less of a low angle area, it was demonstrated that this material has a layered structure. Furthermore, from the fact that a peak of d=4.2 Å was observed in the wide angle area, it was demonstrated that a structure in which phenyl groups are regularly arrayed are formed.

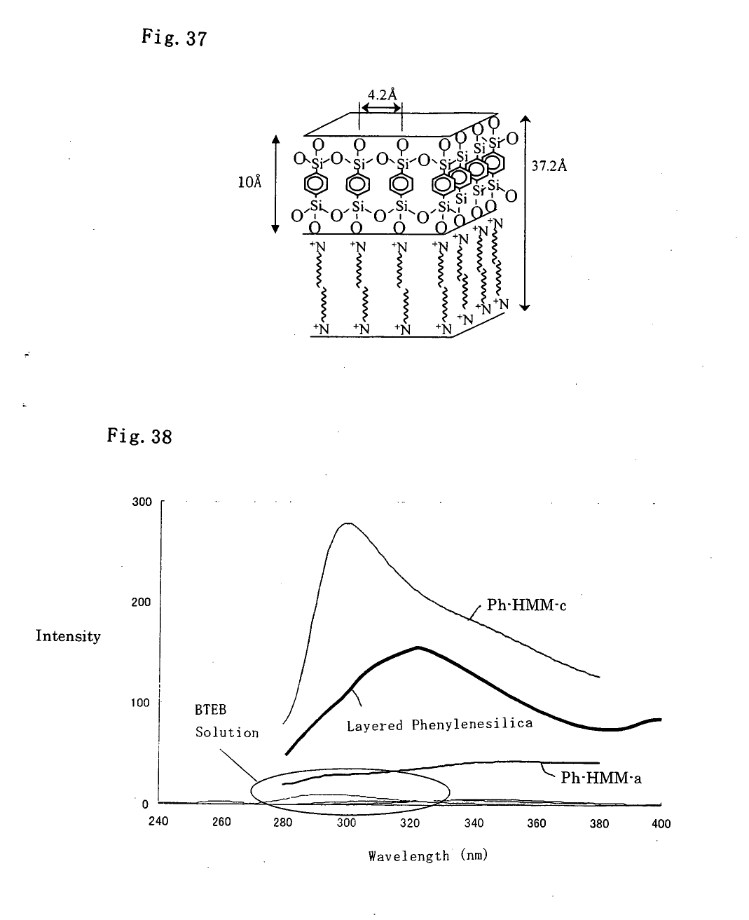

FIG. 36 shows ²⁹Si MAS NMR spectrum of the obtained layered phenylsilica composite material. Two signals are observed at d=−72.7 and −81.2 ppm. Each of them is attributed to T2[SiC(OH)(OSi)₂] and to T3[SiC(OSi)₃]. From these results, it was demonstrated that the obtained layered phenylsilica composite material has a layered structure having a sheet of phenyl silica having a thickness of about 10 Å as shown in FIG. 37. Also, as apparent from the fluorescence spectrum (wavelength of excitation light: 260 nm) shown in FIG. 38, it was demonstrated that the obtained layered phenyl silica composite material emits strong luminescence.

<Synthesis And Luminescence Property Test of Layered Biphenyl Silica Composite Material>

### Example 15

4.5 g of ODTMA was dissolved in 50 ml of water. Then, 800 μl of 6N aqueous NaOH solution was added to the above solution. The obtained solution was cooled to 4° C. by ice and then 2 g of BTEBP was added thereto. After that, ultrasonic wave processing was carried out for 20 minutes. And the solution was stirred for 24 hours while being cooled by ice. White precipitates were formed, and thus filtered to collect them. The collected precipitates were dried to obtain 8.9 g of the layered biphenyl silica composite material.

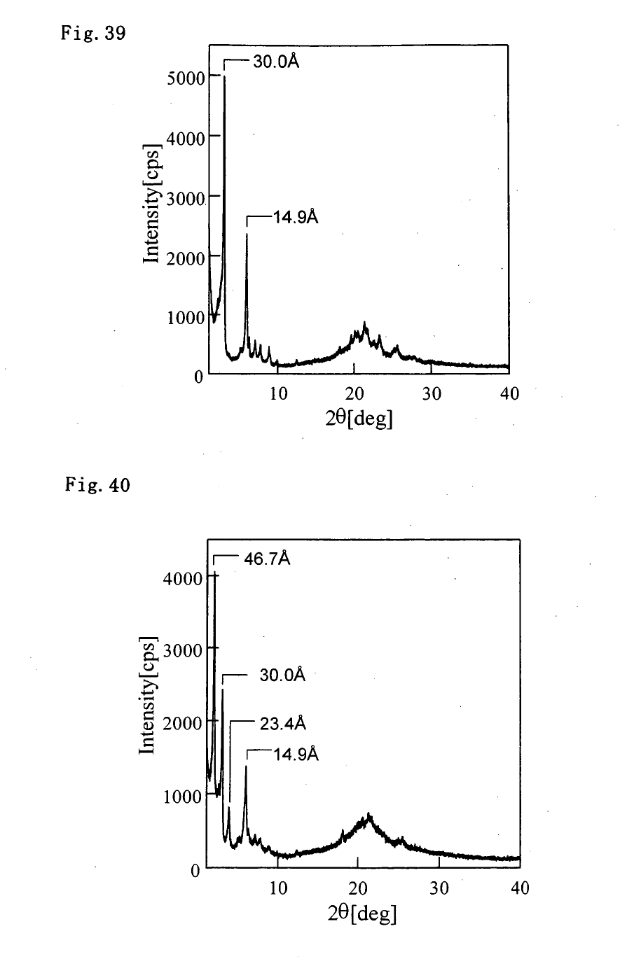

FIG. 39 shows the X-ray powder diffraction pattern of the obtained layered biphenyl silica composite material. From an XRD pattern shown in FIG. 39, a layered structure with an interlayer distance of 30.0 Å was demonstrated in this sample. This interlayer distance had its equivalent in a layered structure formed of a monolayer of the surfactant and cross-linked organic silane.

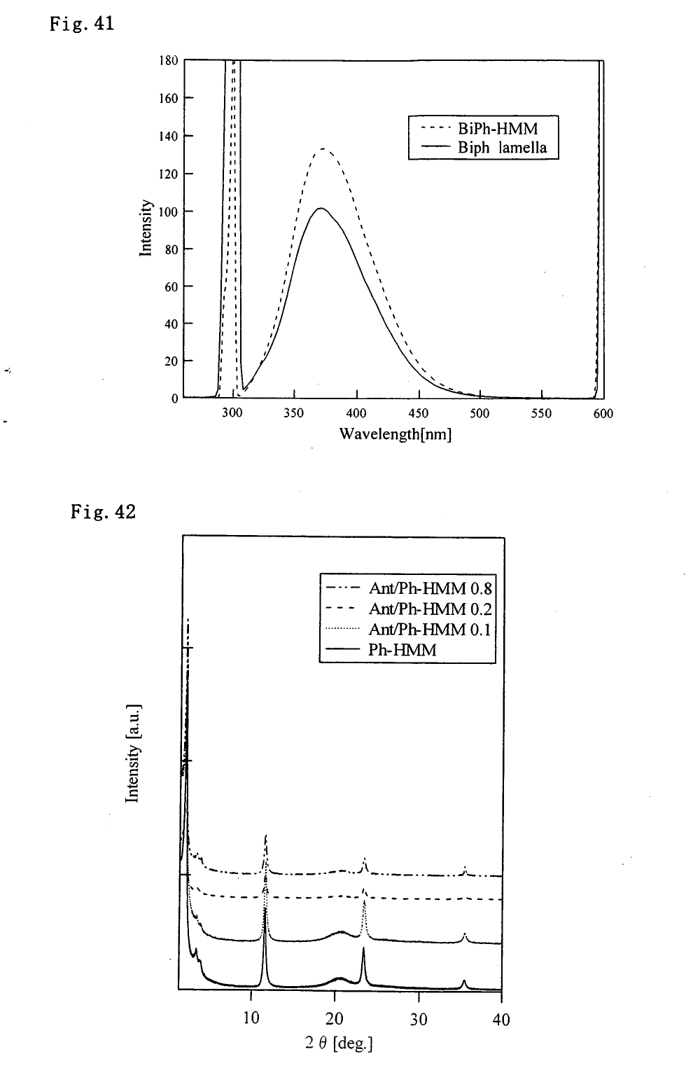

Next, 10 μl of toluene was dropped to 0.08 g of the obtained layered biphenyl silica composite material, and the X-ray powder diffraction pattern was measured again. As apparent from the XRD pattern shown in FIG. 40, the extension of the distance between layers was observed. This demonstrated that, in the obtained layered biphenyl silica composite material, the nanosheets of the biphenyl silica could be separately dispersed. Also, the fluorescence spectrum (wavelength of excitation light: 300 nm) shown in FIG. 41 evidently demonstrated that the obtained layered biphenyl silica composite material emitted strong fluorescence.

<Introduction and Luminescence Property Test of Anthracene>

### Examples 16 to 18

9,10-bistriethoxysylilanthracene (BTEA) available from Azmax Co., Ltd. was used. Using the mesoporous material of phenylsilica composite material (Ph-HMM-c) obtained in Example 1, BTEA was caused to modify a —OH group on the surface of the pores using the following method. That is, 0.1 to 0.8 g of BTEA was dissolved in 65 ml of toluene (solvent). Then, 1 g of Ph-HMM-c was dispersed therein. The solution was stirred at 50° C. for 5 hours, and then left at rest down to room temperature. Then, it was filtered. The obtained solid was washed with acetone and diethyl ether and dried to obtain a little yellowish powder. In this way, the feeding amount of BTEA to 1 g of Ph-HMM-c was varied as shown in Table 4 to obtain the mesoporous material of three kinds of the anthracene-fixed phenyl silica composite material: Ant/Ph-HMM 0.1 (Example 16), Ant/Ph-HMM 0.2 (Example 17), and Ant/Ph-HMM 0.8 (Example 18).

TABLE 4

| | Feeding amount of BTEA/1 g |
|---|---|
| | Ph-HMM-c |
| Example 16: Ant/Ph-HMM 0.1 | 0.1 g |
| Example 17: Ant/Ph-HMM 0.2 | 0.2 g |
| Example 18: Ant/Ph-HMM 0.8 | 0.8 g |

FIG. 42 shows the X-ray diffraction patterns of each sample obtained in Examples 16 to 18, and the pattern of Ph-HMM-c obtained in Example 1. Peaks d₁₀, d₁₁, and d₂₀ which show a hexagonal structure were observed at 2θ=2 to 5° in every sample, and thereby a regular mesostructure constructed therein was identified. Three peaks which show a periodic array of the phenyl group of the backbone were observed at 2θ=10 to 40°, and thereby a crystalline bone structure was identified. The above result demonstrated that, the introduction of BTEA was successfully carried out with the pore structure and the periodicity of backbone thereof being maintained, though the introduction of BTEA rendered lower peak intensity. Also, Ant/Ph-HMM 0.1 and Ph-HMM 0.2 in each of which a smaller amount of BTEA was introduced exhibited similar X-ray diffraction patterns. Also in these cases, BTEA was successfully introduced with the pore structure and the periodicity of the backbone being maintained.

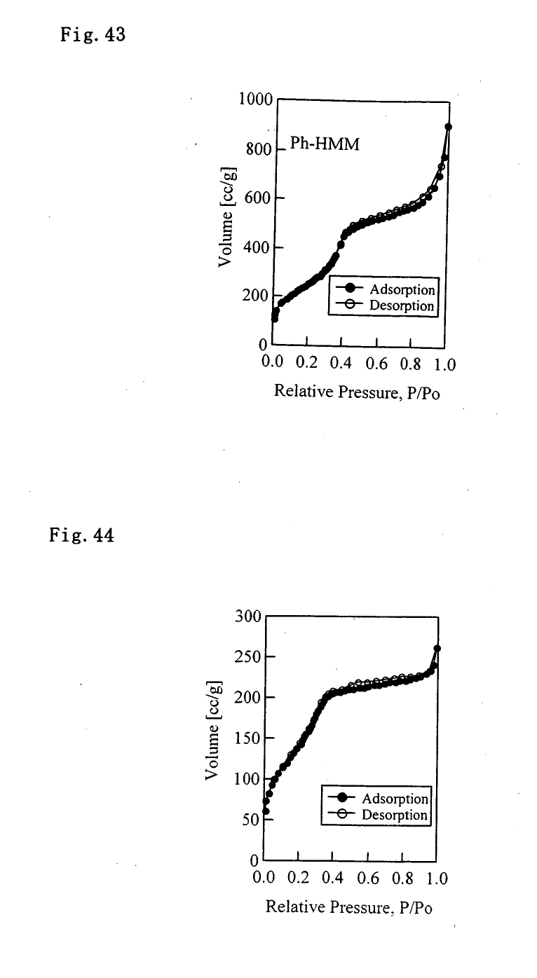

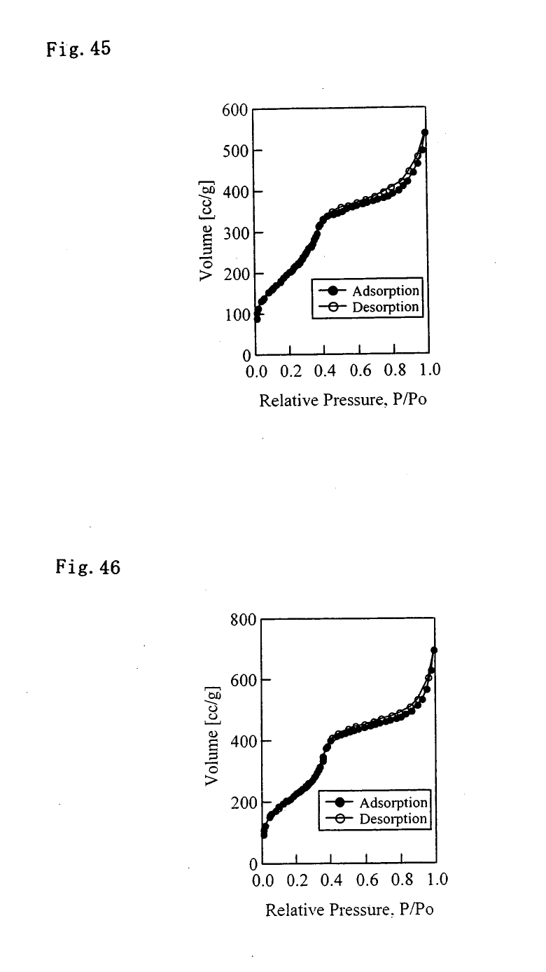

FIG. 43 shows the N₂ adsorption isotherm of Ph-HMM-c obtained in Example 1, FIG. 44 shows that of the sample obtained in Example 16, FIG. 45 shows that of the sample obtained in Example 17, and FIG. 46 shows that of the sample obtained in Example 18. Based on these N₂ adsorption isotherms, for each of the samples obtained in Examples 16 to 18 and the Ph-HMM-c obtained in Example 1, the specific surface area, the diameter of the central pore, and the volume of the pore were calculated by BET method, by BJH method, and by t-plot method, respectively. Table 5 shows the obtained result.

TABLE 5

| | Specific | Diameter | Pore |
|---|---|---|---|
| | surface area | of central | volume |
| | (m²/g) | pore (nm) | (cc/g) |
| Example 1: Ph-HMM | 935 | 3.0 | 0.36 |
| Example 16: Ant/Ph-HMM 0.1 | 830 | 2.9 | 0.33 |
| Example 17: Ant/Ph-HMM 0.2 | 743 | 2.9 | 0.25 |
| Example 18: Ant/Ph-HMM 0.8 | 516 | 2.5 | 0.20 |

The type-IV adsorption isotherms shown in FIGS. 43 to 46 for all samples were typical of mesoporous material. This demonstrated that they had uniform pores with a diameter of 2.5 to 3 nm of the central pore. Also, an increase in the amount of introduced BETA caused a decrease in the specific surface area, in the volume of pores and in the diameter of the central pore. This is probably caused by the introduction of anthracene into the pores.

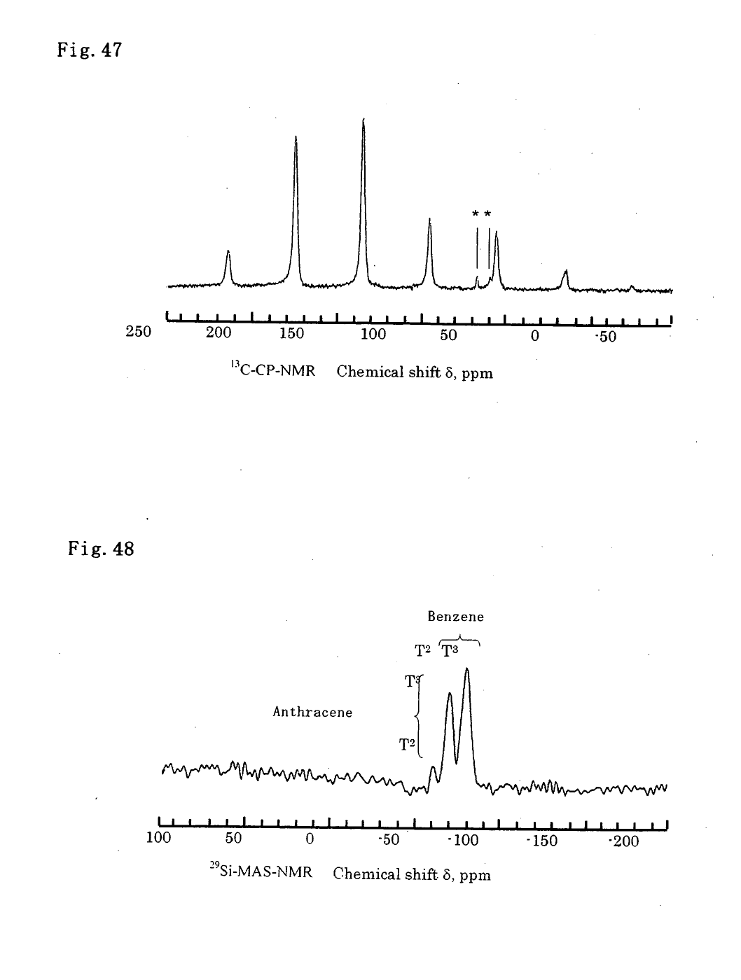

FIG. 47 shows the ¹³C-CP-NMR result of the sample in Example 18 with BTEA introduced into Ph-HMM. This showed a similarity to the NMR result of Ph-HMM without BTEA introduced thereinto, except for peaks (*) observed around 60 ppm. The peak of BTEA itself was hardly observed.

FIG. 48 shows the ²⁹Si-MAS-NMR result of the sample in Example 18 with BTEA introduced into Ph-HMM. In the ²⁹Si-MAS-NMR result, peaks derived from anthracene of BTEA were identified around 60 to 70 ppm, and peaks derived from benzene of Ph-HMM were identified around 70 to 80 ppm. This demonstrated that T³ site of anthracene and T² site of benzene were overlapped around 70 ppm. In addition, the peak of Q site at 100 to 120 ppm was not observed. This demonstrated that aromatic rings were not cut off from Si and that the structure was maintained.

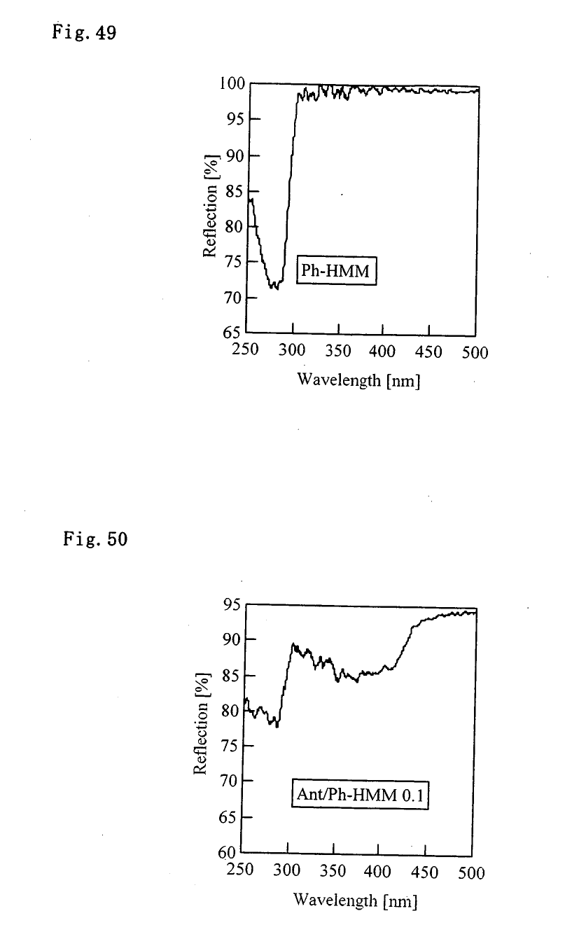

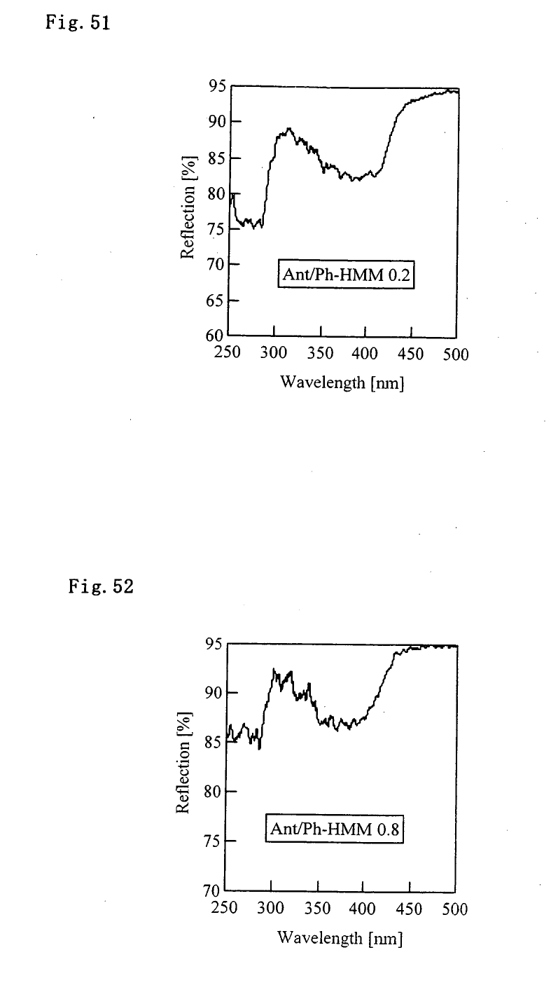

In order to investigate the optical properties of Ph-HMM to which BTEA is fixed, the absorption spectrum (by reflection method) and fluorescence spectrum were measured. FIG. 49 shows the absorption spectrum of Ph-HMM-c obtained in Example 1, FIG. 50 shows that of the sample obtained in Example 16, FIG. 51 shows that of the sample obtained in Example 17, and FIG. 52 shows that of the sample obtained in Example 18. In Ph-HMM, absorption of benzene was observed (260 to 280 nm), while, after BTEA was fixed, absorption of anthracene was observed at 350 to 400 nm in addition to the absorption of benzene. On the other hand, the absorption spectrum (not shown) of the physical mixture of Ph-HMM and BTEA, in which the peak of anthracene was sharp and was shifted to the long wavelength side, had a tendency different from that of Ph-HMM in which BTEA was fixed. This difference was probably derived from the chemical bonding of anthracene of BTEA to Ph-HMM, which confirmed that BTEA was not just physically mixed.

Next, the amount of BTEA fixed to Ph-HMM was measured by the absorption spectrum. The measurement of the sample as it is does not provide a correct spectrum due to the excessively strong reflection spectrum. Therefore, the sample was diluted by barium sulfate to be used as a blank before measurement of spectrum. First, the reflection spectrum of the samples prepared by mixing Ph-HMM and barium sulfate in various mixing ratios was measured. In the mixing ratio of 2 g barium sulfate to 0.03 g Ph-HMM, two peaks which are characteristic of phenyl group were observed at 270 to 290 nm. In a mixing ratio larger than above, the absorbance became so close to saturation that two peaks became unclear. Thus, 0.03 g of Ph-HMM was mixed with 2 g of barium sulfate to measure the absorption spectrum.

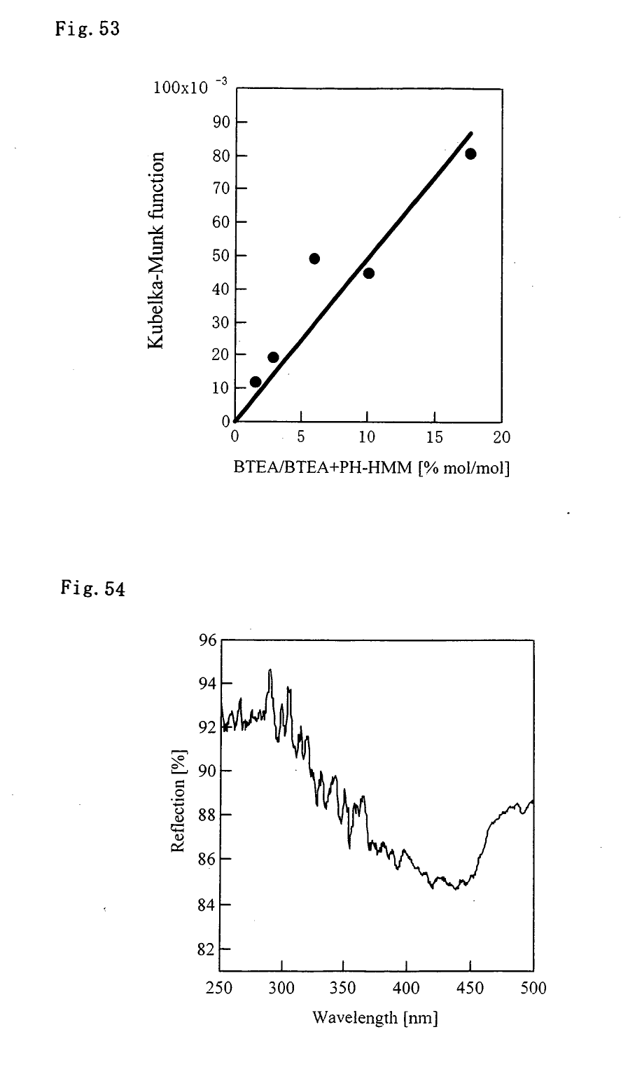

In order to make a calibration curve of BTEA, a sample was prepared by mixing a predetermined amount (0.0011 to 0.0146 g) of BTEA with Ph-HMM/BaSO₄ (0.03 g/2 g). The maximum value ratio of the absorption peaks of benzene and anthracene was plotted as a Kubelka-Munk function. FIG. 53 shows the result. The plot exhibits a good linear relationship passing zero point. Therefore, it was decided to use this calibration curve for a quantitative determination. Note that the Kubelka-Munk function equation is as follows.
K/S=(1−R_{ω})²/2R_{ω}
{where R_{ω} is the maximum value of the absorption peak of anthracene (Max 390 nm); K is an absorption coefficient, and S is a scattering coefficient}.

Also, this calibration curve demonstrated that the peak maximum value of BTEA increases in the reflection spectrum with the increase in the amount of BTEA. The amount of fixed BTEA was calculated using the calibration curve shown in FIG. 53 from the peak maximum value of BTEA in each of the spectra (shown in FIGS. 50 to 52) of the samples to which BTEA actually was fixed. Table 6 shows the result.

TABLE 6

| | |
|---|---|
| Ant/Ph-HMM 0.1 | 2% |
| Ant/Ph-HMM 0.2 | 4% |
| Ant/Ph-HMM 0.8 | 6% |

BTEA/(BTEA + Ph-HMM) (mol %)

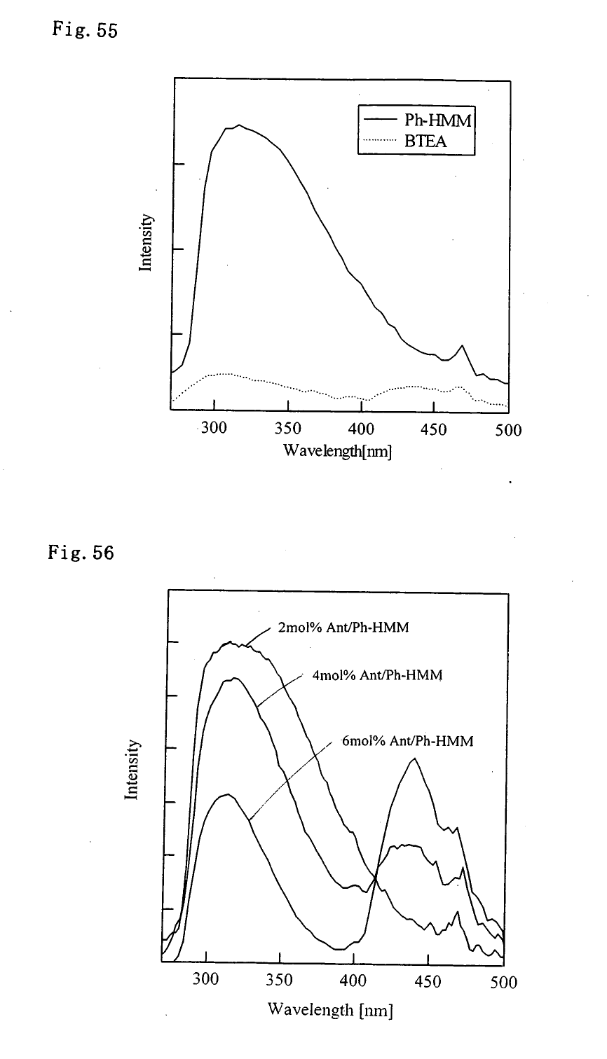

In order to investigate the energy transfer from benzene to anthracene, the fluorescence spectrum was measured. The wavelength suitable for the observation of the energy transfer from benzene to anthracene was identified in the following way. The result of the absorption spectrum in the monomer of BTEA shown in FIG. 54 demonstrated that BTEA did not exhibit absorption at 260 nm, but exhibited absorption derived from anthracene near 450 nm. FIG. 55 shows the fluorescence spectra of Ph-HMM and BTEA at 260 nm of excitation wavelength. A high peak was identified near 320 nm in the fluorescence spectrum of Ph-HMM, but no peak was identified in the fluorescence spectrum of BTEA. Thus, an excitation wavelength of 260 nm was identified as a wavelength suitable for the observation of the energy transfer from benzene to anthracene.

FIG. 56 shows the result of the measurement of the fluorescence spectra of samples obtained in Examples 16 to 18 at 260 nm of excitation wavelength. In the samples to which BTEA had been introduced, the peaks of phenyl group and anthracene were observed at 320 nm and 430 nm, respectively. This suggests that BTEA was fixed to the interior of the pore of Ph-HMM. With the increase in the introduced amount of BTEA, the peak of anthracene became larger and the peak of phenyl group became smaller, while the amount of Ph-HMM itself was constant. Thus, the above fact confirmed the energy transfer from a phenyl group to anthracene.

The above results demonstrated that an anthracene precursor (BTEA) was introduced into the interior of the pore of the mesoporous material of phenyl silica composite material (Ph-HMM-c), and that the energy was transferred from phenyl group to anthracene.

<Introduction of and Luminescence Property Test on Porphyrin>

### Examples 19 and 20

Used in these examples were the mesoporous material of phenyl silica composite material (Ph-HMM-c) obtained in Example 1, and the mesoporous material of biphenyl silica composite material (BiPh-HMM-c) obtained in Example 4. Aluminum porphyrin complex (Al-TPPEt, 0.32 g) was dissolved in 100 ml of benzene. The mesoporous material (1 g) each obtained in Example 1 and 4 was added to the solution. The liquid mixture was stirred at 24° C. for 24 hours, while blocking the light, so that Al-TPPEt was physically adsorbed on each mesoporous material. The obtained powder was filtered, while being satisfactorily washed with ethanol and benzene, to obtain red powder. They were referred to as Al-TPPEt/Ph-HMM (Example 19), and Al-TPPEt/BiPh-HMM (Example 20).

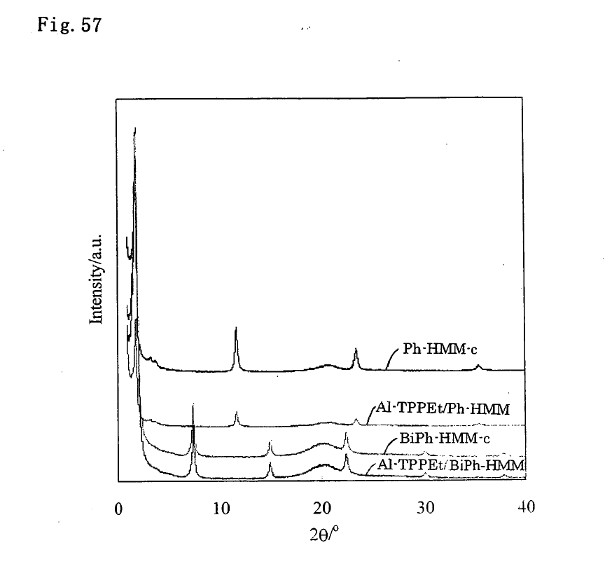

FIG. 57 shows the X-ray diffraction patterns of Ph-HMM-c, BiPh-HMM-c, Al-TPPEt/Ph-HMM, and Al-TPPEt/BiPh-HMM. In Ph-HMM-c and BiPh-HMM-c which were synthesized by adding ODTMA (C₁₈TMA⁺Cl⁻) as a template, peaks indicating the periodicity of benzene in the backbone were identified at 0.76 nm and 1.19 nm, and peaks indicating a mesostructure (2D hexagonal) were identified at 2θ=1 to 3°. In Al-TPPEt/Ph-HMM and Al-TPPEt/BiPh-HMM which have TPPEt introduced into their mesopores, peaks were observed in the same positions as those in Ph-HMM-c and BiPh-HMM-c. This demonstrated that adsorption treatment did not destroy the structures of Ph-HMM-c and BiPh-HMM-c.

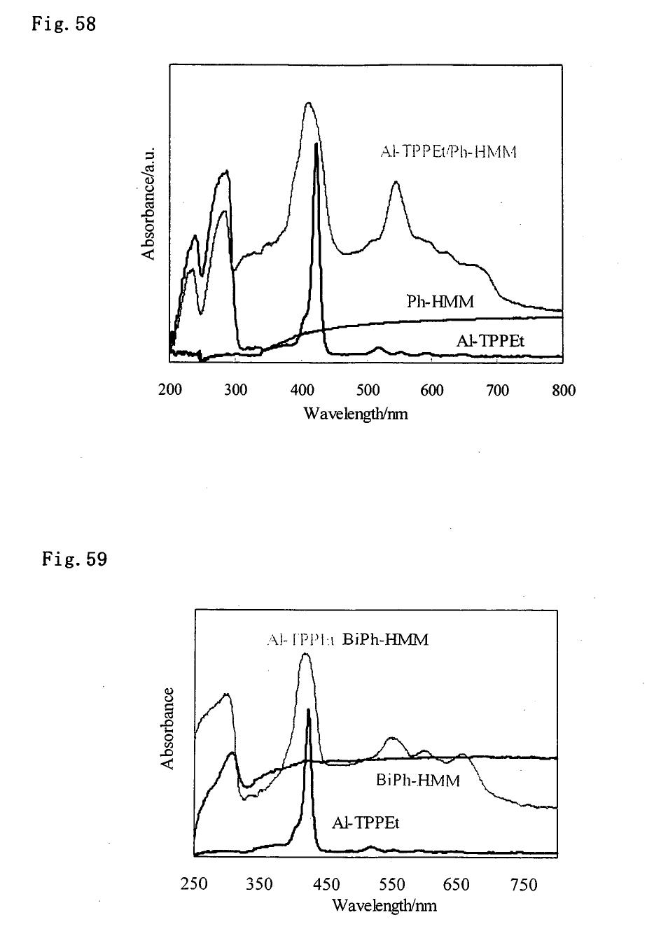

FIGS. 58 and 59 show the UV-vis spectrum of Al-TPPEt/Ph-HMM and that of Al-TPPEt/BiPh-HMM, respectively. Absorption attributed to the n-n* transition of benzene and biphenyl on the mesoporous silica wall surface was observed at approximately 260 to 320 nm. The absorption spectrum which is attributed to the Soret band and Q band of Al-TSPP was observed between 400 and 700 nm. Both of them were identified in a composite material. The association state of Al-TPPEt in mesopores can be estimated by the shift of the Soret band of Al-TPPEt. The Soret bands of Al-TPPEt in Al-TPPEt/Ph-HMM and Al-TPPEt/BiPh-HMM were 406 and 413 nm, respectively. These were blue-shifted from a band (422 nm) which has no association state in chloroform. This result suggests that Al-TPPEt forms an H aggregate in Ph-HMM and BiPh-HMM. A possible reason why such an H aggregate is formed is that hydrophobic porphyrin is adsorbed, in a regularly arrayed manner, on hydrophobic parts which are regularly arrayed in the pores.

A larger blue shift of the Soret band of Al-TPPEt was observed in Al-TPPEt/Ph-HMM than the one observed in Al-TPPEt/BiPh-HMM. This result confirmed that the wall surface of the pores of Ph-HMM-c tends to take an H-aggregate easily. A possible reason for this is that BiPh-HMM-c had wider hydrophobic parts than Ph-HMM-c, and that Al-TPPEt was adsorbed in those parts in a tilted manner, which makes the taking of the H-aggregates difficult.

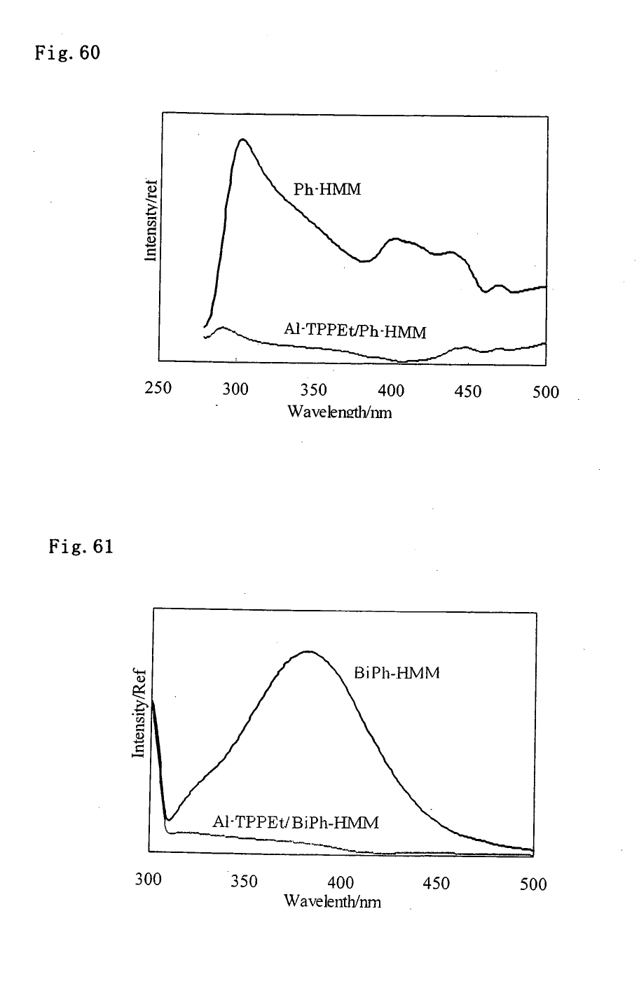

FIG. 60 shows the fluorescence spectrum of an Al-TPPEt/Ph-HMM composite material. When Ph-HMM-c was excited using the light having a wavelength of 260 nm, a strong fluorescence was observed near 300 nm. However, the fluorescence was quenched in the composite material into which Al-TPPEt was introduced. FIG. 61 shows the fluorescence of Al-TPPEt/BiPh-HMM composite material. In this case, also, when BiPh-HMM-c was excited using the light having a wavelength of 300 nm, a strong fluorescence was observed near 380 nm. However, the fluorescence was quenched in the composite material into which Al-TPPEt was introduced. These results suggest that energy was transferred from Ph-HMM-c or BiPh-HMM-c to Al-TPPEt. However, the fluorescence derived from Al-TPPEt could not be detected by this device probably because it was hidden by the second harmonic wave of the excitation light or had an absorbance in far-infrared area.

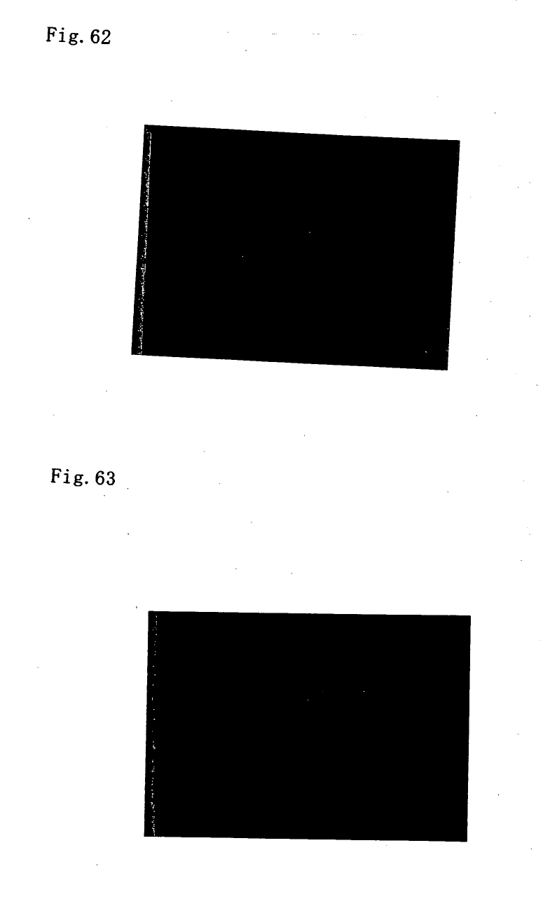

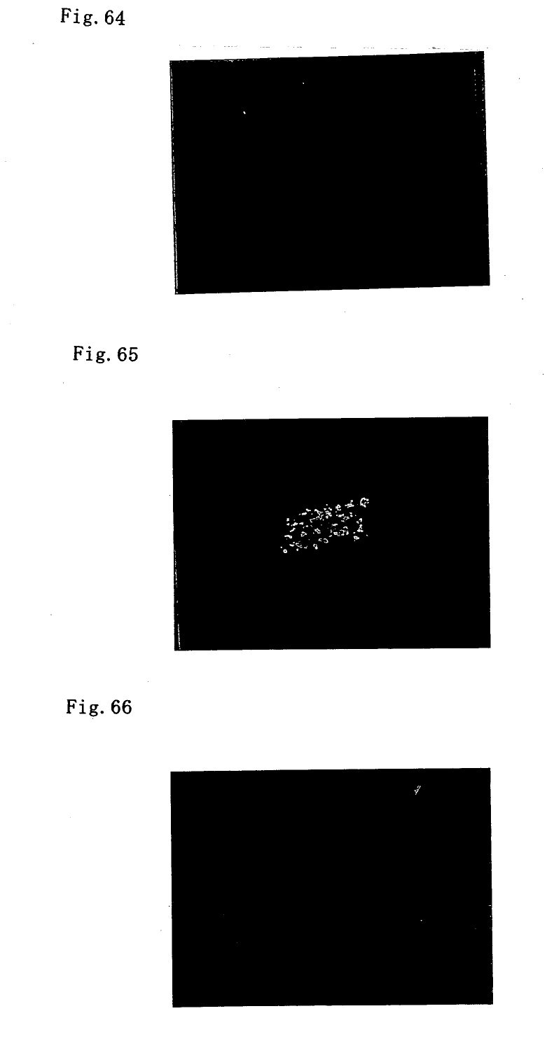

FIGS. 62 to 66 are photographs showing the luminescence states of powders of Al-TPPEt, Al-TPPEt/Ph-HMM, Ph-HMM-c, BiPh-HMM-c, and Al-TPPEt/BiPh-HMM, which states were observed while the powders were exposed to an UV lamp (254 nm). The results shown in FIGS. 62 to 66 demonstrated that only the sample supporting Al-TPPEt (Al-TPPEt/Ph-HMM, and Al-TPPEt/BiPh-HMM) emitted luminescence. Also this result demonstrated the transfer of energy from Ph-HMM-c or BiPh-HMM-c to Al-TPPEt.

From the foregoing results, the mechanism of the energy transfer from Ph-HMM-c to Al-TPPEt is considered as follows. The closeness in distance between the two molecules, which is attributed to the presence of Al-TPPEt in the mesopores, makes the Perrin model of the energy transfer depending on this distance applicable to this case. The Perrin model is often used when examining the energy transfer in a rigid solution and in a solid phase. In this model, the overlapping of the spectra is not important. In this model, the presence of acceptor in the quenching space of the donor makes the energy transfer efficient. In the system of this composite, Al-TPPEt was adsorbed as an H-aggregate on the wall surface of Ph-HMM-c which serves as a donor. As a result, the sufficient amount of Al-TPPEt was present in the quenching space of Ph-HMM-c sufficiently, and the energy presumably transferred from Ph-HMM-c to Al-TPPEt, efficiently.

As described above, the efficient energy transfer from phenyl silica composite material or biphenyl silica composite material to aluminum porphyrin in the mesopores was confirmed. Ways of applying the porphyrin which has obtained energy are expected to the fixation of CO₂ or the synthesis of polymer, to name a few. Also, freely controlling the color and energy of the fluorescence is made possible by adsorbing various kinds of fluorescence materials on the mesoporous material of the phenyl silica composite material or the biphenyl silica composite material which emit fluorescence in ultraviolet area.

<Heat Resistance Test>

### Example 21 and Comparative Examples 8 and 9

The film of biphenyl silica composite material (BiPh-HMMc-s-film, shown in Example 21) obtained in a similar manner as in Example 10, and, for comparative purpose, the films of the prior art fluorescence materials {Bis[N-(1-naphthyl)-N-phenyl]benzidine (NPB) Comparative example 8), and 4,4′-Bis(9-carbazolyl)-biphenyl(CBP)} (comparative example 9) were left at rest in an electric furnace at 150° C. for 30 minutes. The appearance of the heat-treated film was observed with the naked eye.

In BiPh-HMMc-s-film obtained in Example 21 (Example 10), the transparency of the film had no change, while both of prior art filmy fluorescence materials for comparison (NPB and CBP) (Comparative examples 8 and 9) became clouded. Such white turbidity was probably caused by the crystallization of the fluorescence material. From this result, an excellent heat resistance that the luminescent material of the present invention has was demonstrated.

<Synthesis of and Luminescence Property Test on the Film of the Luminescent Material (2)>

### Example 22

BTEBP (1.2 g) having the structure shown below was added to the solution prepared by adding 320 μl of ion-exchange water, 10 μl of 2N aqueous hydrochloric acid solution, and 0.86 g of nonionic surfactant Brij-76(C₁₈H₃₇(EO)₁₀) which serves as a template, to 4 g of ethanol (EtOH). This liquid mixture was stirred at room temperature for 1 hour to obtain a sol solution. Using this sol solution, a coat film (thickness: 100 to 500 nm) was obtained on a glass substrate by a spin coating method. The coating conditions include 4000 rpm of revolutions, and 1 minute of a revolution time period. The obtained film was further dried at 100° C. for 1 hour or more.

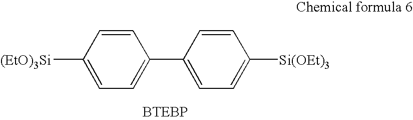

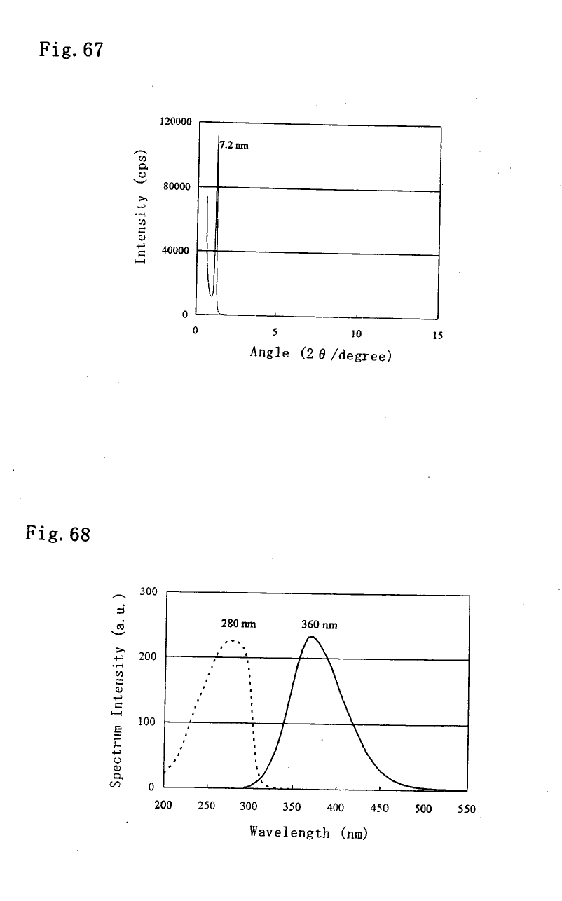

FIG. 67 shows the X-ray diffraction pattern of the film of biphenyl silica composite material (BiPh-HMMc-s-film2) obtained in Example 22. FIG. 68 shows the fluorescence spectrum (solid line, excitation wavelength: 280 nm) and excitation spectrum (dashed line, measuring wavelength: 360 nm) of the film. In the X-ray diffraction pattern, a distinctive peak was observed at d=7.2 nm, demonstrating the existence of a regular mesostructure (FIG. 67). Measuring the fluorescence spectrum using an excitation wavelength of 280 nm demonstrated a strong luminescence emitted near 360 nm (FIG. 68).

### Examples 23 and 24

The amount shown in Table 7 of BTEB (Example 23) or BTEBP (Example 24) was added as an Si source to the solution prepared by adding ion-exchange water, 2N aqueous hydrochloric acid solution, and nonionic surfactant P123 [(EO)₂₀-(PO)₇₀-(EO)₂₀] that serves as a template to ethanol such that they are mixed in the compositions shown in Table 7. This liquid mixture was stirred at room temperature for 1 hour to obtain a transparent uniform sol solution. This sol solution was applied on a glass substrate by means of by a dip coating method to obtain a uniform coat film (film thickness: 450 nm). The dipping conditions include 2 cm/min of dipping speed, and 2 minutes of immersing time period. The obtained film was further calcined in air at 250° C. for 2 hours.

TABLE 7

| | Si source | P123 | H2O | EtOH | 2N HCl |
|---|---|---|---|---|---|
| | (g) | (g) | (g) | (g) | (μl) |
| Example 23 | 1 | 0.725 | 1 | 4 | 10 |
| Example 24 | 0.6 | 0.45 | 360 | 4 | 10 |

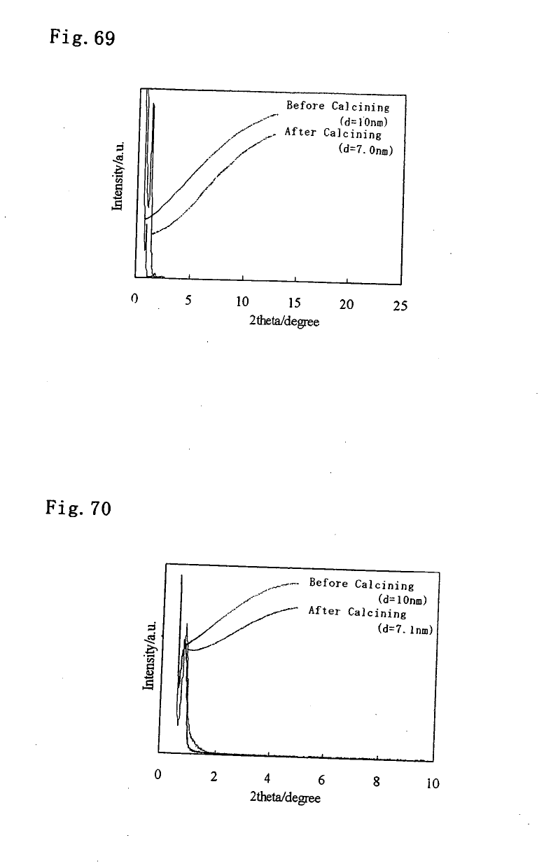

FIGS. 69 and 70 show the X-ray diffraction patterns before and after the calcining of the film of phenylsilica composite material (Ph-HMM) obtained in Example 23 and the film of biphenyl silica composite material (BiPh-HMM) obtained in Example 24, respectively. The result demonstrated that each of the Ph-HMM film and the BiPh-HMM film has a regular mesostructure before and after calcining.

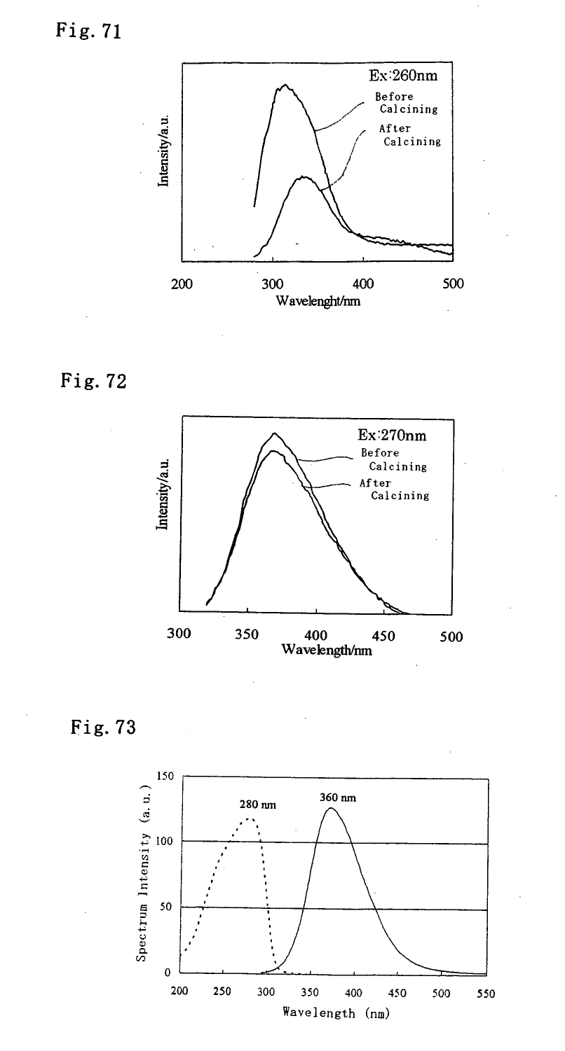

FIGS. 71 and 72 then show the fluorescence spectra before and after the calcining of the Ph-HMM film and the BiPh-HMM film, respectively. The result demonstrated that each of the Ph-HMM film and the BiPh-HMM film emitted a strong luminescence before and after the calcining.

### Example 25

BTEBP (0.3 g) was added to the solution prepared by adding 90 μl of ion-exchange water, 10 μl of 2N aqueous hydrochloric acid solution to 2 g of ethanol (EtOH). This liquid mixture was stirred at room temperature for one and half hours to obtain a sol solution. Using this sol solution, a coat film (film thickness: 100 to 500 nm) was obtained by a spin coating method as in Example 22. The obtained film was dried.

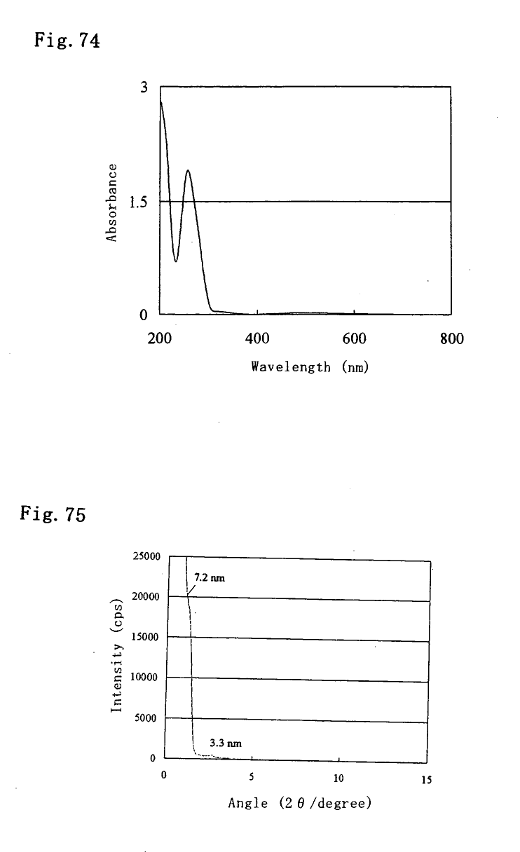

FIG. 73 shows the fluorescence spectrum (solid line, excitation wavelength: 280 nm), excitation spectrum (dashed line, measuring wavelength: 360 nm), and FIG. 74 shows the UV spectrum of the film of biphenyl silica (BiPh-acid-film) obtained in Example 25. Measuring the fluorescence spectrum using 280 nm of an excitation wavelength demonstrated that strong luminescence was emitted around 360 nm (FIG. 73). The result of the UV spectrum demonstrated that this film had a light absorption band mainly at 250 to 270 nm (FIG. 74).

### Example 26

A solution prepared by dissolving 0.1 g of BTETP having the chemical formula described below in 1 g of an ethanol/THF (mixing ratio by weight: 1:1) mixed solvent was added to a solution prepared by adding 21 μl of ion-exchange water, 5 μl of 2N aqueous hydrochloric acid solution, and 0.07 g of Brij-76 (C₁₈H₃₇(EO)₁₀) to 1 g of the ethanol/THF (mixing ratio by weight: 1:1) mixed solvent. This mixture was stirred at room temperature for 24 hour or more to obtain a sol solution. Using this sol solution, a coat film (film thickness: 100 to 300 nm) was obtained by a spin coating method as in Example 22. The obtained film was dried.

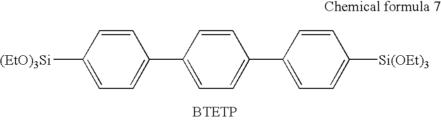

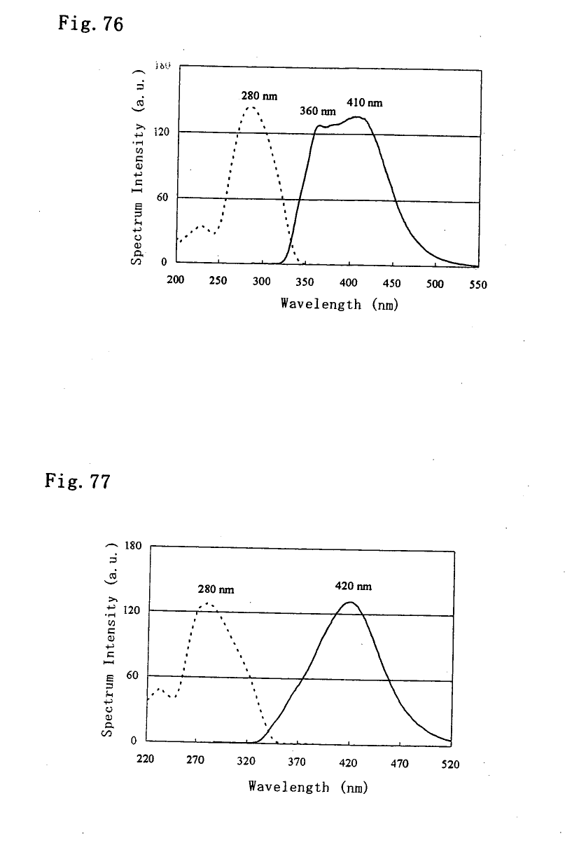

FIG. 75 shows the X-ray diffraction pattern of the film of terphenyl silica composite material (TPh-HMMc-s-film) obtained in Example 26. FIG. 76 shows the fluorescence spectrum (solid line, excitation wavelength: 280 nm) and the excitation spectrum (dashed line, measuring wavelength: 420 nm) of the film. In the X-ray diffraction pattern, a peak, though having a broad width, was observed at d=7.2 nm, and the existence of a regular mesostructure was demonstrated (FIG. 75). Measuring a fluorescence spectrum using 280 nm of an excitation wavelength demonstrated that this film emitted a strong luminescence having 360 nm and 410 nm as the central wavelength (FIG. 76).

### Example 27

A solution prepared by dissolving 0.1 g of BTETP in 1 g of an ethanol/THF (mixing ratio by weight: 1:1) mixed solvent was added to a solution prepared by adding 43 μl of ion-exchange water and 10 μl of 2N aqueous hydrochloric acid solution to 1 g of the ethanol/THF (mixing ratio by weight: 1:1) mixed solvent. This mixture was stirred at room temperature for 24 hours or more to obtain a sol solution. Using this sol solution, a coat film (film thickness: 100 to 300 nm) was obtained by a spin coating method as in Example 22. The obtained film was dried.

FIG. 77 shows the fluorescence spectrum (solid line, excitation wavelength: 280 nm) and the excitation spectrum (dashed line, measuring wavelength: 400 nm) of the film of terphenyl silica (TPh-acid-film) obtained in Example 27. Measuring a fluorescence spectrum using 280 nm of an excitation wavelength demonstrated that this film emits strong luminescence having 420 nm as the central wavelength (FIG. 77).

### Example 28

A solution prepared by dissolving 0.1 g of 1,6-BTEPyr having the chemical formula described below in 1 g of an ethanol/THF (mixing ratio by weight: 1:1) mixed solvent was added to a solution prepared by adding 21 μl of ion-exchange water, 5 μl of 2N aqueous hydrochloric acid solution, and 0.07 g of Brij-76 (C₁₈H₃₇(EO)₁) to 1 g of the ethanol/THF (mixing ratio by weight: 1:1) mixed solvent. This mixture was stirred at room temperature for 15 hours to obtain a sol solution. Using this sol solution, a coat film (film thickness: 100 to 300 nm) was obtained by a spin coating method as in Example 22. The obtained film was dried.

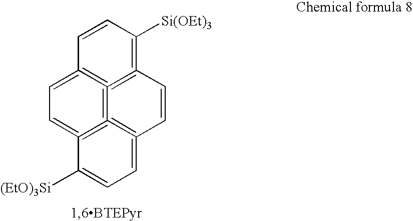

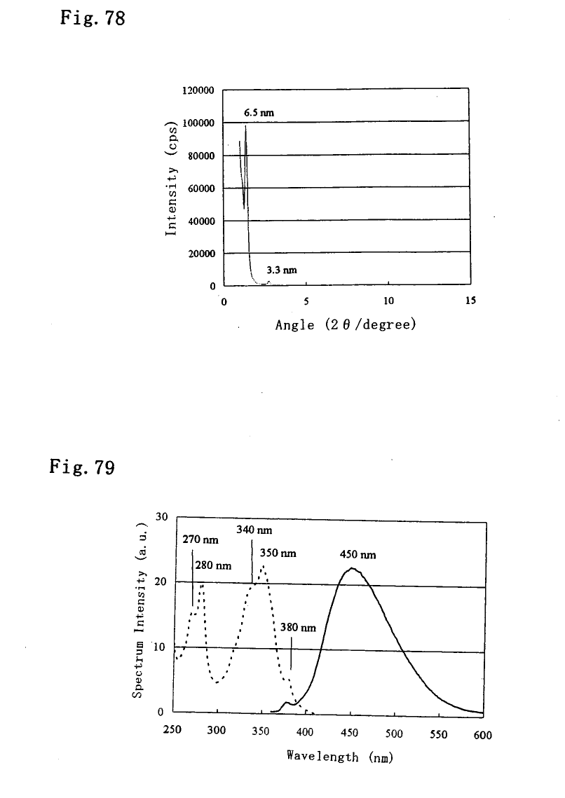

FIG. 78 shows the X-ray diffraction pattern of the film (Pyr-HMMc-s-film) of pyrene silica composite material obtained in Example 28. FIG. 79 shows the fluorescence spectrum (solid line, excitation wavelength: 350 nm) and excitation spectrum (dashed line, measuring wavelength: 450 nm) of the film. In the X-ray diffraction pattern, a peak was observed at d=6.5 nm, and the existence of a regular mesostructure was demonstrated (FIG. 78). Measuring a fluorescence spectrum using 350 nm of an excitation wavelength demonstrated that this film emitted strong luminescence having 450 nm as the central wavelength (FIG. 79).

### Example 29

A solution prepared by dissolving 0.1 g of 1,6-BTEPyr in 1 g of ethanol was added to a solution prepared by adding 10 μl of ion-exchange water, and 2 μl of 2N aqueous hydrochloric acid solution to 1 g of ethanol. This mixture was stirred at room temperature for 1 hour to obtain a sol solution. Using this sol solution, a coat film (film thickness: 100 to 300 nm) was obtained by a spin coating method as in Example 22. The obtained film was dried.

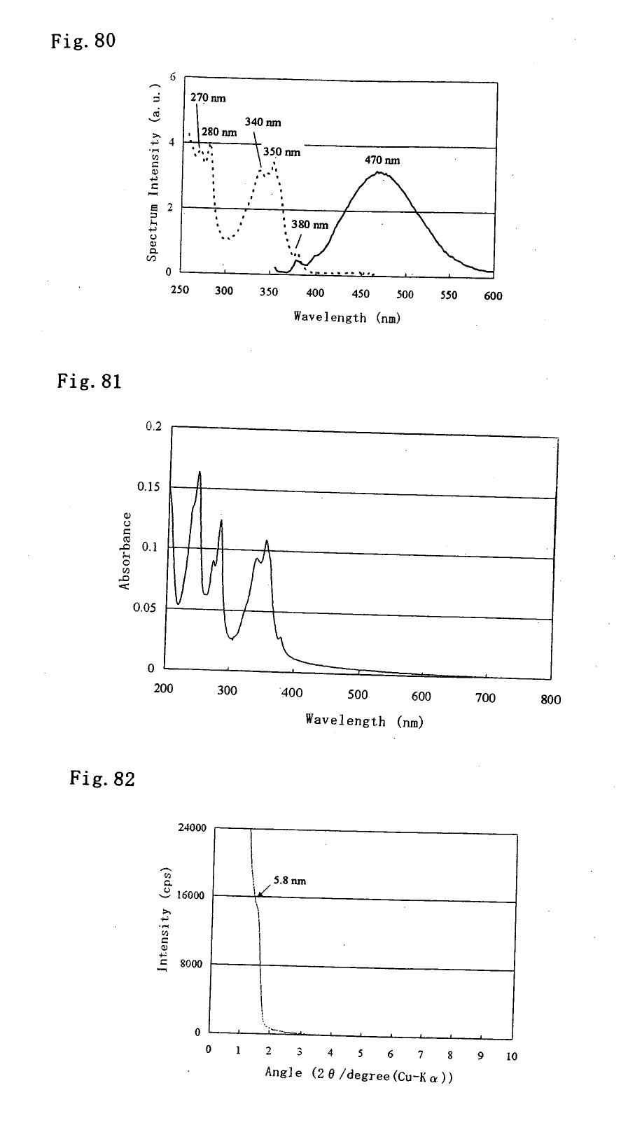

FIG. 80 shows the fluorescence spectrum (solid line, excitation wavelength: 350 nm) and the excitation spectrum (dashed line, measuring wavelength: 450 nm) of the film of pyrene silica (Pyr-acid-film) obtained in Example 29. FIG. 81 shows the UV spectrum of the film. Measuring a fluorescence spectrum using 350 nm of an excitation wavelength demonstrated that strong luminescence was emitted near 470 nm (FIG. 80). The result of the UV spectrum demonstrated that this film had a light absorption band having 250, 280, and 350 nm as the central wavelength (FIG. 81).

### Example 30

A solution prepared by dissolving 0.1 g of BTEAnt having the chemical formula described below in 1 g of an ethanol/THF (mixing ratio by weight: 1:1) mixed solvent was added to a solution prepared by adding 43 μl of ion-exchange water, 10 μl of 2N aqueous hydrochloric acid solution, and 0.07 g of Brij-76 (C₁₈H₃₇(EO)₁₀) to 1 g of the ethanol/THF (mixing ratio by weight: 1:1) mixed solvent. This mixture was stirred at room temperature for 20 hours or more to obtain a sol solution. Using this sol solution, a coat film (film thickness: 100 to 300 nm) was obtained by a spin coating method as in Example 22. The obtained film was dried.

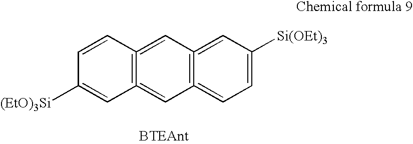

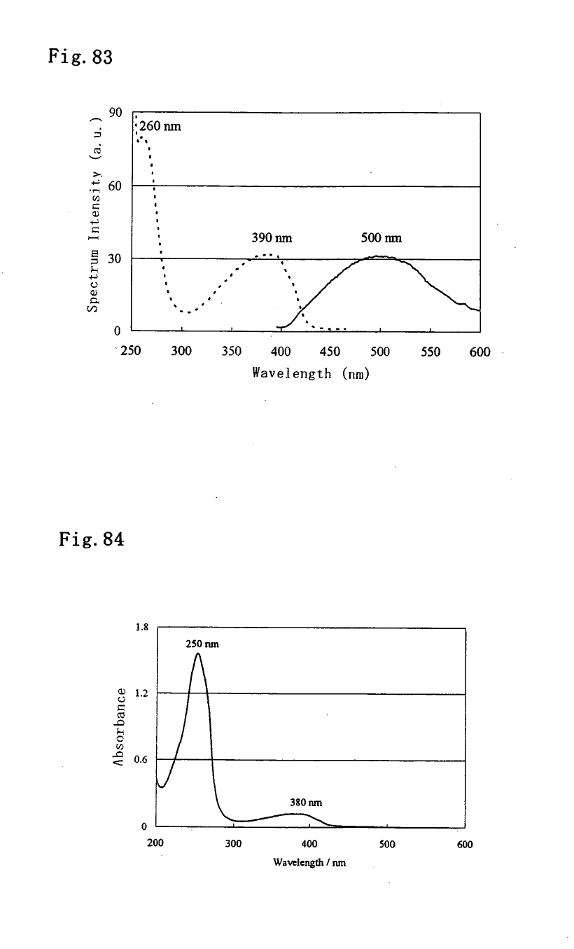

FIG. 82 shows the X-ray diffraction pattern of the film (Ant-HMMc-s-film) of anthracene silica composite material obtained in Example 30. FIG. 83 shows the fluorescence spectrum (solid line, excitation wavelength: 390 nm) and the excitation spectrum (dashed line, measuring wavelength: 500 nm) of the film. FIG. 84 shows the UV spectrum of the film. In the X-ray diffraction pattern, a peak, though having a broad width, was observed at d=5.8 nm, and the existence of a regular mesostructure was demonstrated (FIG. 82). Measuring a fluorescence spectrum using 390 nm of an excitation wavelength demonstrated that strong luminescence was emitted near 500 nm (FIG. 83). The result of the UV spectrum demonstrated that this film had a light absorption band having 250, and 380 nm as the central wavelength (FIG. 84).

### Example 31

A THF solution (2.9 ml) containing 1.01 g of 4, 4′-dibromooctafluorobiphenyl was dripped into 2.9 ml of THF solution containing 0.22 g of magnesium, 0.10 g of iodine, 1.05 g of chlorotriethoxy silane at 60° C. under argon atmosphere. This reacted mixture was refluxed at 75° C. for 18 hours. After that, the solvent was removed. Then, the product was extracted from the residue using 30 ml of hexane to obtain a yellow oily crude product. This product was heated at 350° C. under reduced pressure (100 hPa) to obtain octafluorobiphenyl silica as a brown glassy solid.

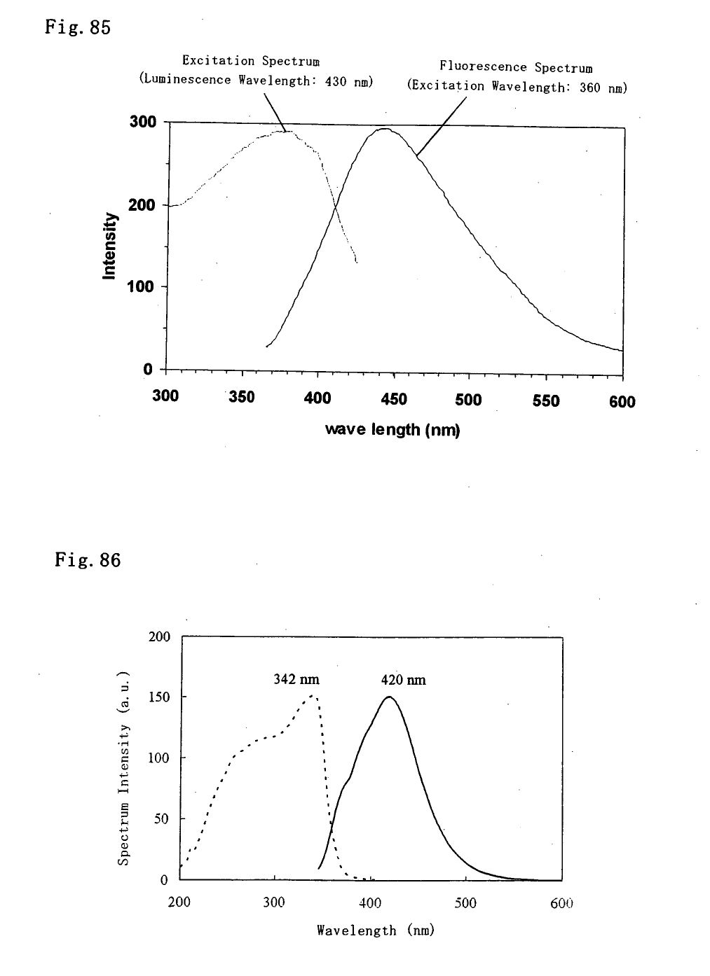

The obtained octafluorobiphenyl silica was fixed to a sample holder and the fluorescence and the excitation were measured. Measuring a fluorescence using 360 nm of excitation wavelength, demonstrated that, a fluorescence peak was observed at 440 nm (FIG. 85). Furthermore, in measuring an excitation spectrum using 430 nm of measuring wavelength, a broad excitation peak is observed in a wavelength range between 350 and 400 nm with the center of 370 nm (FIG. 85).

<Synthesis of and Luminescence Property Test on Luminescent Materials in Powder>

### Examples 32 to 36

Two mixture solutions of 6 g of ion-exchange water and 333 μl of 12N aqueous hydrochloric acid solution (for Examples 35 and 36) were prepared. Three more solutions were prepared by dissolving 0.08 g of 1,12-bis(octadecyl dimethyl ammonium)dodecane dibromide (C₁₈₋₁₂₋₁₈) which serves as a surfactant in the above solution (for Examples 32 to 34). Subsequently, a solution prepared by dissolving 0.1 g of each organic silicon compound (organic cross-linked silica precursor) shown in Table 8 in 1 g of ethanol was added to the corresponding one of the above solutions being vigorously stirred. These mixture solutions were exposed to ultrasonic waves for 15 minutes. Each of the obtained mixtures was stirred at room temperature for 24 hours, heated at 100° C. for 20 hours in an air-tight container, and cooled to room temperature. After that, each mixture was filtered, washed, and dried to obtain a targeted sample in powder.

TABLE 8

| | Organic | | Maximum | Maximum |
|---|---|---|---|---|
| | cross-linked | | excitation | luminescence |
| | silica | | wavelength | wavelength |
| | precursor | Surfactant | (nm) | (nm) |
| Example 32 | BTETP | C₁₈₋₁₂₋₁₈ | 342 | 420 |
| Example 33 | 1,6-BTEPyr | C₁₈₋₁₂₋₁₈ | 407 | 465 |
| Example 34 | BTEAnt | C₁₈₋₁₂₋₁₈ | 423 | 515 |
| Example 35 | BTETP | None | 340 | 420 |
| Example 36 | 1,6-BTEPyr | None | 390 | 475 |

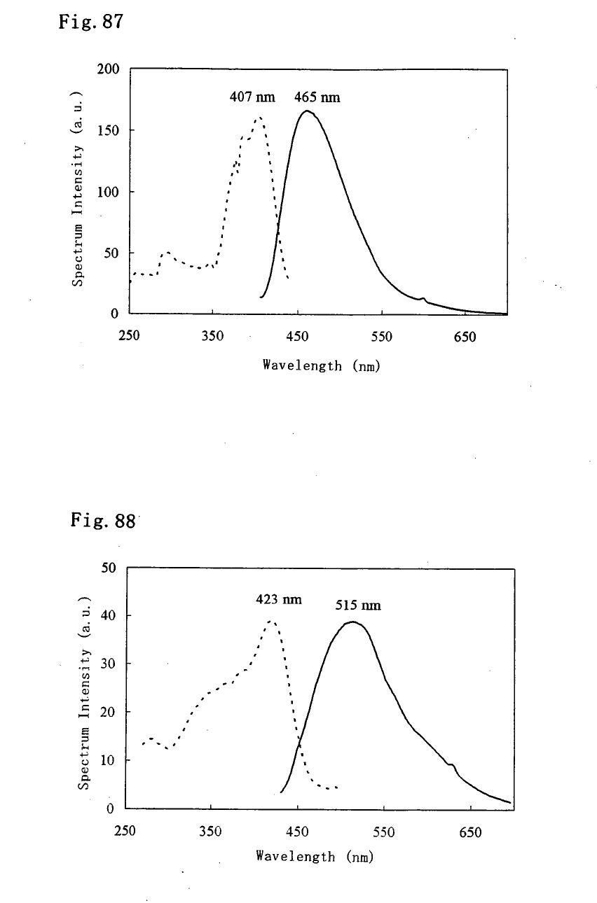

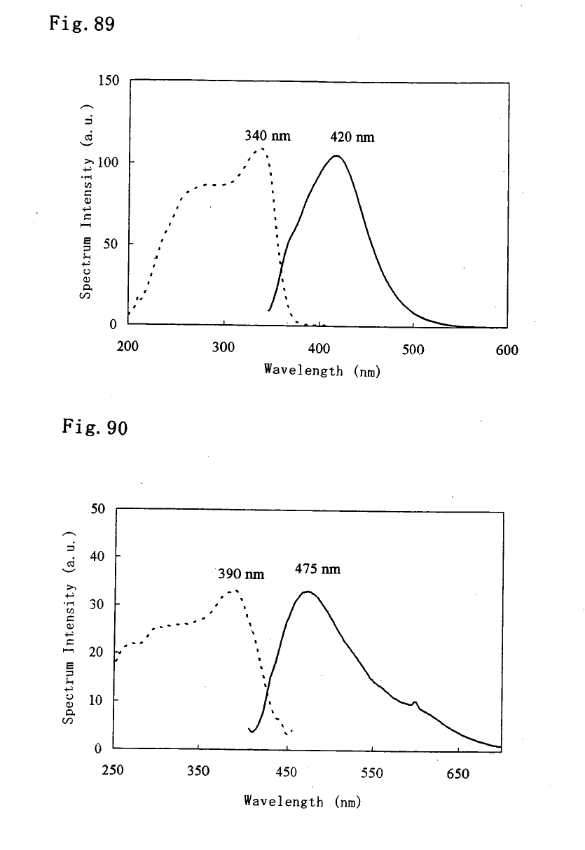

The fluorescence spectrum and the excitation spectrum of each sample obtained in Examples 32 to 36 were measured. The results of Examples 32, 33, 34, 35, and 36 are shown in FIGS. 86, 87, 88, 89, 90, respectively. Table 8 shows the maximum excitation wavelength and the maximum luminescence wavelength of each Example.

The excitation spectrum having the center at 340 nm and luminescence spectrum having the center at 420 nm were demonstrated in the sample (Tph-HMM-acid) obtained in Example 32 and the sample (Tph-acid) obtained in Example 35, both of which were synthesized using BTETP. The excitation spectrum having the center at 390 to 410 nm and the luminescence spectrum having the center at 460 to 480 nm were demonstrated in the sample (Pyr-HMM-acid) obtained in Example 33 and the sample (Pyr-acid) obtained in Example 36, both of which were synthesized using 1,6-BTEPyr. Furthermore, the excitation spectrum having the center at 420 nm, and the luminescence spectrum having the center at 520 nm were demonstrated in the sample (Ant-HMM-Acid) which was synthesized using BTEAnt and obtained in Example 34.

<Introduction of Other Luminescent Materials and Luminescence Property Test>

### Example 37

Octadecyl-trimethyl-ammonium chloride (ODTMA) which serves as a template and fluorescein (Fl available from Tokyo Chemical Industry Co., Ltd.) which serves as an optical function molecule were added to a basic solution (6N NaOH+H₂O) shown in Table 9 in such a ratio that they are mixed in the composition shown in Table 9. The mixtures were exposed to ultrasonic waves to be dissolved. The amount shown in Table 9 of BTEBP was added to such solutions, and the mixtures were stirred for 20 minutes using ultrasonic waves. Each mixture which had thus been obtained was stirred at room temperature for a day, and then heated at 100° C. round the clock. The obtained precipitates was taken out by filtration, and washed by distilled water to obtain the targeted sample.

TABLE 9

| | BTEBP | ODTMA | 6N NaOH | H₂O | Fluorescein |
|---|---|---|---|---|---|
| Sample | (g) | (g) | (g) | (g) | (mg) |
| 1 | 2 | 1.6 | 8 | 80 | — |
| 2 | 2 | 1.6 | 8 | 80 | 0.5 |
| 3 | 2 | 1.6 | 8 | 80 | 1 |
| 4 | 2 | 1.6 | 8 | 80 | 2 |
| 5 | 2 | 1.6 | 8 | 80 | 5 |
| 6 | 2 | 1.6 | 8 | 80 | 10 |

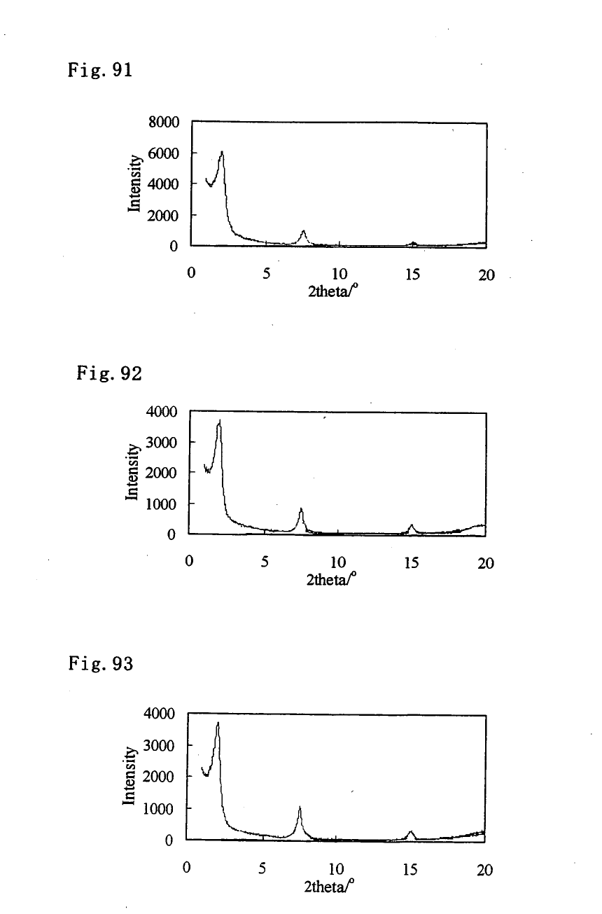

FIGS. 91, 92 and 93 show the X-ray diffraction pattern of sample 1 (BiPh-HMM powder), that of sample 2 (Fl(0.5 mg)/BiPh-HMM powder), and that of sample 5 (Fl(5 mg)/BiPh-HMM powder) which were obtained in Example 37, respectively. A diffraction peak derived from a mesostructure near 2θ=2°, periodic structure diffraction peaks which indicate the regular array of the biphenyl group in the pore backbone near 2θ=8, 15° were identified in each of sample 2 and sample 5 as in sample 1 in which Fl was not supported. As described above, it was confirmed that BiPh-HMM powder having a crystalline backbone could be prepared in a system in which Fl was added.

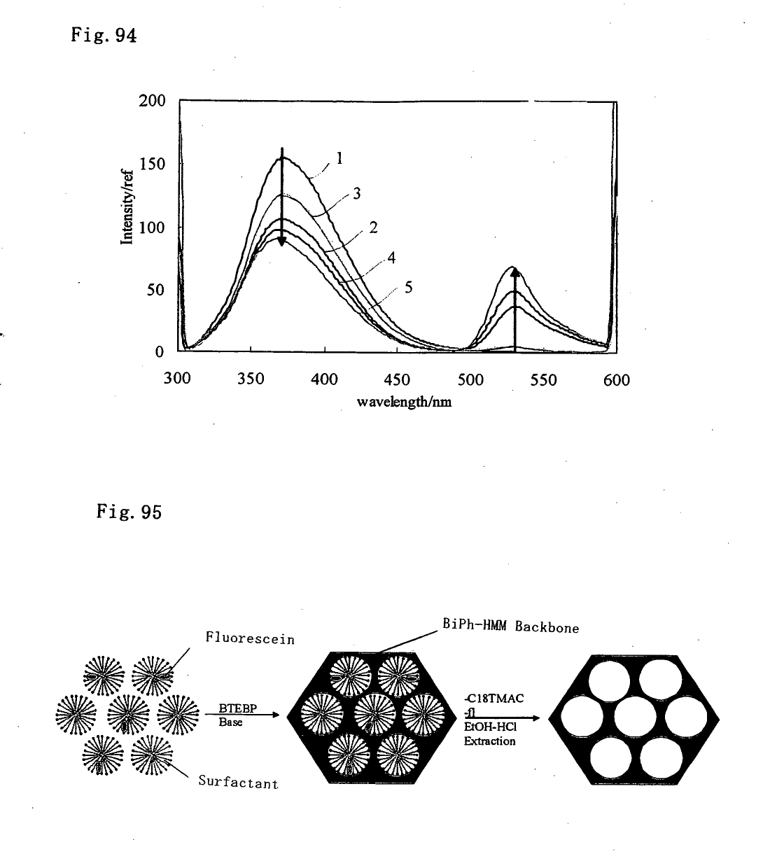

FIG. 94 shows the fluorescence spectra (excitation wavelength: 300 ml) of samples 1 to 5 obtained in Example 37. In the fluorescence of sample 1 which did not support Fl, only the peak having the maximal value at 370 nm was observed. On the other hand, in samples 2 to 5 which supported Fl, a peak at 370 nm, and another peak of Fl having the maximal value at 530 nm were identified. The fact that an ethanol solution of Fl did not exhibit fluorescence by excitation at 300 nm confirmed that the energy transfer from BiPh-HMM to Fl caused luminescence at 530 nm. With the increase in the amount of added Fl, the fluorescence spectrum of BiPh-HNMM at 370 nm was reduced, and the fluorescence spectrum of Fl at 530 nm was increased. This demonstrated that, with the increase in the amount of Fl, the energy transfer from BiPh-HMM to Fl occurred.

The surfactant was removed from sample 5 obtained in Example 37 by means of ethanol extraction, and the transformation in the structure and the change in the fluorescence properties were examined. The result shows that the mesostructure and the regular array structure of the biphenyl groups are not transformed at all, but that fluorescence was not exhibited at all. This demonstrated that Fl was taken in the surfactant. FIG. 95 shows the pattern diagram of the structure of the sample (Fl/BiPh-HMM powder) obtained in Example 37.

### Example 38

Brij76 (C₁₈H₃₇(EO)₁₀, 0.43 g) which serves as a template and each of the predetermined amount (0 mg for sample 1, 11 mg for sample 2, and 30 mg for sample 3) of fluorescein (Fl) which serves as an optical function molecule were added to a solution containing 0.09 g of ion-exchange water, 3 g of ethanol, and 0.01 g of 2N aqueous hydrochloric acid solution. Each mixture was stirred for 20 minutes to make a uniform solution. BTEBP (0.6 g) was then added to each of such solutions and the mixture was stirred for another 2 hours. Each solution thus obtained was applied onto a glass substrate by a dip coating method, and was dried at 60° C. for 2 hours to obtain uniform coat film (film thickness: 450 nm). The mol ratios of Fl to BTEBP were 0 mol % for sample 1, 2 mol % for sample 2, and 5 mol % for sample 3.

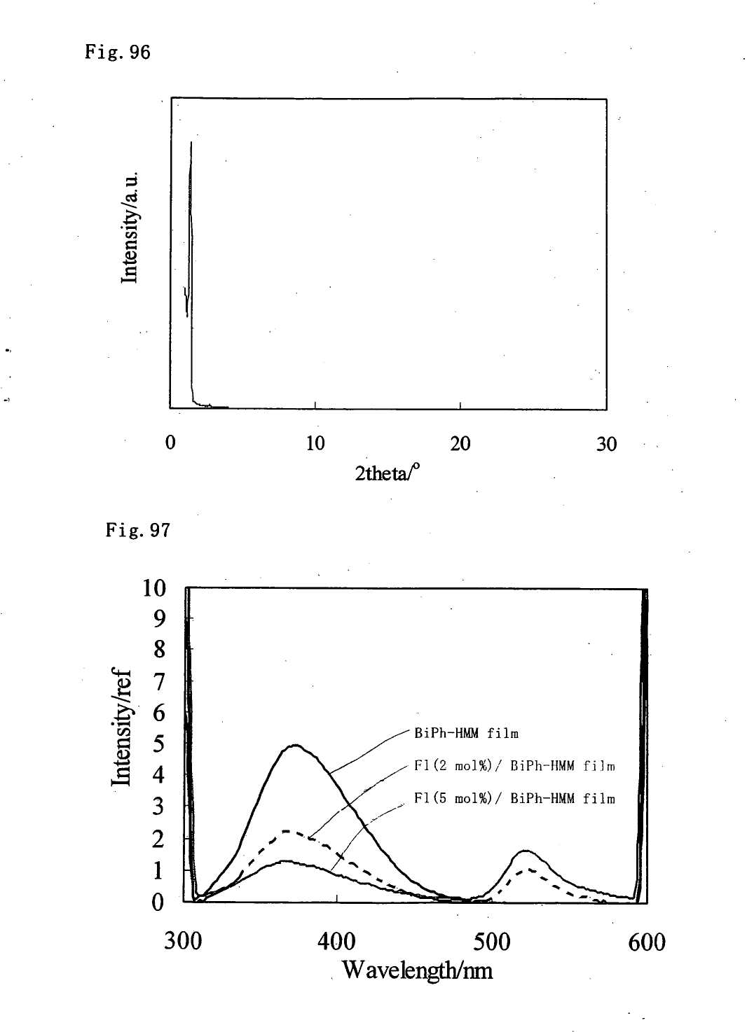

FIG. 96 shows the X-ray diffraction pattern of sample 2 (Fl(2 mol %)/BiPh-HMM film) obtained in Example 38. In this sample, a peak attributed to a mesostructure was observed near 2θ=1 to 2°, and a regular mesostructure that the sample had was identified.

FIG. 97 shows the fluorescence spectra (excitation wavelength: 300 nm) of samples 1 to 3 obtained in Example 38. For BiPh-HMM film (sample 1), only the maximum fluorescence wavelength of 370 nm was identified. The introduction of Fl, however, caused the reduction in fluorescence peak at 370 nm, and caused the increase in the peak of Fl near 530 nm. What was demonstrated was that the increase in the amount of introduced Fl made this tendency more noticeable.

When observing each sample obtained in Example 38 being exposed to ultraviolet irradiation, the samples containing 0 mol %, 2 mol %, and 5 mol % of Fl were bluish purple, blue, and green, respectively.

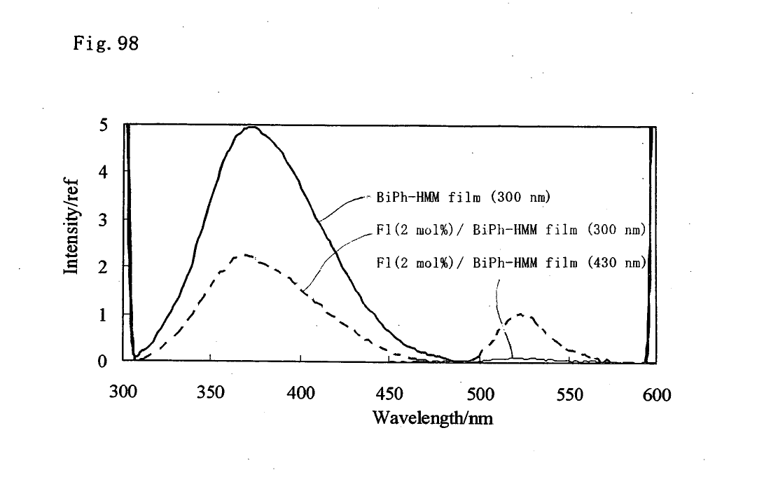

Using the sample 2 (Fl (2 mol %)/BiPh-HMM film) obtained in Example 38, comparison was made between the fluorescence spectra excited using the light having 300 nm of the absorption wavelength of biphenyl group and the light having 420 nm of the absorption wavelength of Fl. FIG. 98 shows the obtained result. In 300 nm excitation, strong luminescence (530 nm) of Fl was observed. However, in 420 nm excitation, weak fluorescence was observed. This result demonstrated that the energy transfer from the biphenyl groups allowed Fl to efficiently emit luminescence. A light harvesting effect by mesoporous backbone was confirmed.

### Examples 39 and 40

Brij76 (C₁₈H₃₇(EO)₁₀, 0.5 g) which serves as a template and a predetermined amount of Rhodamine B (Example 39, available from Aldrich Corporation) or pyrene (Example 40, available from Tokyo Chemical Industry Co., Ltd.) which serves as an optical function molecule were added to a solution containing 360 μl of ion-exchange water, 4 g of ethanol, and 0.01 g of 2N aqueous hydrochloric acid solution. This mixture solution was stirred to produce a uniform solution. Then, 0.6 g of BTEBP was added to such solutions. The mixtures were stirred for another hour to obtain transparent uniform sol solutions. Each sol solution thus obtained was applied on a glass substrate by means of a dip coating method. The coat was dried at 60° C. for 2 hours to obtain a uniform coat film (thickness: 450 nm).

In Example 39, the amount of Rhodamine varied: 0 mg (0 mol %), 2.6 mg (0.5 mol %), 5.2 mg (1 mol %), 10 mg (2 mol %), 26 mg (5 mol %). Also, in Example 40, the amount of pyrene varied: 12 mg (5 mol %), 25 mg (10 mol %), 50 mg (20 mol %). The values put in parenthesis indicate a mol ratio of Rhodamine or pyrene to BTEBP.

When X-ray structure analysis was carried out on each sample obtained in Examples 39 and 40, a peak (d=6.5 nm) indicating a mesostructure was identified in any of BiPh-HMM films into which a pigment (Rhodamine or pyrene) was introduced.

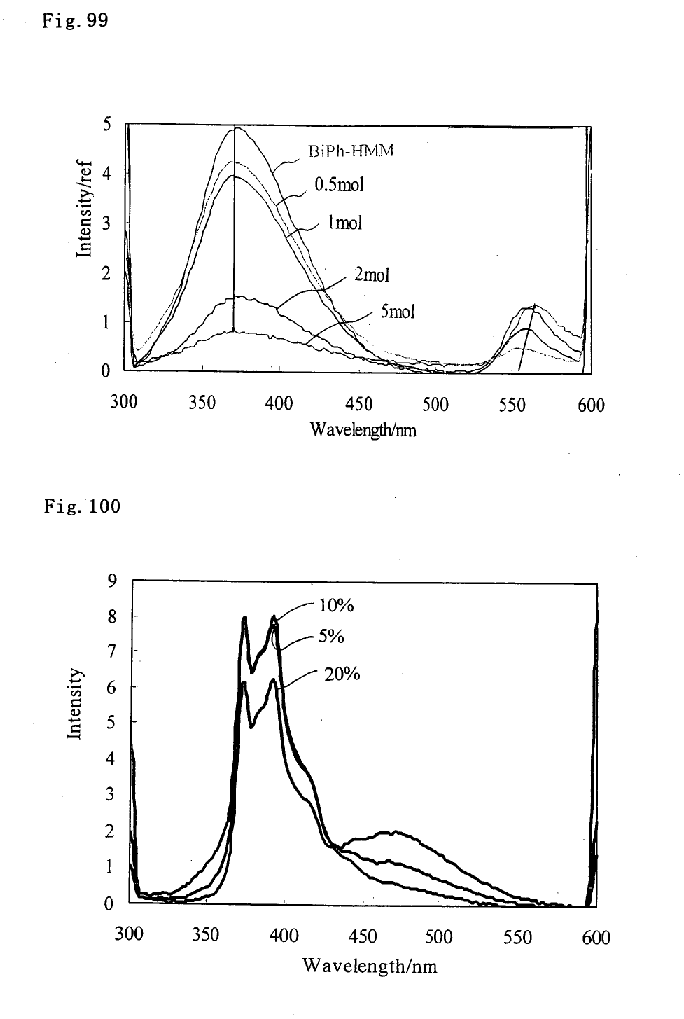

FIG. 99 shows the fluorescence spectra (excitation wavelength: 300 nm) of each sample (Rhodamine/BiPh-HMM film) obtained in Example 39. FIG. 100 shows the fluorescence spectra (excitation wavelength: 300 nm) of each sample (pyrene/BiPh-HMM film) obtained in Example 40. The samples into which Rhodamine was introduced and the samples into which pyrene was introduced demonstrated that, with the increase in the amount of introduced pigment, the fluorescence of the biphenyl group decreased and the fluorescence of the pigment increased, and that the energy transferred from a biphenyl backbone to the pigment.

Furthermore, in each sample (pyrene/BiPh-HMM film) obtained in Example 40, the intensity of monomer luminescence was maintained high even when pyrene was introduced until the amount of pigment introduced into BTEBP reached 20 mol %. This demonstrated that, in mesopores, a pigment was difficult to associate when being in high concentration.

### Examples 41 and 42

Brij76 (C₁₈H₃₇(EO)₁₀, 0.5 g) which serves as a template and 40 mg of EuCl₃ (Example 41, available from Wako Pure Chemical Industries, Ltd.) or 38 mg of Tb Cl₃ (Example 42, available from Wako Pure Chemical Industries, Ltd.) which serves as an optical function molecule were added to a solution containing 360 μl of ion-exchange water, 4 g of ethanol, and 0.01 g of 2N aqueous hydrochloric acid solution. This mixture solution was stirred to produce a uniform solution. Then, 0.6 g of BTEBP was added to such solutions. The mixtures were stirred for another 1 hour to obtain transparent uniform sol solutions. Each sol solution thus obtained was applied onto a glass substrate by a dip coating method. The coat was dried at 60° C. for 2 hours to obtain a uniform coat film (film thickness: 450 nm).

When X-ray structure analysis was carried out on samples obtained in Examples 41 and 42, a peak (d=6.3 nm) indicating a mesostructure was identified in any of BiPh-HMM films into which rare-earth ions (EuCl₃ or TbCl₃) are introduced.

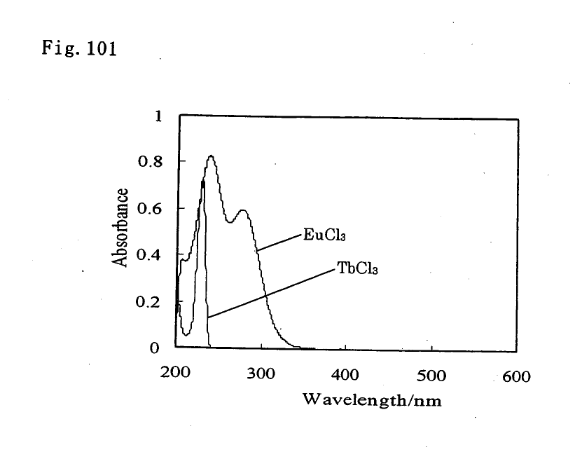

Also, as apparent from FIG. 101 showing the absorption spectra of the ethanol solutions of EuCl₃ and TbCl₃, they have absorption wavelength (EuCl₃: 250 nm, and 270 nm, Tb Cl₃: 220 nm) in a ultraviolet area. However, each of them hardly exhibited a fluorescence spectrum when being excited at the respective maximum absorption wavelength.

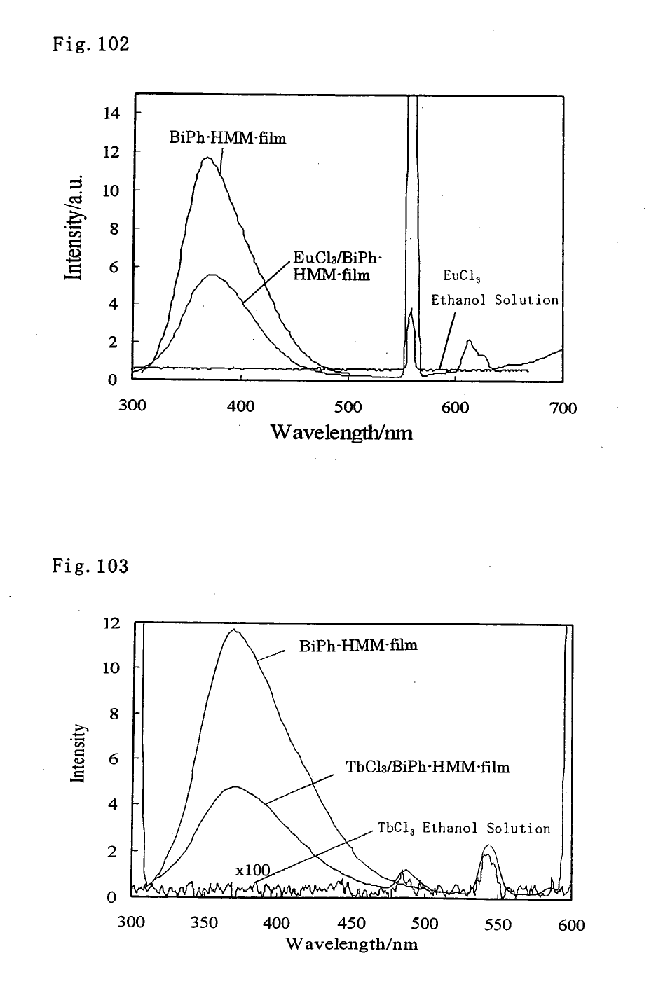

FIG. 102 shows the fluorescence spectrum (excitation wavelength: 280 nm) of the sample (EuCl₃/BiPh-HMM-film) obtained in Example 41, as well as the fluorescence spectra of the ethanol solutions of BiPh-HMM-film and of EuCl₃. FIG. 103 shows the fluorescence spectrum (excitation wavelength: 300 nm) of the sample (TbCl₃/BiPh-HMM-film) obtained in Example 42, as well as the fluorescence spectra of the ethanol solutions of BiPh-HMM-film and of Tb Cl₃. The sample into which EuCl₃ was introduced and the sample into which TbCl₃ was introduced demonstrated that, with the increase in the amount of introduced pigment, the fluorescence of the biphenyl group decreased and the fluorescence of the pigment was increased, and that the energy transferred from a biphenyl backbone to the pigment.

Also, when the above samples were exposed to ultraviolet irradiation (254 nm), strong luminescence in reddish purple, and one in blue colors were observed for EuCl₃/BiPh-HMM-film and for TbCl₃/BiPh-HMM-film, respectively.

### Example 43

Brij76 (C₁₈H₃₇(EO)₁₀, 0.43 g) which serves as a template and a predetermined amount of 7-diethylamino-4-methylcoumarin (available from Sigma-Aldrich Corporation, hereinafter referred to as “coumarin”) which serves as a fluorescence pigment were added to a solution containing 0.18 g of ion-exchange water, 4 g of ethanol, and 0.01 g of 2N aqueous hydrochloric acid solution. This mixture solution was stirred to produce a uniform solution. Then, 0.6 g of BTEBP was added to such solutions. The mixtures were stirred at room temperature for another 2 hours to obtain sol solutions.

The amount of added coumarin varied: 0 mg (0 mol %), 0.188 mg (0.06 mol %), 0.37 mg (0.12 mol %), 0.56 mg (0.18 mol %), 0.75 mg (0.24 mol %), 0.94 mg (0.3 mol %), 1.88 mg (0.6 mol %), 3.7 mg (1.2 mol %), 5.6 mg (1.8 mol %), 7.5 mg (2.4 mol %), 9.4 mg (3.0 mol %), 18.8 mg (6.0 mol %). The values put in parenthesis refer to the mol ratio of coumarin to BTEBP.

The preparation of the above sol solutions was carried out under dark condition to prevent the deterioration caused by the photodimerization reaction of coumarin and the like. Each sol solution thus obtained was then applied onto a glass substrate by a dip coating method. The coat was dried at 60° C. for 2 hours to obtain a uniform coat film (film thickness: 450 nm).

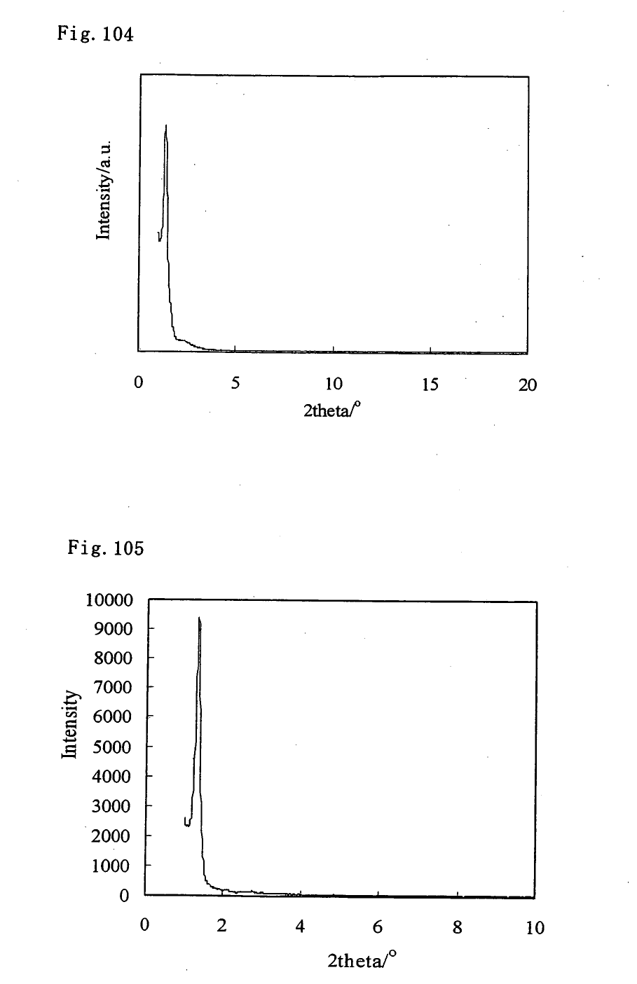

FIGS. 104 and 105 show the X-ray diffraction patterns of BiPh-HMM-film into which coumarin was not introduced and of coumarin (3 mol %)/BiPh-HMM-film into which 3 mol % of coumarin was introduced, respectively. In each film, a diffraction caused by a mesostructure was observed at 2θ=1 to 2°. This demonstrated that the mesostructure of BiPh-HMM-film was maintained even after the introduction of coumarin.

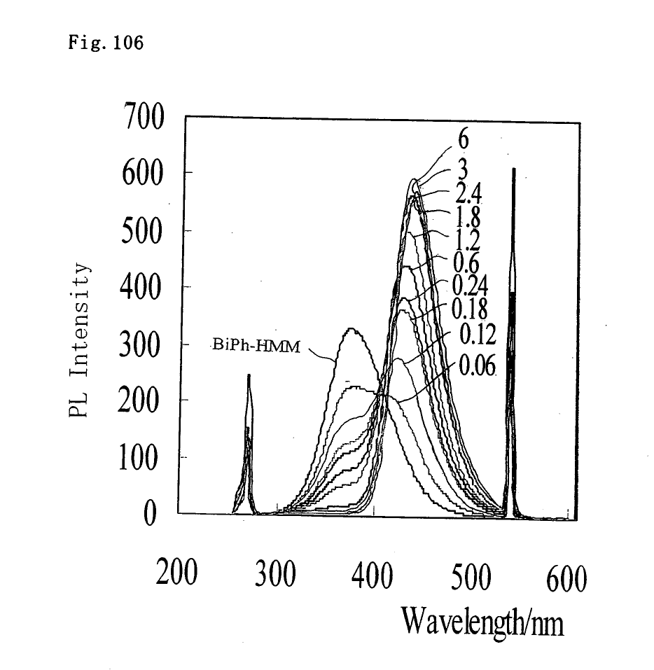

FIG. 106 shows the fluorescence spectra (excitation wavelength: 270 nm) of coumarin/BiPh-HMM-films into which various amounts of coumarin were introduced. In the fluorescence spectrum of BiPh-HMM-film into which coumarin was not introduced, luminescence caused by the biphenyl group was observed only at 370 nm. On the other hand, the introduction of coumarin made luminescence at 430 nm attributable to coumarin observable, but simultaneously caused rapid reduction in the intensity of luminescence at 370 nm attributable to the biphenyl group. At the time when 1.8 mol % or more of coumarin was introduced to the biphenyl group in BiPh-HMM, luminescence caused by the biphenyl group was almost completely quenched. Sharp blue luminescence emitted by this coumarin/BiPh-HMM-film was observed when the film was exposed to ultraviolet irradiation.

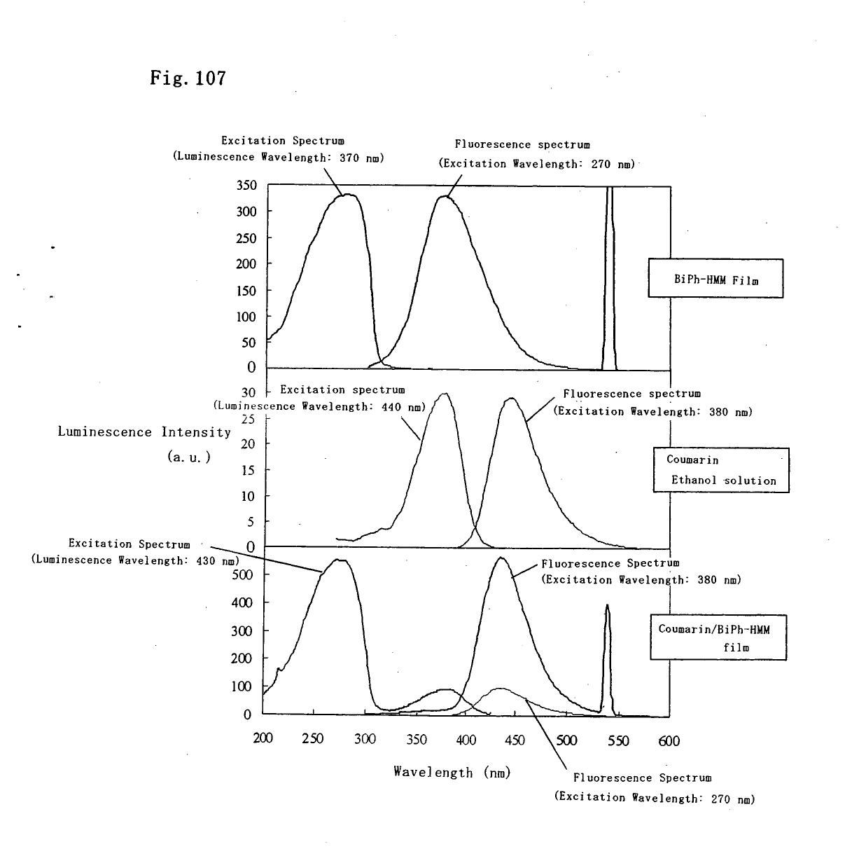

FIG. 107 shows comparison of the fluorescence and the excitation spectra between BiPh-HMM-film, the ethanol solution of coumarin, and coumarin (1.8 mol %)/BiPh-HMM-film. It is apparent from FIG. 107 that excitation wavelength of BiPh-HMM-film and that of coumarin hardly overlap with each other. That is, it can be seen that, by the light with a wavelength of 270 nm, BiPh-HMM-film is excited prior to coumarin. This demonstrated the energy transferred from BiPh-HMM-film to coumarin.

When coumarin (1.8 mol %)/BiPh-HMM-film was excited at 270 nm and at 380 nm, it was seen that excitation at 270 nm provided the fluorescence intensity of coumarin eight times (area ratio) stronger than that which excitation at 380 nm provided (FIG. 107). When the amount of introduced coumarin was 0.12 mol %, the ratio between the intensities of the fluorescence of both excitation wavelengths became forty eight to one. That is, this demonstrated that the energy transfer from BiPh-HMM allows coumarin to emit luminescence with efficiency higher than direct excitation of coumarin. The present inventors conclude that this is because BiPh-HMM efficiently harvests the light, and can efficiently give the energy to coumarin.

### Example 44

Predetermined amounts of coumarin which serves as a fluorescence pigment were added to solutions each containing 0.18 g of ion-exchange water, 4 g of ethanol, and 0.01 g of 2N aqueous hydrochloric acid solution. These mixture solutions were stirred to produce uniform solutions. Then, 0.6 g of BTEBP was added to such solutions. The obtained mixtures were stirred at room temperature for another 2 hours to obtain sol solutions.

The amount of added coumarin varied: 0 mg (0 mol %), 0.047 mg (0.015 mol %), 0.094 mg (0.03 mol %), 0.47 mg (0.15 mol %), 0.94 mg (0.3 mol %), 4.7 mg (1.5 mol %), 9.4 mg (3.0 mol %). The values put in parenthesis refer to the mol ratio of coumarin to BTEBP.

The preparation of the above sol solutions was carried out under dark condition to prevent the deterioration caused by photodimerization reaction of coumarin and the like. Each sol solution thus obtained was then applied onto a glass substrate by a dip coating method. The coat was dried at 60° C. for 2 hours to obtain a uniform coat film (film thickness: 450 nm).

The X-ray diffraction pattern of the composite film formed from coumarin and biphenyl silica (coumarin/BiPh composite film) obtained in Example 44 demonstrated no distinctive peak, and thus, no regular mesostructure constructed was identified.

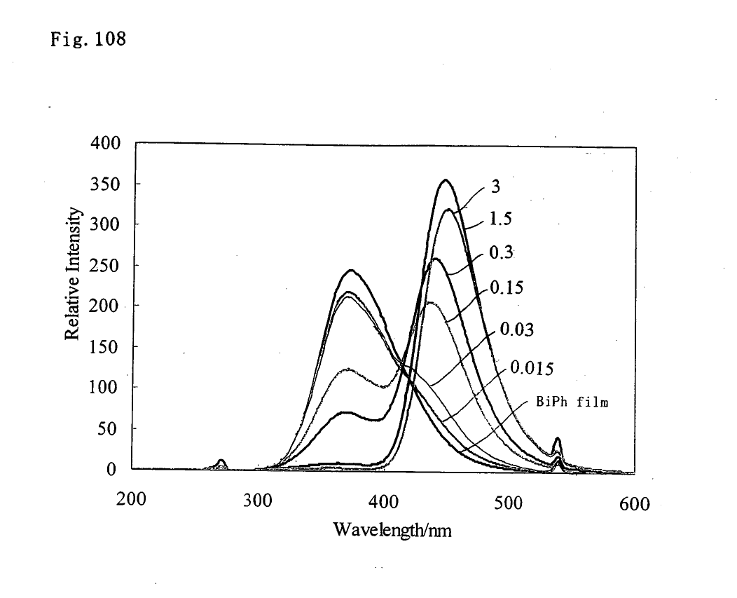

FIG. 108 shows the fluorescence spectra (excitation wavelength: 270 nm) of the coumarin/BiPh composite films into which various amounts of coumarin have been introduced. The result demonstrated that in the system in which no surfactant is used, excitation energy transferred from the biphenyl group to coumarin. Sharp blue luminescence emitted by this coumarin/BiPh composite film as well was observed when the film was exposed to ultraviolet irradiation.

### Example 45 and comparative examples 10 and 11

A phosphorescence complex Ir(ppy)₃ solution (mixing ratio of solvent, 1:4=ethanol:THF) having a given concentration was previously prepared as follows. That is, 23 mg (3.5×10⁻⁵ mol) of Ir(ppy)₃ (available from Dojindo Laboratories) was first added to a solution containing 30.7 g of THF and 7.8 g of ethanol. The mixture was stirred to produce a uniform solution. This solution was designated with “X”.

The concentration of solution X was designated with “a”. Then, four solutions (D, C, B, and A) of different concentration (a, 0.75a, 0.5a, and 0.25a, respectively) were prepared. The weight of each solution was 8 g. The mixing ratio of solvents was 1:4=ethanol:THF. Brij76 (C₁₈C₃₇(EO)₁₀, 0.43 g) which serves as a surfactant, 10 μl of 6N aqueous hydrochloric acid solution, and 180 μl of pure water were added to each of the solutions A, B, C, and D. The obtained mixtures were stirred for 10 minutes. (The obtained solutions were designated with A′, B′, C′, and D′, respectively.) Then, 0.6 g of BTEBP was added to each of the solutions A′, B′, C′, and D′. The obtained mixtures were stirred for a day to produce uniform sol solutions. (These sol solutions were designated with A″, B″, C″, and D″.)

The mol ratio of Ir(ppy)₃ to BTEBP in the sol solutions A″, B″, C″, and D″ thus obtained were 0.14 mol %, 0.28 mol %, 0.42 mol %, 0.58 mol %.

A quartz substrate was dip-coated (it took 1 minute for dipping, 2 minutes each for upward and downward movements) with each sol solution thus obtained. The substrate was then dried at 60° C. for 2 hours to obtain a uniform coat film (film thickness: 450 nm).

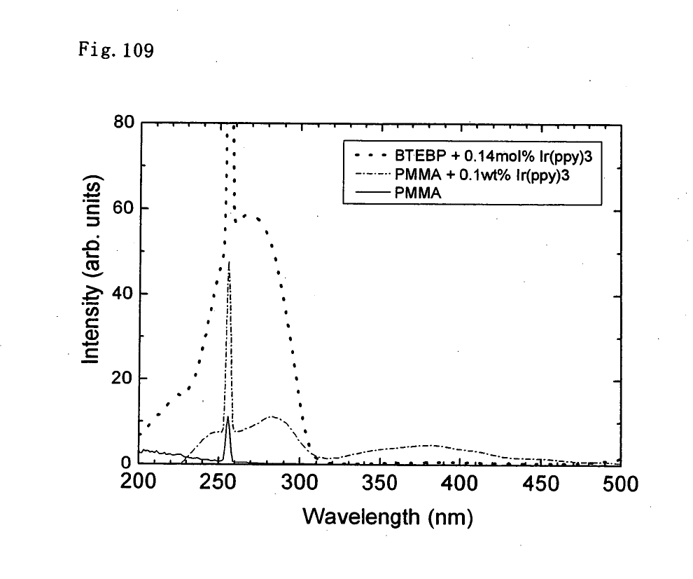

The phosphorescence emitting peak wavelength is 511 nm. Thus, an excitation spectrum to obtain the emission was measured. FIG. 109 shows the excitation spectrum of Ir(ppy)₃/BiPh-HMM film into which 0.14 mol % of Ir(ppy)₃ was introduced, as well as the excitation spectra of Ir(ppy)₃/PMMA film (Comparative example 10) into which 0.1% by weight of Ir(ppy)₃ was introduced for comparison, and a PMMA film into which Ir(ppy)₃ was not introduced (Comparative example 11). The excitation spectrum of PMMA film (film thickness: 1.1 to 1.2 μm) demonstrated that PMMA was optically not active near 220 nm. Also, the excitation spectrum of the film (film thickness: 1.1 to 1.2 μm) prepared by doping Ir(ppy)₃ in the optically inactive PMMA demonstrated that that Ir(ppy)₃ was not directly excited near 220 nm. On the other hand, BiPh-HMM film itself is excited near 220 nm. As a result, the excitation wavelength of Ir(ppy)₃/BiPh-HMM film was set to 220 nm.

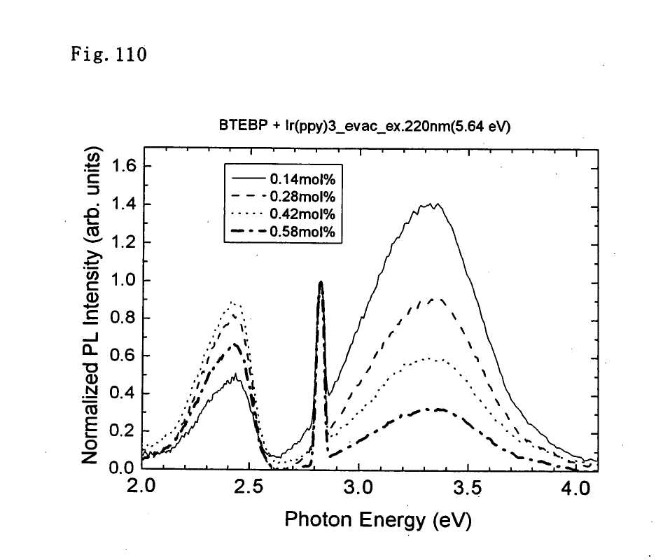

FIG. 110 shows the phosphorescence spectrum of each Ir(ppy)₃/BiPh-HMM film obtained in Example 45. When Ir(ppy)₃/BiPh-HMM film was excited at the wavelength (excitation wavelength: 220 nm, Photon Energy=5.64 eV) at which phosphorescent material Ir(ppy)₃ was not excited, green luminescence (luminescence peak wavelength: 511 nm) derived from Ir(ppy)₃ was obtained. This demonstrated that the energy transferred from BiPh-HMM to the phosphorescent material. Also, with the increase in the concentration of Ir(ppy)₃, the peak intensity of a biphenyl-derived ultraviolet emission (emission wavelength: 370 nm, Photon Energy=3.3 eV) was reduced, and the peak intensity of an Ir(ppy)₃-derived green luminescence (luminescence wavelength: 511 nm, Photon Energy=2.4 eV) was increased. Note that the comparison was made by standardizing luminescence intensities using the peak intensity of the excitation light.

### Examples 46 to 48

The mesoporous material of the biphenyl silica composite material (BiPh-HMM-c) obtained in Example 4, and the precursor of the mesoporous material of the biphenyl silica composite material containing a surfactant (BiPh-HMM-c-s) obtained in Example 5 were used.

First, 55 mg of Rhodamine 6G (R6G, available from Tokyo Chemical Industry Co., Ltd.) was dissolved in 24 g of ethanol to prepare R6G solution A. Similarly, 55 mg of R6G was dissolved in 11.4 g of ethanol to prepare R6G solution B.

R6G solution A (2.56 g) was added to 1 g of BiPh-HMM-c. The mixture was exposed to ultrasonic waves for 1 minute to cause R6G to be dispersed. Then, ethanol was evaporated at room temperature to obtain sample 1 which comprises BiPh-HMM-c with R6G permeating through (attached on or filled in pores of) its surface (Examples 46, the amount of permeating R6G is 0.59% by weight to BiPh-HMM-c).

Similarly, 2.56 g of R6G solution A or 2.48 g of R6G solution B was poured to 1 g of BiPh-HMM-c-s. The mixture was exposed to ultrasonic radiation for 1 minute to cause R6G to be dispersed. Then, ethanol was evaporated at room temperature to obtain sample 2 (Example 47, the amount of permeating R6G is 0.59% by weight to BiPh-HMM-c-s), or sample 3 (Example 48, the amount of permeating R6G is 1.2% by weight to BiPh-HMM-c-s), each of which comprises BiPh-HMM-c-s with R6G permeating (attached or filled in pores).

FIG. 111 shows the fluorescence spectra of samples 1 to 3 (mixtures of R6G and BiPh-HMM) obtained, respectively, in Examples 46 to 48, as well as the fluorescence spectrum of BiPh-HMM-c-s obtained in Example 5. When BiPh-HMM-c-s and samples 1 to 3 were excited using the light with a wavelength of 300 nm, fluorescence near 370 nm which is characteristic of BiPh-HMM-c-s and fluorescence near 560 nm derived from the adhesion of R6G were observed. It is not altogether clear whether the fluorescence near 560 nm was caused by the energy transfer from BiPh-HMM-c-s, by excitation at 300 nm, or by these two together. Nevertheless, it was demonstrated that samples 1 to 3 had lower fluorescence intensity near 370 nm than BiPh-HMM-c-s, and the ratio of the fluorescence intensity near 370 nm to the intensity near 560 nm varied depending on the existence of a surfactant and on the amount of impregnated R6G. Accordingly, controlling these makes it possible to adjust color when mixing colors.

### Example 49

The precursor of the mesoporous material of the biphenylsilica composite material containing a surfactant (BiPh-HMM-c-s) obtained in Example 5 was used.

Dansyl Acid (DANS, 1-Dimethylaminonaphthalene-5-sulufonic acid available from Tokyo Chemical Industry Co., Ltd., 57 g) was dissolved in the mixture solution of 18.5 g of acetone and 23.5 g of ion-exchange water to prepare DANS solution. DANS solution (9.65 g) was poured to 1 g of BiPh-HMM-c-s. The mixture was exposed to ultrasonic waves for 1 minute to cause DANS to be dispersed. Then, the solvent was evaporated at room temperature to obtain sample which comprises BiPh-HMM-c-s with DANS permeating (attached to or filled in pores) thereon (the amount of permeating DANS is 1.3% by weight to BiPh-HMM-c-s).

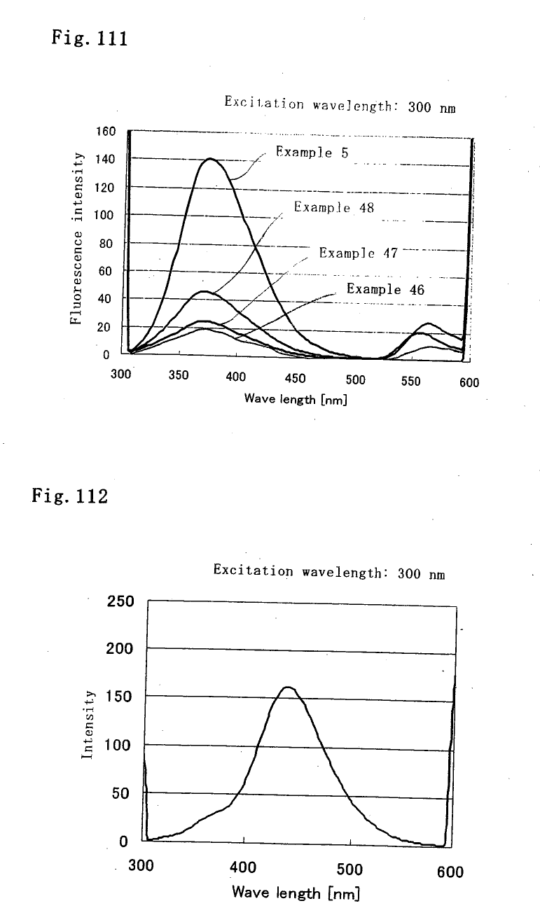

FIG. 112 shows the fluorescence spectrum of the sample (mixture of DANS and BiPh-HMM) thus obtained in Examples 49 When the sample was excited using the light with a wavelength of 300 nm, the fluorescence intensity near 370 nm characteristic of BiPh-HMM-c-s was reduced, and the strong blue fluorescence near 440 nm derived from permeating DANS was identified.

### Examples 50 to 53

Adding 1 ml of 2N aqueous hydrochloric acid solution and 0.178 g of Brij76 (C₁₈H₃₇(EO)₁₀) which serves as a surfactant to 36 g of ion-exchange water, they were mixed to produce a uniform solution. BTEBP (0.598 g) was added to the solution being stirred. This solution was exposed to ultrasonic waves for 20 minutes. The obtained solution was stirred at room temperature for 72 hours, and stirred at 100° C. for another 24 hours. Then, the solution was cooled to room temperature, filtered, washed, and dried to obtain the precursor of the mesoporous material of the biphenylsilica composite material containing a surfactant Example 50, BiPh-HMM-c2-s). In the X-ray diffraction pattern of BiPh-HMM-c2-s obtained in Example 50, a peak was observed in a low angle area (5° or less) showing a regular mesostructure, but no peak showing the regular array of biphenyl was observed.

Here, BiPh-HMM-c2-s obtained in Example 50, the mesoporous material of biphenylsilica composite material (BiPh-HMM-c) obtained in Example 4, and the precursor of the mesoporous material of the biphenylsilica composite material containing a surfactant (BiPh-HMM-c2-s) obtained in Example 5 were used.

Firstly, coumarin (7-Diethylamino-4-methylcoumarin, available from Aldrich Corporation, 104 mg) was dissolved in 20 g of ethanol to prepare coumarin solutions A, and in 35 g of ethanol to prepare coumarin solution B. Coumarin solution A (3.174 g) was poured to 1 g of BiPh-HMM-c. The mixture was exposed to ultrasonic waves for 1 minute to cause coumarin to be dispersed. Then, ethanol was evaporated at room temperature to obtain sample 1 which comprises BiPh-HMM-c having coumarin permeating through (attached to or filled in pores of) its surface (Examples 51, the amount of permeating coumarin was 1.82 mol % to BiPh-HMM-c).

Also, 2.842 g of coumarin solution B was poured to 1 g of BiPh-HMM-c-s, and 3.086 g of coumarin solution B was poured to BiPh-HMM-c2-s. The mixtures were exposed to ultrasonic waves for 1 minute to cause coumarin to be dispersed. Then, ethanol was evaporated at room temperature to obtain sample 2 which comprise BiPh-HMM-c-s with coumarin permeating (attached or filled in pores) thereon (Example 52, the amount of permeating coumarin was 1.87 mol % to BiPh-HMM-c-s), and to obtain sample 3 which comprise BiPh-HMM-c2-s with coumarin permeating (attached or filled in pores) thereon (Example 53, the amount of impregnated coumarin was 2.03 mol % to BiPh-HMM-c2-s).

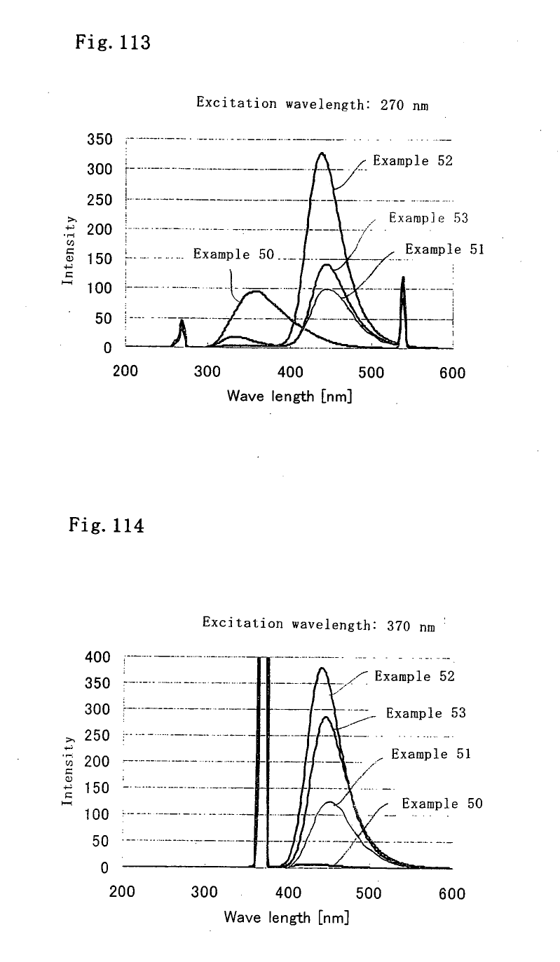

FIGS. 113 (excitation wavelength: 270 nm) and 114 (excitation wavelength: 370 nm) show the fluorescence spectra of samples 1 to 3 (mixtures of coumarin and BiPh-HMM) thus obtained in Examples 51 to 53, and the fluorescence spectrum of BiPh-HMM-c2-s obtained in Example 50.

<White Luminescence Test by Combination of Introduced Pigments>

### Example 54

Brij76 (C₁₈H₃₇ (EO)₁₀, 0.5 g), 2 mg of Rhodamine6G, and 10 mg of coumarin152 (available from Aldrich Corporation) were added to the solution containing 4 g of ethanol, 360 μl of water, and 0.01 g of 2N aqueous hydrochloric acid solution. This mixture solution was stirred to produce a uniform solution. Subsequently, 0.6 g of BTEBP was added to the solution. The mixture was stirred for another hour to obtain a transparent uniform sol solution. The sol solution thus obtained was applied onto a glass substrate by a dip coating method. The coat was dried at 60° C. for 2 hours to obtain a uniform coat film (film thickness: 450 nm).

X-ray structure analysis carried out on the sample obtained in Example 54 demonstrated that BiPh-HMM film into which Rhodamine and coumarin are introduced also exhibits the peak (d=6.3 nm) indicating a mesostructure.

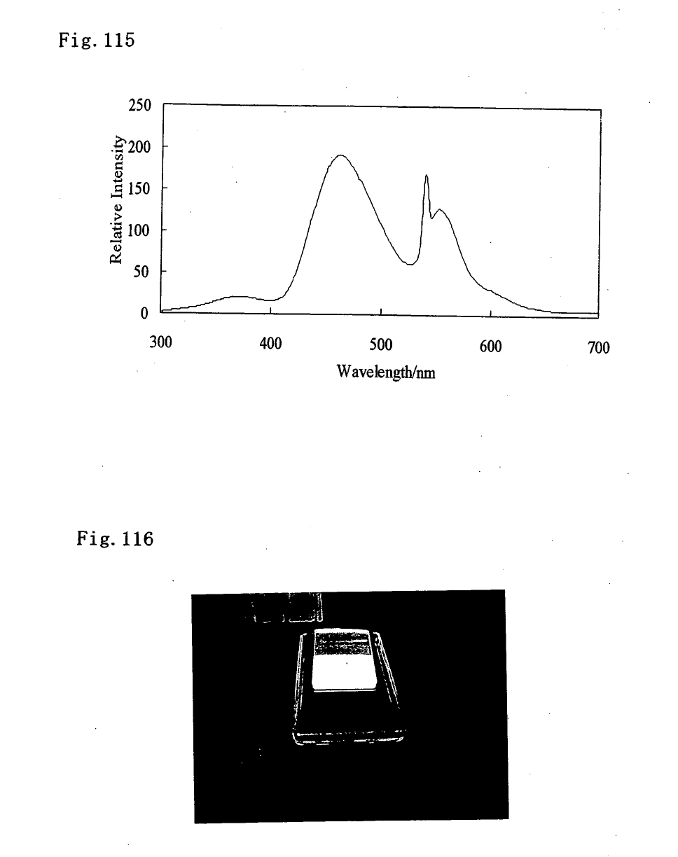

FIG. 115 shows the fluorescence spectrum of the sample obtained in Example 54. In the BiPh-HMM film into which Rhodamine and coumarin were introduced, the luminescence of coumarin at 460 nm and that of Rhodamine at 550 nm were both observed. When being exposed to ultraviolet radiation (254 nm), white luminescence emitted from the film was observed (FIG. 116).

<Measurement of the Refractive Index of a Porous Biphenyl Silica Composite Material>

### Example 55

BTEBP (0.3 g) was added to the solution prepared by adding 90 μl of ion-exchange water, 10 μl of 2N aqueous hydrochloric acid solution, and 0.2 g of nonionic surfactant P123 ((EO)₂₀ (PO)₇₀ (EO)₂₀) to 2 g of ethanol. The mixture solution was stirred at room temperature for 1 hour to obtain a sol solution. Using this sol solution, a coat film (film thickness: 300 to 600 nm) was obtained on a glass substrate by a spin coating method. Coating conditions include 4000 rpm of revolutions, and 1 minute of revolution time. Furthermore, the obtained coat film was calcined in air at 250° C. for 2 hours to obtain porous BiPh-HMM-a-film (film thickness: 500 nm).

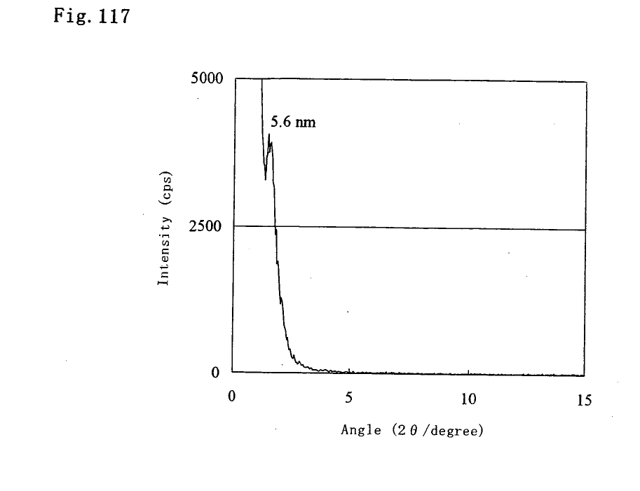

FIG. 117 shows the X-ray diffraction pattern of BiPh-HMM-a-film obtained in Example 55. A peak at d=5.6 nm was observed indicating this BiPh-HMM-a-film had a regular mesostructure existing therein.

Table 10 shows the result of measuring the refractive index of the BiPh-HMM-a-film obtained in Example 55 by ellipsometry. The porous film obtained in Example 55 has a refractive index of 1.34. This refractive index is lower than that of a glass (refractive index: 1.7) having no pore. This demonstrated the possibility of achieving high efficiency in taking out the light with a porous luminescent material of the present invention.

TABLE 10

| Sample | Refractive index |
|---|---|
| Glass | 1.7 |
| Air | 1 |
| BiPh-HMM | 1.34 |

<Measurement of the Fluorescence Quantum Yield of the Biphenyl Silica Composite Material>

### Example 56

In general, with respect to a powder and a film, accurate fluorescence quantum yield cannot be determined because of problems concerning light scattering and unavailability of a suitable comparative sample. Thus, a biphenyl silica composite material was synthesized in fine particles (about 200 nm in diameter) which are dispersible in a solvent and which do not cause light scattering. Then, the fluorescence quantum yield of the biphenyl silica composite material was determined using 9,10-diphenylanthracene which has a known quantum yield (quantum yield: 0.90) as a standard sample.

Firstly, the fine particles of the biphenylsilica composite material were synthesized through the following procedure. Ion-exchange water (50 ml) and 0.31 g of 6N aqueous sodium hydroxide solution were mixed. Then, 1 g of BTEBP was added to the mixture. This solution was stirred at room temperature for 5 minutes, and then was exposed to ultrasonic waves for 20 minutes, thereby resulting in a white emulsified solution. This emulsion was put in an autoclave which has a Teflon interior surface and a metallic exterior surface, and stirred in a rotary oven at 120° C. for 15 hours. The obtained solution was translucent. This solution was filtered with a Teflon filter (filterpore size: 100 μm). When water was removed, 500 ml of water was added onto the filter to wash the residue. After this washing operation was repeated once again, a drying process was carried out in vacuum round the clock to obtain the fine particle of the biphenyl silica composite material.

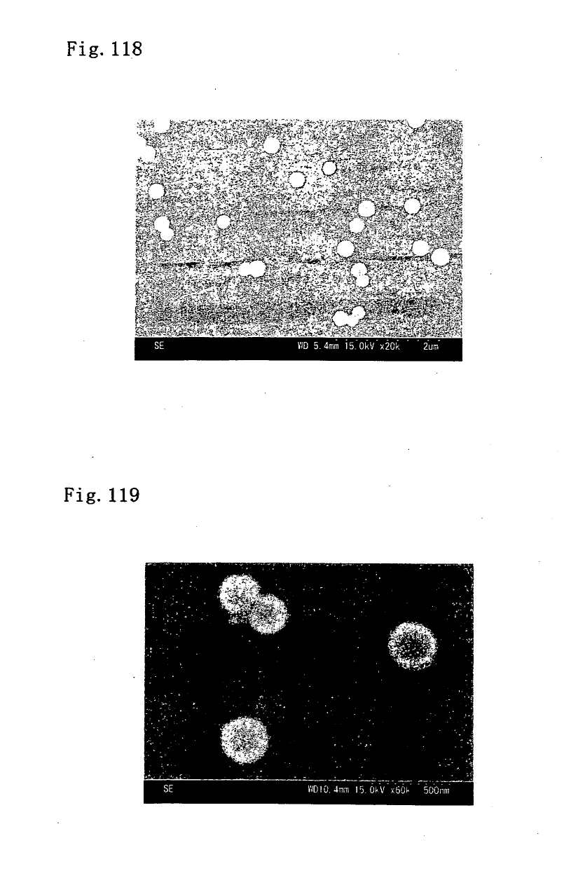

FIGS. 118 and 119 show scanning electron micrographs of the synthesized biphenyl silica fine particles. The produced fine particles having a diameter of about 200 nm were identified. Few particles aggregated between each other, and most of the particles were isolated from each other.

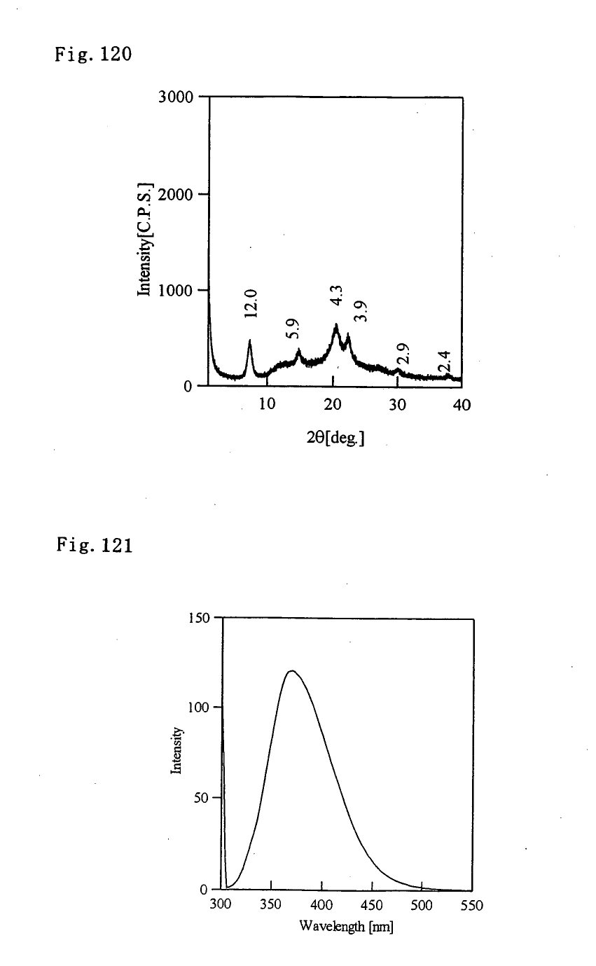

FIG. 120 shows the X-ray diffraction pattern of the obtained biphenyl silica fine particles. Several peaks were observed, indicating that this material had a periodic structure in molecule scale. Each peak attributes to 12.0 Å (001), 5.9 Å (002), 3.9 Å (003), 2.9 Å (004), 2.4 Å (005), indicating this particle had a layered structure with an interlayer distance of 12 Å.

FIG. 121 shows the fluorescence spectrum (excitation wavelength: 300 nm) of the powder of the obtained biphenyl silica fine particles. Strong fluorescence around 370 nm that the biphenyl silica fine particles exhibited was identified.

A method of measuring a fluorescence quantum yield is described below. A spectrophotometer (MPS-2400, available from Shimadzu Corporation) was used in the measurement of an absorption spectrum. A spectrofluorometer (FP6600, available from JASCO Corporation) was used in the measurement of a fluorescence spectrum. Also, a square cell (10 mm) was used in the measurement of an absorption spectrum. A triangle cell was used in the measurement of a fluorescence spectrum.

The biphenyl silica fine particles synthesized as described above were dispersed in 2-propanol (refractive index at 260 nm of wavelength: about 0.4) having a refractive index close to that of biphenylsilica. This dispersion liquid was exposed to ultrasonic waves to obtain a transparent solution. Two dispersion liquids having different concentrations were prepared. The unit concentrations of biphenyl silica which were calculated from the unit formula (SiO_{1.5}—C₆H₄—C₆H₄—SiO_{1.5}: MW256) were 1.62×10⁻⁶ and 0.81×10⁻⁶ mol/L.

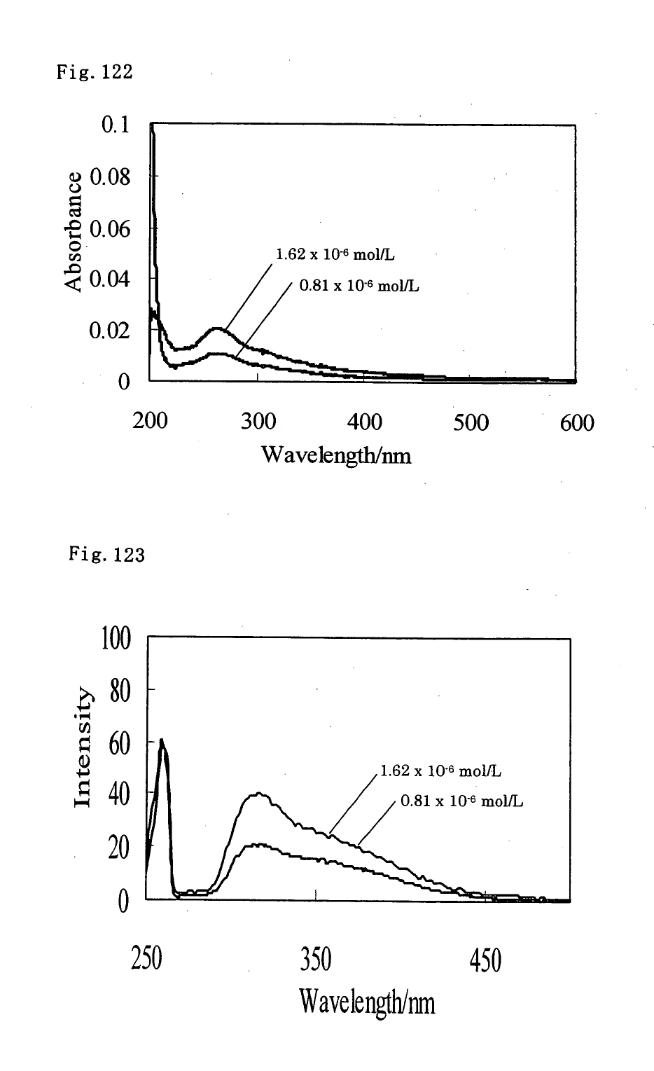

The haze value of the dispersion liquids was 6.4% in each concentration (haze value of only the solvent: 0.5%) indicating that the effect of light scattering by the particles is negligibly small. FIG. 122 shows the absorption spectra of biphenyl silica fine particles/2-propanol dispersion liquids of the two concentrations. FIG. 123 shows the fluorescence spectra (excitation wavelength: 260 nm) of the liquids. In this concentration range, a good linearity of the absorbance and that of the integrated fluorescence intensity to the concentration were obtained, suggesting that there is no effect of the concentration such as self-quenching.

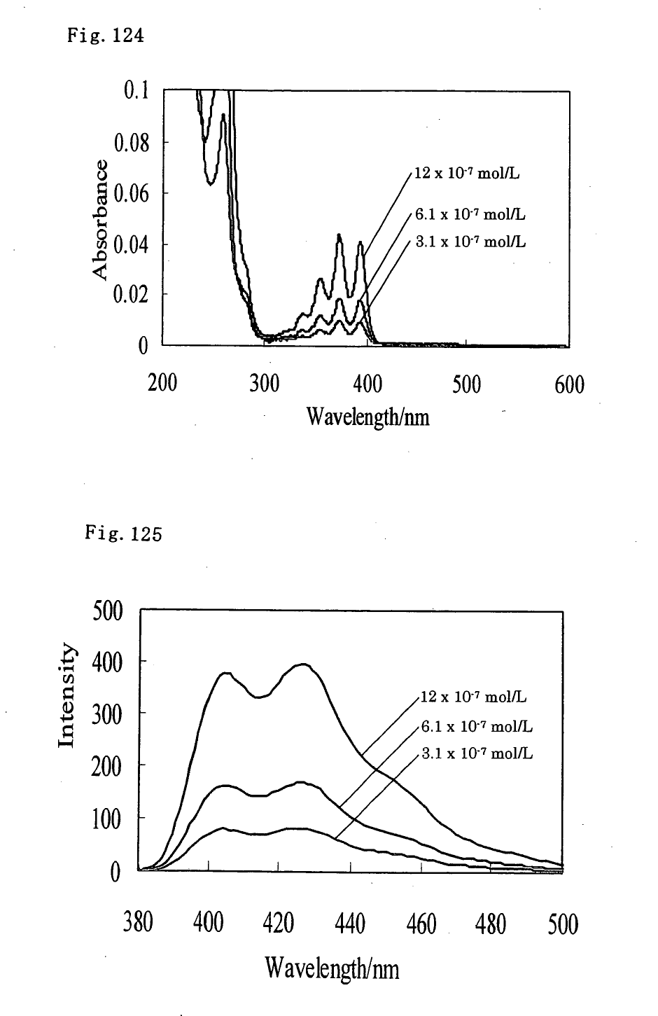

On the other hand, 9,10-diphenylanthracene solution which serves as the standard sample was prepared using cyclohexane as a solvent according to conditions described in a literature (J. Phys. Chem., Vol. 87, 1983, p. 83). FIGS. 124 and 125 show, respectively, the absorption spectrum and the fluorescence spectrum (excitation wavelength: 370 nm) of 9,10-diphenylanthracene/cyclohexane solution. In this concentration range (0.31 to 1.2×10⁻⁶ mol/L), the linearity of the absorbance and that of the integrated fluorescence intensity to the concentration were obtained.

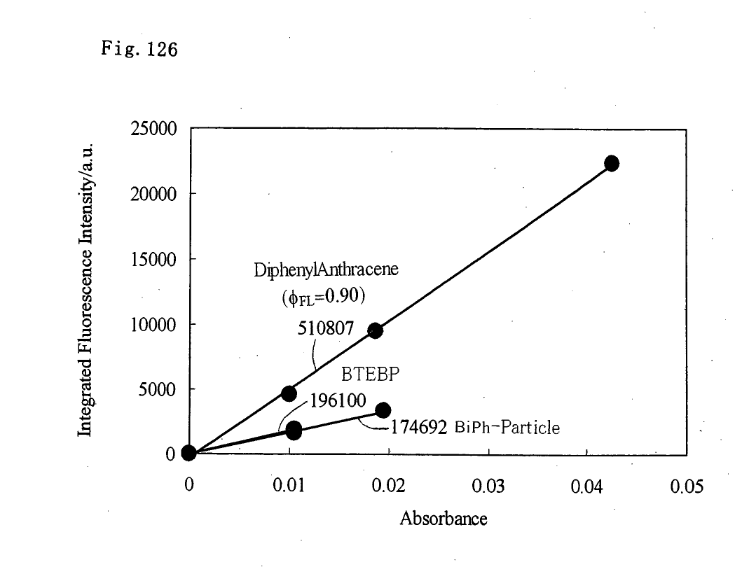

The integrated fluorescence intensity of the biphenylsilica fine particle dispersion liquid and that of the standard sample were plotted to the absorbance (FIG. 126). The fluorescence quantum yield was calculated by the following equation from the gradients of the graph (gradₓ and gradₛₜ, The subscripts ₓ and ₛₜ indicate the sample to be determined and the standard sample, respectively).
Φₓ=φₛₜ(gradₓ/gradₛₜ)×(η²ₓ/η²ₛₜ)
Where Φ is a fluorescence quantum yield, η is the refractive index of a solvent. For n of 2-propanol, 1.3972 (wavelength: 260 nm) was used. And for η of cyclohexane, 1.4405 (wavelength: 370 nm) was used. As a result of calculation, the fluorescence quantum yield of the biphenyl silica fine particles of 0.3 was obtained.

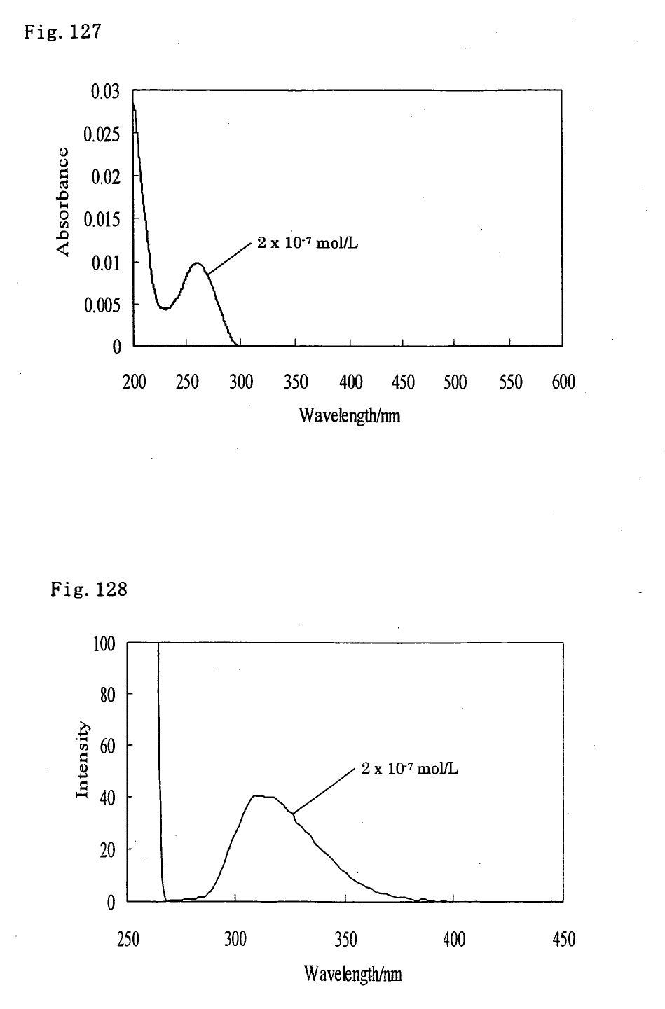

By the same method, the fluorescence quantum yield of 4,4′-bis(triethoxysylil)biphenyl [(EtO)₃S1-C₆H₄—C₆H₄—Si(OEt)₃] which is a raw material of biphenyl silica fine particle was found. FIGS. 127 and 128 show the absorption spectrum and the fluorescence spectrum (excitation wavelength: 255 nm) of BTEBP/2-propanol solution, respectively. Also, the relationships between the integrated fluorescence intensity and the absorbance were plotted in FIG. 126. The fluorescence quantum yield of BTEBP (0.34) was determined by these gradients.

### Examples 57 and 58

Ion-exchange water (90 μl) and 5 μl of 2N aqueous hydrochloric acid solution were added to 2 g of ethanol. Brij76 (C₁₈H₃₇(EO)₁₀, 0.215 g) which serves as a surfactant was then added to the above mixture. This mixture was mixed to produce a uniform solution. BTEBP (0.3 g) was added to the above solution. This mixture was stirred for 24 hours to obtain a sol solution. This sol solution was four times diluted with ethanol. Then, this sol solution was applied onto the quart substrate by a spin coating method to produce a coat film thereon. This coat film was dried at room temperature to obtain BiPh-HMM-film having a thickness of about 100 nm (Example 57).

Additionally, coumarin-supporting BiPh-HMM-film was obtained by the same method except that coumarin (available from Sigma-Aldrich Corporation) of 3 mol % to BTEBP was added when Brij76 was dissolved in the solution prior to the addition of BTEBP (Example 58).

The quantum yield of the obtained film was measured using an organic EL quantum yield measuring device (C9920-01) available from Hamamatsu Photonics K.K. In this device, correction was made in advance by measuring AlQ₃ with a known quantum yield of 0.2 (see Jpn. J. Appl. Phys., 43, 11A, (2004)7730). Table 11 shows the obtained results.

BiPh-HMM-film obtained in Example 57 has a quantum yield of 0.51, which is higher than that of powder sample. The quantum yield of coumarin/BiPh-HMM-film obtained in Example 58 is almost 1. This indicated that almost 100% of the energy absorbed by the biphenyl backbone was transferred to coumarin, and most of the transferred energy was converted to the light.

TABLE 11

| | Quantum yield |
|---|---|
| Sample | (excitation wavelength: 285 nm) |
| AlQ₃ | 0.20 |
| BiPh-HMM-film | 0.51 |
| Coumarin/BiPh-HMM-film | 0.99 |

### INDUSTRIAL APPLICABILITY

As described above, the present invention improves luminescence efficiency. In addition, the present invention prevents the reduction in luminance caused by concentration quenching, and thereby achieves high luminescence. Furthermore, the present invention provides an organic luminescent material with excellent heat resistance and a long service lifetime. The technology of the present invention is very useful in improving the luminescence of organic luminescent materials, conventionally, incapable of achieving sufficient luminance and luminescence efficiency. Also it is useful in maintaining a high luminescence of the materials for a long period of time, while the materials are free from reduction in luminance caused by concentration quenching.

1. A luminescent material composed of a polymer of an organic silicon compound represented by the following general formula (1):
Chemical Formula 1 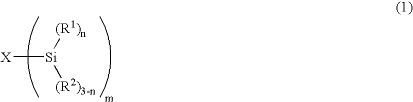
[where X is an organic molecule which emits any of fluorescence and phosphorescence; R¹ is at least a member selected from the group consisting of a lower alkoxy group, a hydroxyl group, an allyl group, an ester group, and halogen atoms; R² is at least a member selected from the group consisting of a lower alkyl group and a hydrogen atom; n is an integer of 1 to 3; and m is an integer of 1 to 4].

2. The luminescent material according to claim 1, wherein R¹ is a lower alkoxy group and/or a hydroxyl group, and n is 3.

3. The luminescent material according to claim 1, wherein R¹ is a lower alkoxy group, n is 3, m is 2, and the polymer of said organic silicon compound has a repeating unit represented by the following general formula (2):
Chemical Formula 2 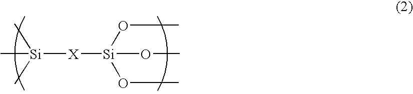
[where X is an organic molecule which emits any of fluorescence and phosphorescence].

4. The luminescent material according to claim 1, wherein said the difference in energy between the ground. state and any of a singlet excited state and a triplet excited state is 40 to 140 kcal/mol in said organic molecule which emits any of fluorescence and phosphorescence.

5. The luminescent material according to claim 1, wherein the polymer of said organic silicon compound has a structure with a period of 5 nm or less caused by a regular array of said organic molecule which emits any of fluorescence and phosphorescence.

6. The luminescent material according to claim 1, wherein the polymer of said organic silicon compound is a porous material.

7. The luminescent material according to claim 1, wherein the polymer of said organic silicon compound is a mesoporous material having a central pore diameter of 1 to 30 nm.

8. The luminescent material according to claim 6, further comprising another luminescent compound.

9. The luminescent material according to claim 8, wherein said another luminescent compound is in a state selected from the group consisting of “adsorbed on,” “bonded to,” “filled in,” and “mixed with” said porous material.

10. The luminescent material according to claim 8, further comprising a surfactant.

11. The luminescent material according to claim 8, wherein said another luminescent compound is a phosphorescent material.

12. The luminescent material according to claim 1, further comprising another luminescent compound.

13. The luminescent material according to claim 12, wherein said another luminescent compound is in a state selected from the group consisting of “adsorbed on,” “bonded to,” “filled in,” and “mixed with” the polymer of said organic silicon compound.

14. The luminescent material according to claim 12, wherein said another luminescent compound is a phosphorescent material.

15. The luminescent material according to claim 1, wherein the polymer of said organic silicon compound is a particulate material having an average particle diameter of 1 μm or less.

16. The luminescent material according to claim 1, wherein the polymer of said organic silicon compound is a film having an average film thickness of 1 μm or less.

17. The luminescent material according to claim 1, wherein the polymer of said organic silicon compound is a layered material of stacked nanosheets, each layer having a thickness of 10 nm or less.

18. The luminescent material according to claim 1, further comprising an electric charge transporting material.

19. A method of producing a luminescent material, comprising a step of obtaining a luminescent material by polymerizing an organic silicon compound represented by the following general formula (1) under the existence of another luminescent compound:
Chemical Formula 3 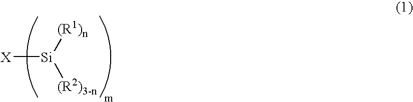
[where X is an organic molecule which emits any of fluorescence and phosphorescence; R¹ is at least a member selected from the group consisting of a lower alkoxy group, a hydroxyl group, an allyl group, an ester group, and halogen atoms; R² is at least a member selected from the group consisting of a lower alkyl group and a hydrogen atom; n is an integer of 1 to 3; and m is an integer of 1 to 4].

20. The method of producing a luminescent material according to claim 19, further comprising said organic silicon compound is polymerized under the existence of said another luminescent compound and a surfactant.
